(19) United States
(12) Patent Application Publication
(10) Pub. No.: US 2025/0240411 A1
(43) Pub. Date: Jul. 24, 2025

(54) VIDEO ENCODING METHOD AND VIDEO DECODING METHOD

(71) Applicant: GUANGDONG OPPO MOBILE TELECOMMUNICATIONS CORP., LTD., Dongguan (CN)

(72) Inventor: Fan WANG, Dongguan (CN)

(21) Appl. No.: 19/177,183

(22) Filed: Apr. 11, 2025

Related U.S. Application Data
(63) Continuation of application No. PCT/CN2022/125168, filed on Oct. 13, 2022.

(51) Int. Cl. H04N 19/107; H04N 19/176; H04N 19/70

(52) U.S. Cl. CPC H04N 19/107; H04N 19/176; H04N 19/70

(57) ABSTRACT

A video decoding method includes: determining N candidate weight derivation modes, where N is a positive integer; determining a candidate prediction mode list, where the candidate prediction mode list includes at least one candidate prediction mode, and the at least one candidate prediction mode includes a prediction mode determined based on partitioning a template of a current block; determining a first weight derivation mode and K first prediction modes based on the N candidate weight derivation modes and the candidate prediction mode list, where K is a positive integer and K>1; and predicting the current block based on the first weight derivation mode and the K first prediction modes, to obtain a prediction value of the current block.

### CROSS-REFERENCE TO RELATED APPLICATION(S)

This application is a continuation of International Application No. PCT/CN2022/125168, filed Oct. 13, 2022, the entire disclosure of which is incorporated herein by reference.

### TECHNICAL FIELD

This disclosure relates to the field of video coding technology, and more particularly, to a video encoding method and a video decoding method.

### BACKGROUND

Digital video technology can be applied to various video apparatuses, such as digital televisions, smart phones, computers, electronic readers, or video players, etc. With development of video technology, the data amount in video data is large. In order to facilitate transmission of video data, the video apparatus implements video compression technology, so that video data can be transmitted or stored more efficiently.

There is temporal redundancy or spatial redundancy in a video, and redundancy in the video can be eliminated or reduced through prediction, thereby improving compression efficiency. Currently, in order to improve prediction effect, multiple prediction modes can be applied to predict a current block. For example, a candidate prediction mode list is constructed, and multiple prediction modes are selected from the candidate prediction mode list to predict a current block. However, the existing candidate prediction mode list constructed is not accurate enough, which reduces accuracy of prediction of the current block.

### SUMMARY

In a first aspect, a video decoding method is provided in the disclosure. The method includes the following. N candidate weight derivation modes are determined, where Nis a positive integer. A candidate prediction mode list is determined, where the candidate prediction mode list includes at least one candidate prediction mode, and the at least one candidate prediction mode includes a prediction mode determined based on partitioning a template of a current block. A first weight derivation mode and K first prediction modes are determined based on the N candidate weight derivation modes and the candidate prediction mode list, where K is a positive integer and K>1. The current block is predicted based on the first weight derivation mode and the K first prediction modes, to obtain a prediction value of the current block. In terms of determining the candidate prediction mode list, for each first candidate weight derivation mode in the N candidate weight derivation modes, a candidate prediction mode list corresponding to the first candidate weight derivation mode is determined.

In a second aspect, a video encoding method is provided in embodiments of the disclosure. The method includes the following. N candidate weight derivation modes are determined, where N is a positive integer. A candidate prediction mode list is determined, where the candidate prediction mode list includes at least one candidate prediction mode, and the at least one candidate prediction mode includes a prediction mode determined based on partitioning a template of a current block. A first weight derivation mode and K first prediction modes are determined based on the N candidate weight derivation modes and the candidate prediction mode list, where K is a positive integer and K>1. The current block is predicted based on the first weight derivation mode and the K first prediction modes, to obtain a prediction value of the current block. In terms of determining the candidate prediction mode list, for each first candidate weight derivation mode in the N candidate weight derivation modes, a candidate prediction mode list corresponding to the first candidate weight derivation mode is determined.

### BRIEF DESCRIPTION OF THE DRAWINGS

FIG. 1 is a schematic block diagram of a video coding system according to embodiments of the disclosure.

FIG. 2 is a schematic block diagram of a video encoder according to embodiments of the disclosure.

FIG. 3 is a schematic block diagram of a video decoder according to embodiments of the disclosure.

FIG. 4 is a schematic diagram illustrating weight allocation.

FIG. 5 is a schematic diagram illustrating weight allocation.

FIG. 6A is a schematic diagram illustrating inter prediction.

FIG. 6B is a schematic diagram illustrating weighted inter prediction.

FIG. 7A is a schematic diagram illustrating intra prediction.

FIG. 7B is a schematic diagram illustrating intra prediction.

FIG. 8A to FIG. 8I each are a schematic diagram illustrating intra prediction.

FIG. 9 is a schematic diagram illustrating intra prediction modes.

FIG. 10 is a schematic diagram illustrating intra prediction modes.

FIG. 11 is a schematic diagram illustrating intra prediction modes.

FIG. 12 is a schematic diagram illustrating matrix-based intra prediction (MIP).

FIG. 13 is a schematic diagram illustrating template-based intra mode derivation (TIMD) prediction.

FIG. 14A is a histogram corresponding to decoder-side intra mode derivation (DIMD).

FIG. 14B is a schematic diagram illustrating DIMD prediction.

FIG. 15 is a schematic diagram illustrating combination-based prediction.

FIG. 16 is a schematic diagram illustrating a template.

FIG. 17 is a schematic flowchart of a video decoding method provided in an embodiment of the disclosure.

FIG. 18 is a schematic diagram illustrating partitioning of a template.

FIG. 19 is a schematic diagram illustrating neighbouring blocks.

FIG. 20 is a schematic diagram illustrating partitioning of a reconstructed sample area.

FIG. 21A is a schematic diagram illustrating determination of a third candidate prediction mode.

FIG. 21B is another schematic diagram illustrating determination of a third candidate prediction mode.

FIG. 22A is a schematic diagram illustrating templates.

FIG. 22B is a schematic diagram illustrating derivation of template weights.

FIG. 23A is a schematic diagram illustrating a blending area.

FIG. 23B is a schematic diagram illustrating another blending area.

FIG. 24 is a schematic flowchart of a video encoding method provided in an embodiment of the disclosure.

FIG. 25 is a schematic block diagram of a video decoding apparatus provided in an embodiment of the disclosure.

FIG. 26 is a schematic block diagram of a video encoding apparatus provided in an embodiment of the disclosure.

FIG. 27 is a schematic block diagram of an electronic device provided in embodiments of the disclosure.

FIG. 28 is a schematic block diagram of a video coding system provided in embodiments of the disclosure.

### DETAILED DESCRIPTION

The disclosure can be applied to the field of picture coding, video coding, hardware video coding, dedicated circuit video coding, real-time video coding, etc. For example, the solution in the disclosure can be incorporated into audio video coding standards (AVS), such as H.264/audio video coding (AVC) standard, H.265/high efficiency video coding (HEVC) standard, and H.266/versatile video coding (VVC) standard. Alternatively, the solution in the disclosure can be incorporated into other proprietary or industry standards, including ITU-TH.261, ISO/IECMPEG-1Visual, ITU-TH.262 or ISO/IECMPEG-2Visual, ITU-TH.263, ISO/IECMPEG-4Visual, ITU-TH.264 (also known as ISO/IECMPEG-4AVC), including scalable video coding (SVC) and multi-view video coding (MVC) extensions. It should be understood that the techniques in the disclosure are not limited to any particular coding standard or technology.

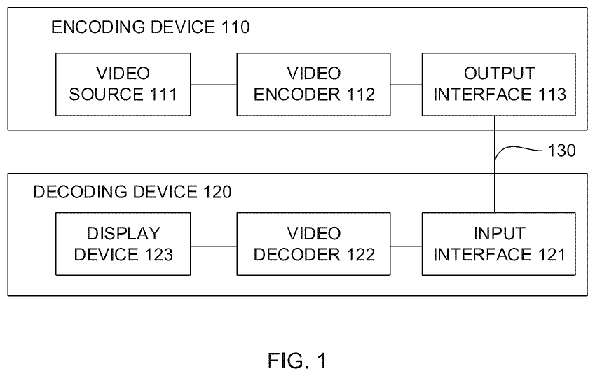

For ease of understanding, a video coding system in embodiments of the disclosure is firstly introduced with reference to FIG. 1.

FIG. 1 is a schematic block diagram of a video coding system according to embodiments of the disclosure. It should be noted that FIG. 1 is only an example, and the video coding system in embodiments of the disclosure includes but is not limited to that illustrated in FIG. 1. As illustrated in FIG. 1, the video coding system 100 includes an encoding device 110 and a decoding device 120. The encoding device is configured to encode (which can be understood as compress) video data to generate a bitstream, and transmit the bitstream to the decoding device. The decoding device is configured to decode the bitstream generated by the encoding device, to obtain decoded video data.

The encoding device 110 in embodiments of the disclosure can be understood as a device having a video encoding function, and the decoding device 120 can be understood as a device having a video decoding function, that is, the encoding device 110 and the decoding device 120 in embodiments of the disclosure include a wider range of devices, including smartphones, desktop computers, mobile computing devices, notebook (such as laptop) computers, tablet computers, set-top boxes, televisions, cameras, display devices, digital media players, video game consoles, vehicle-mounted computers, and the like.

In some embodiments, the encoding device 110 can transmit encoded video data (such as bitstream) to the decoding device 120 via a channel 130. The channel 130 can include one or more media and/or apparatuses capable of transmitting the encoded video data from the encoding device 110 to the decoding device 120.

In an example, the channel 130 includes one or more communication media that enable the encoding device 110 to transmit the encoded video data directly to the decoding device 120 in real-time. In this example, the encoding device 110 can modulate the encoded video data according to a communication standard and transmit the modulated video data to the decoding device 120. The communication medium includes a wireless communication medium, such as a radio frequency spectrum. Optionally, the communication medium can also include a wired communication medium, such as one or more physical transmission lines.

In another example, the channel 130 includes a storage medium that can store video data encoded by the encoding device 110. The storage medium includes a variety of local access data storage media, such as optical discs, digital versatile discs (DVDs), flash memory, and the like. In this example, the decoding device 120 can obtain the encoded video data from the storage medium.

In another example, the channel 130 can include a storage server that can store video data encoded by the encoding device 110. In this example, the decoding device 120 can download the stored encoded video data from the storage server. Optionally, the storage server can store the encoded video data and can transmit the encoded video data to the decoding device 120. For example, the storage server can be a web server (e.g., for a website), a file transfer protocol (FTP) server, and the like.

In some embodiments, the encoding device 110 includes a video encoder 112 and an output interface 113. The output interface 113 can include a modulator/demodulator (modem) and/or a transmitter.

In some embodiments, the encoding device 110 can further include a video source 111 in addition to the video encoder 112 and the input interface 113.

The video source 111 can include at least one of a video capture apparatus (for example, a video camera), a video archive, a video input interface, or a computer graphics system, where the video input interface is configured to receive video data from a video content provider, and the computer graphics system is configured to generate video data.

The video encoder 112 encodes the video data from the video source 111 to generate a bitstream. The video data can include one or more pictures or a sequence of pictures. The bitstream contains encoding information of a picture or a sequence of pictures. The encoding information can include encoded picture data and associated data. The associated data can include a sequence parameter set (SPS), a picture parameter set (PPS), and other syntax structures. The SPS can contain parameters applied to one or more sequences. The PPS can contain parameters applied to one or more pictures. The syntax structure refers to a set of zero or multiple syntax elements arranged in a specified order in the bitstream.

The video encoder 112 directly transmits the encoded video data to the decoding device 120 via the output interface 113. The encoded video data can also be stored on a storage medium or a storage server for subsequent reading by the decoding device 120.

In some embodiments, the decoding device 120 includes an input interface 121 and a video decoder 122.

In some embodiments, the decoding device 120 can further include a display device 123 in addition to the input interface 121 and the video decoder 122.

The input interface 121 includes a receiver and/or a modem. The input interface 121 can receive encoded video data via the channel 130.

The video decoder 122 is configured to decode the encoded video data to obtain decoded video data, and transmit the decoded video data to the display device 123.

The display device 123 displays the decoded video data. The display device 123 can be integrated together with the decoding device 120 or external to the decoding device 120. The display device 123 can include various display devices, such as a liquid crystal display (LCD), a plasma display, an organic light emitting diode (OLED) display, or other types of display devices.

In addition, FIG. 1 is only an example, and the technical solutions of embodiments of the disclosure are not limited to FIG. 1. For example, the technology of the disclosure can also be applied to one-sided video encoding or one-sided video decoding.

In the following, a video encoding framework in embodiments of the disclosure will be introduced.

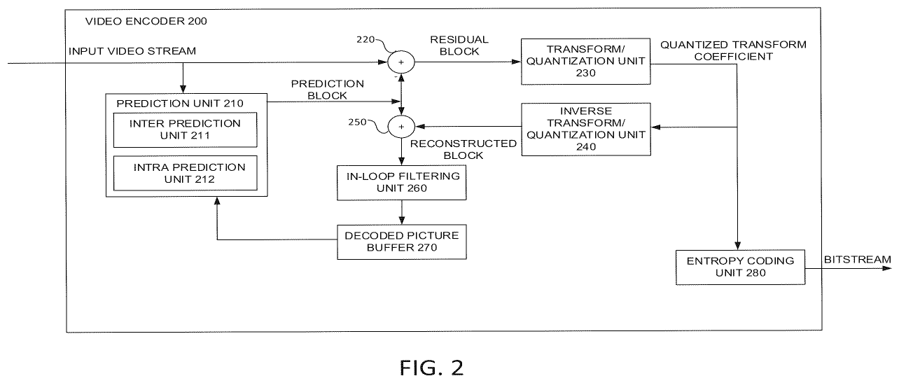

FIG. 2 is a schematic block diagram of a video encoder 200 according to embodiments of the disclosure. It should be understood that the video encoder 200 can be configured to perform lossy compression or lossless compression on a picture. The lossless compression can be visually lossless compression or mathematically lossless compression.

The video encoder 200 can be applied to picture data in luma-chroma (YCbCr, YUV) format. For example, a YUV ratio can be 4:2:0, 4:2:2, or 4:4:4, where Y represents luminance (Luma), Cb (U) represents blue chrominance, and Cr (V) represents red chrominance. U and V represent chrominance (Chroma) for describing colour and saturation. For example, in terms of color format, 4:2:0 represents that every 4 pixels have 4 luma components and 2 chroma components (YYYYCbCr), 4:2:2 represents that every 4 pixels have 4 luma components and 4 chroma components (YYYYCbCrCbCr), and 4:4:4 represents full pixel display (YYYYCbCrCbCrCbCrCbCr).

For example, the video encoder 200 reads video data, and for each picture in the video data, partitions the picture into several coding tree units (CTU). In some examples, the CTU can be called “tree block”, “largest coding unit” (LCU), or “coding tree block” (CTB). Each CTU can be associated with a pixel block of the same size as the CTU within the picture. Each pixel can correspond to one luminance (luma) sample and two chrominance (chroma) samples. Thus, each CTU can be associated with one luma sample block and two chroma sample blocks. The CTU can have a size of 128×128, 64×64, 32×32, and so on. The CTU can be further partitioned into several coding units (CUs) for coding. The CU can be a rectangular block or a square block. The CU can be further partitioned into a prediction unit (PU) and a transform unit (TU), so that coding, prediction, and transformation are separated, which is more conducive to flexibility in processing. In an example, the CTU is partitioned into CUs in a quadtree manner, and the CU is partitioned into TUs and PUs in a quadtree manner.

The video encoder and video decoder can support various PU sizes. Assuming that a size of a specific CU is 2N×2N, the video encoder and video decoder can support PUs of 2N×2N or N×N for intra prediction, and support symmetric PUs of 2N×2N, 2N×N, N×2N, N×N, or similar size for inter prediction; and the video encoder and video decoder can also support asymmetric PUs of 2N×nU, 2N×nD, nL×2N, or nR×2N for inter prediction.

In some embodiments, as illustrated in FIG. 2, the video encoder 200 can include a prediction unit 210, a residual unit 220, a transform/quantization unit 230, an inverse transform/quantization unit 240, a reconstruction unit 250, an in-loop filtering unit 260, a decoded picture buffer 270, and an entropy coding unit 280. It should be noted that the video encoder 200 can include more, fewer, or different functional components.

Optionally, in the disclosure, a current block can be referred to as a current CU or a current PU. A prediction block can be referred to as a prediction picture block or a picture prediction block. A reconstructed picture block can be referred to as a reconstructed block or a picture reconstructed block.

In some embodiments, the prediction unit 210 includes an inter prediction unit 211 and an intra prediction unit 212. Since there is a strong correlation between neighbouring samples in a video picture, intra prediction is used in the video coding technology to eliminate spatial redundancy between neighbouring samples. Since there is a strong similarity between neighbouring pictures in a video, inter prediction is used in the video coding technology to eliminate temporal redundancy between neighbouring pictures, thereby improving encoding efficiency.

The inter prediction unit 211 can be used for inter prediction. The inter prediction can include motion estimation and motion compensation. In inter prediction, reference can be made to picture information of different pictures. In inter prediction, motion information is used to find a reference block from a reference picture, and a prediction block is generated according to the reference block to eliminate temporal redundancy. A frame used for inter prediction can be a P frame and/or a B frame, where P frame refers to a forward prediction frame, and B frame refers to bidirectional prediction frame. In inter prediction, the motion information is used to find a reference block from a reference picture, and a prediction block is generated according to the reference block. The motion information includes a reference picture list containing the reference picture, a reference picture index, and a motion vector. The motion vector can be an integer-sample motion vector or a fractional-sample motion vector. If the motion vector is the fractional-sample motion vector, interpolation filtering on the reference picture is required to generate a required fractional-sample block. Here, an integer-sample block or fractional-sample block found in the reference picture according to the motion vector is called a reference block. In some technologies, the reference block can be used directly as a prediction block, and in some technologies, the prediction block will be generated based on the reference block. Generating the prediction block based on the reference block can also be understood as taking the reference block as a prediction block and then processing to generate a new prediction block based on the prediction block.

The intra prediction unit 212 is configured to predict sample information of the current picture block only with reference to information of the same picture, so as to eliminate spatial redundancy. A frame used for intra prediction can be an I frame.

There are multiple prediction modes for intra prediction. Taking the international digital video coding standard H series as an example, there are 8 angular prediction modes and 1 non-angular prediction mode in H.264/AVC standard, which are extended to 33 angular prediction modes and 2 non-angular prediction modes in H.265/HEVC. The intra prediction mode used in HEVC includes a planar mode, direct current (DC), and 33 angular modes, and there are 35 prediction modes in total. The intra prediction mode used in VVC includes planar, DC, and 65 angular modes, and there are 67 prediction modes in total.

It should be noted that with increase of the number of angular modes, intra prediction will be more accurate, which will be more in line with demand for development of high-definition and ultra-high-definition digital video.

The residual unit 220 can generate a residual block of the CU based on a sample block of the CU and a prediction block of a PU of the CU. For example, the residual unit 220 can generate the residual block of the CU such that each sample in the residual block has a value equal to a difference between a sample in the sample block of the CU and a corresponding sample in the prediction block of the PU of the CU.

The transform/quantization unit 230 can quantize a transform coefficient. The transform/quantization unit 230 can quantize a transform coefficient associated with a TU of a CU based on a quantization parameter (QP) value associated with the CU. The video encoder 200 can adjust the degree of quantization applied to a transform coefficient associated with the CU by adjusting the QP value associated with the CU.

The inverse transform/quantization unit 240 can perform inverse quantization and inverse transform respectively on the quantized transform coefficient, to reconstruct a residual block according to the quantized transform coefficient.

The reconstruction unit 250 can add samples in the reconstructed residual block to corresponding samples in one or more prediction blocks generated by the prediction unit 210, to generate a reconstructed picture block associated with the TU. By reconstructing sample blocks of each TU of the CU in this way, the video encoder 200 can reconstruct the sample block of the CU.

The in-loop filtering unit 260 is configured to process an inverse-transformed and inverse-quantized sample, compensate distorted information, and provide a better reference for subsequent sample encoding. For example, the in-loop filtering unit 260 can perform deblocking filtering operations to reduce blocking artifacts of the sample block associated with the CU.

In some embodiments, the in-loop filtering unit 260 includes a deblocking filtering unit and a sample adaptive offset/adaptive loop filtering (SAO/ALF) unit, where the deblocking filtering unit is configured for deblocking, and the SAO/ALF unit is configured to remove a ringing effect.

The decoded picture buffer 270 can store reconstructed sample blocks. The inter prediction unit 211 can use reference pictures including reconstructed sample blocks to perform inter prediction on PUs of other pictures. In addition, the intra prediction unit 212 can use the reconstructed sample blocks in the decoded picture buffer 270 to perform intra prediction on other PUs in the same picture as the CU.

The entropy coding unit 280 can receive the quantized transform coefficient from the transform/quantization unit 230. The entropy coding unit 280 can perform one or more entropy coding operations on the quantized transform coefficient to generate entropy coded data.

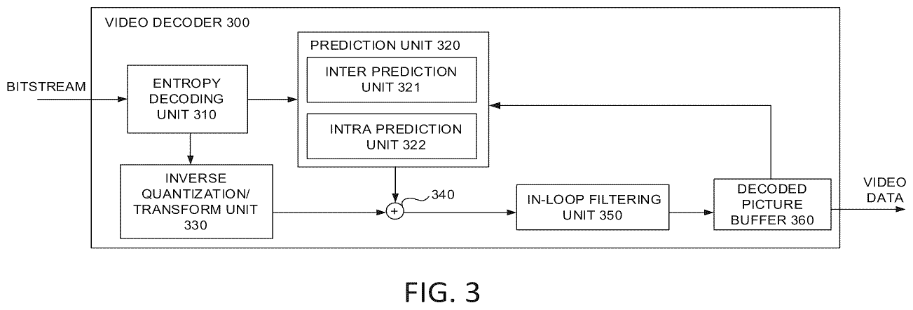

FIG. 3 is a schematic block diagram of a video decoder according to embodiments of the disclosure.

As illustrated in FIG. 3, the video decoder 300 includes an entropy decoding unit 310, a prediction unit 320, an inverse quantization/transform unit 330, a reconstruction unit 340, an in-loop filtering unit 350, and a decoded picture buffer 360. It should be noted that the video decoder 300 can include more, fewer, or different functional components.

The video decoder 300 can receive a bitstream. The entropy decoding unit 310 can parse the bitstream to extract syntax elements from the bitstream. As part of parsing the bitstream, the entropy decoding unit 310 can parse entropy-coded syntax elements in the bitstream. The prediction unit 320, the inverse quantization/transform unit 330, the reconstruction unit 340, and the in-loop filtering unit 350 can decode video data according to the syntax elements extracted from the bitstream, that is, generate decoded video data.

In some embodiments, the prediction unit 320 includes an intra prediction unit 322 and an inter prediction unit 321.

The intra prediction unit 322 can perform intra prediction to generate a prediction block of a PU. The intra prediction unit 322 can use an intra-prediction mode to generate a prediction block of the PU based on a sample block of spatially neighbouring PUs. The intra prediction unit 322 can also determine an intra prediction mode of the PU from one or more syntax elements parsed from the bitstream.

The inter prediction unit 321 can construct a first reference picture list (list 0) and a second reference picture list (list 1) according to the syntax elements parsed from the bitstream. In addition, the entropy decoding unit 310 can parse motion information of the PU if the PU is encoded by using inter prediction. The inter prediction unit 321 can determine one or more reference blocks of the PU according to the motion information of the PU. The inter prediction unit 321 can generate a prediction block of the PU based on one or more reference blocks of the PU.

The inverse quantization/transform unit 330 can perform inverse quantization on (that is, dequantize) a transform coefficient associated with a TU. The inverse quantization/transform unit 330 can use a QP value associated with a CU of the TU to determine the degree of quantization.

After inverse quantization of the transform coefficient, the inverse quantization/transform unit 330 can perform one or more inverse transformations on the inverse-quantized transform coefficient in order to generate a residual block associated with the TU.

The reconstruction unit 340 uses the residual block associated with the TU of the CU and the prediction block of the PU of the CU to reconstruct a sample block of the CU. For example, the reconstruction unit 340 can add samples in the residual block to corresponding samples in the prediction block to reconstruct the sample block of the CU to obtain the reconstructed picture block.

The in-loop filtering unit 350 can perform deblocking filtering to reduce blocking artifacts of the sample block associated with the CU.

The video decoder 300 can store the reconstructed picture of the CU in the decoded picture buffer 360. The video decoder 300 can use the reconstructed picture in the decoded picture buffer 360 as a reference picture for subsequent prediction, or transmit the reconstructed picture to a display device for display.

A basic process of video coding is as follows. At an encoding end, a picture is partitioned into blocks, and for a current block, the prediction unit 210 performs intra prediction or inter prediction to generate a prediction block of the current block. The residual unit 220 can calculate a residual block based on the prediction block and an original block of the current block, that is, a difference between the prediction block and the original block of the current block, where the residual block can also be referred to as residual information. The residual block can be transformed and quantized by the transform/quantization unit 230 to remove information that is not sensitive to human eyes, so as to eliminate visual redundancy. Optionally, the residual block before being transformed and quantized by the transform/quantization unit 230 can be called a time-domain residual block, and the time-domain residual block after being transformed and quantized by the transform/quantization unit 230 can be called a frequency residual block or a frequency-domain residual block. The entropy coding unit 280 receives the quantized transformation coefficient output by the transform/quantization unit 230, and can perform entropy coding on the quantized transformation coefficient to output a bitstream. For example, the entropy coding unit 280 can eliminate character redundancy according to a target context model and probability information of a binary bitstream.

At a decoding end, the entropy decoding unit 310 can parse the bitstream to obtain prediction information, a quantization coefficient matrix, etc. of the current block, and the prediction unit 320 performs intra prediction or inter prediction on the current block based on the prediction information to generate a prediction block of the current block. The inverse quantization/transform unit 330 uses the quantization coefficient matrix obtained from the bitstream to perform inverse quantization and inverse transformation on the quantization coefficient matrix to obtain a residual block. The reconstruction unit 340 adds the prediction block and the residual block to obtain a reconstructed block. The reconstructed blocks form a reconstructed picture. The in-loop filtering unit 350 performs in-loop filtering on the reconstructed picture on a picture basis or on a block basis to obtain a decoded picture. Similar operations are also required at the encoding end for obtaining the decoded picture. The decoded picture can also be referred to as a reconstructed picture, and the reconstructed picture can be a reference picture of a subsequent picture for inter prediction.

It should be noted that block partition information as well as mode information or parameter information for prediction, transformation, quantization, entropy coding, and in-loop filtering, etc. determined by the encoding end is carried in the bitstream when necessary. At the decoding end, the bitstream parsed and existing information is analyzed to determine the block partition information as well as the mode information or the parameter information for prediction, transformation, quantization, entropy coding, in-loop filtering, etc. that is the same as such information at the encoding end, so as to ensure the decoded picture obtained at the encoding end is the same as the decoded picture obtained at the decoding end.

The above is the basic process of a video coder under a block-based hybrid coding framework. With development of technology, some modules or steps of the framework or process can be optimized. The disclosure is applicable to the basic process of the video coder under the block-based hybrid coding framework, but is not limited to the framework and process.

In embodiments of the disclosure, the current block can be a current CU or a current PU, etc. Due to requirements of parallel processing, a picture can be partitioned into slices, etc. Slices in the same picture can be processed in parallel, that is, there is no data dependency between the slices. The term “frame” is a common expression. It can be generally understood that a frame is a picture. In the disclosure, the frame can also be replaced with a picture or a slice, etc.

In the video coding standard VVC currently under development, there is an inter prediction mode called geometric partitioning mode (GPM). In the video coding standard AVS currently under development, there is an inter prediction mode called angular weighted prediction (AWP) mode. Although these two modes have different names and implementation details, they share common principles.

It should be noted that in traditional unidirectional prediction, only one reference block with the same size as the current block is searched for, while in traditional bidirectional prediction, two reference blocks with the same size as the current block are used, where a sample value of each sample in a prediction block is an average of samples at corresponding positions in the two reference blocks, that is, all samples in each reference block account for 50%. Bidirectional weighted prediction allows proportions of the two reference blocks to be different, such as 75% for all samples in a 1^{st} reference block and 25% for all samples in a 2^{nd} reference block, but proportions of all samples in the same reference block are the same, but proportions of all samples in the same reference block are the same. Other optimization methods, such as decoder-side motion vector refinement (DMVR) technology, bi-directional optical flow (BIO), etc., may cause some changes in reference samples or prediction samples, which is however not related to the foregoing principles. BIO can also be abbreviated as BDOF. In GPM or AWP, two reference blocks with the same size as the current block are also used. However, in some sample positions, 100% of sample values at corresponding positions in the 1^{st} reference block are used; in some sample positions, 100% of sample values at corresponding positions in the 2^{nd} reference block are used; and in a boundary area (or referred to as blending area), sample values at corresponding positions in these two reference blocks are used according to a certain proportion. Weights of the boundary area are also transitioned gradually. The allocation of these weights is determined according to a mode in GPM or AWP, and the weight of each sample position is determined according to the mode in GPM or AWP. In some cases, for example, if the size of a block is very small, in some modes in GPM or AWP, it may be impossible to ensure that at some sample positions, 100% of sample values at corresponding positions in the 1^{st} reference block are used; and at some sample positions, 100% of sample values at corresponding positions in the 2^{nd} reference block are used. It can also be considered that in GPM or AWP, two reference blocks with different sizes from the current block are used, that is, a required part of each reference block is taken as a reference block, in other words, a part with non-zero weights is taken as the reference block, while a part with zero weights is removed, which is specific implementation related and is not the focus of discussion of the disclosure.

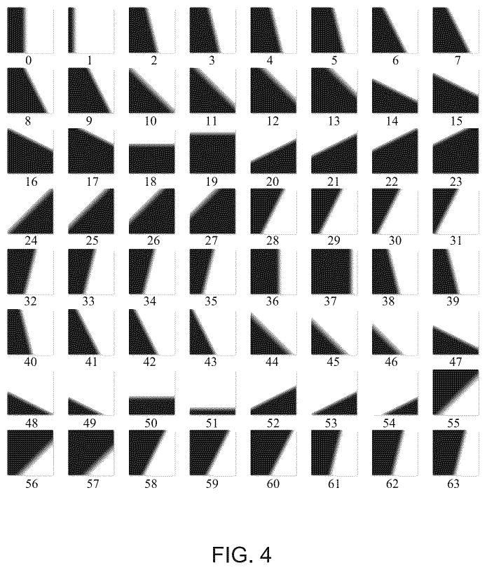

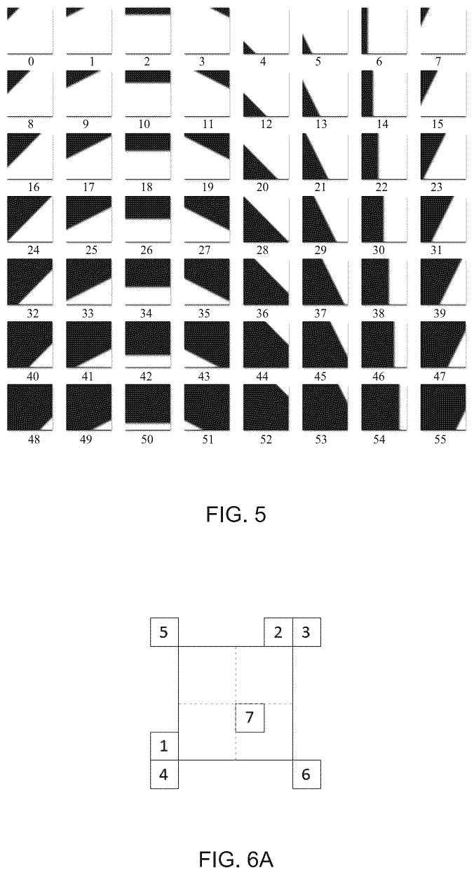

Exemplarily, FIG. 4 is a schematic diagram illustrating weight allocation. FIG. 4 is a schematic diagram illustrating weight allocation for multiple partitioning modes of GPM on a 64×64 current block provided in embodiments of the disclosure, where GPM has 64 partitioning modes. FIG. 5 is a schematic diagram illustrating weight allocation. FIG. 5 is a schematic diagram illustrating weight allocation for multiple partitioning modes of AWP on a 64×64 current block provided in embodiments of the disclosure, where AWP has 56 partitioning modes. In each of FIG. 4 and FIG. 5, for each partitioning mode, a black area represents a weight of 0% for corresponding positions in the 1^{st} reference block, while a white area represents a weight of 100% for corresponding positions in the 1^{st} reference block, a grey area represents a weight greater than 0% and less than 100%, represented by a colour depth, for corresponding positions in the 1^{st} reference block, and a weight for a corresponding position in the 2^{nd} reference block is 100% minus a weight for a corresponding position in the 1^{st} reference block.

GPM and AWP differ in method for weight derivation. For GPM, an angle and an offset are determined according to each mode, and then a weight matrix for each mode is calculated. For AWP, a one-dimensional weight line is firstly defined, and then a method similar to intra angular prediction is used to fill an entire matrix with the one-dimensional weight line.

It should be noted that in earlier coding technologies, only rectangular partitioning was available, no matter whether it is for CU partitioning, PU partitioning, or TU partitioning. However, with GPM or AWP, the effect of non-rectangular partitioning for prediction is achieved without partitioning. In GPM and AWP, a weight mask for two reference blocks is used, namely the weight map as described above. From the mask, weights of the two reference blocks for generating the prediction block are determined. It can be simply understood as that some positions in the prediction block come from the 1^{st} reference block and some positions come from the 2^{nd} reference block, and a blending area is obtained by weighting corresponding positions in the two reference blocks, which allows a smoother transition. In GPM and AWP, the current block is not partitioned into two CUs or PUs according to a partition line. Therefore, after prediction, the current block is processed as a whole during transformation, quantization, inverse transformation, and inverse quantization of residuals.

In GPM, a weight matrix is used to simulate geometric shape partitioning, or more precisely, simulate partitioning of prediction. To implement GPM, in addition to the weight matrix, two prediction values are also needed, each determined by one unidirectional motion information. These two unidirectional motion information come from a motion information candidate list, such as a merge motion information candidate list (mergeCandList). In GPM, two indices are used in a bitstream to determine the two unidirectional motion information from mergeCandList.

In inter prediction, motion information is used to represent “motion”. Basic motion information includes reference frame (or called reference picture) information and motion vector (MV) information. In common bidirectional prediction, prediction is performed on a current block by using two reference blocks. The two reference blocks can be a forward reference block and a backward reference block. Optionally, the two reference blocks are allowed to be both forward or both backward. Forward means that a moment corresponding to the reference picture is before a current picture, and backward means that the moment corresponding to the reference picture is after the current picture. In other words, forward means that a position of the reference picture in a video is before the current picture, and backward means that the position of the reference picture in the video is after the current picture. In other words, forward means that a picture order count (POC) of the reference picture is less than a POC of the current picture, and backward means that the POC of the reference picture is greater than the POC of the current picture. In order to use bidirectional prediction, it is necessary to find two reference blocks, and accordingly, two groups of reference picture information and motion vector information are needed. Each of the two groups can be understood as one unidirectional motion information, and one bidirectional motion information can be obtained by combining the two groups. During implementation, the unidirectional motion information and the bidirectional motion information may use the same data structure, but the two groups of reference picture information and motion vector information in the bidirectional motion information are both valid, while one of the two groups of reference picture information and motion vector information in the unidirectional motion information is invalid.

In some embodiments, two reference picture lists are supported, and are denoted as RPL0, RPL1, where RPL is an abbreviation for reference picture list. In some embodiments, only RPL0 can be applied to a P slice, and both RPL0 and RPL1 can be applied to a B slice. For a slice, each reference picture list has several reference pictures, and a coder finds a certain reference picture according to a reference picture index. In some embodiments, the motion information is represented by a reference picture index and a motion vector. For example, for the bidirectional motion information described above, a reference picture index refIdxL0 corresponding to RPL0, a motion vector mvL0 corresponding to RPL0, a reference picture index refIdxL1 corresponding to RPL1, and a motion vector mvL0 corresponding to RPL1 are used. Here, the reference picture index corresponding to RPL0 and the reference picture index corresponding to RPL1 can be understood as the reference picture information described above. In some embodiments, two flags are used to indicate whether to use motion information corresponding to RPL0 and whether to use motion information corresponding to RPL0 respectively, and are denoted as predFlagL0 and predFlagL1 respectively, which can also mean that predFlagL0 and predFlagL1 indicate whether the unidirectional motion information is “valid”. Although such data structure of the motion information is not explicitly indicated, the motion information is indicated by using a reference picture index, a motion vector, and a flag indicating validity corresponding to each RPL. In some standard texts, the term “motion vector” is used rather than “motion information”, and it can also be considered that the reference picture index and the flag indicating whether to use corresponding motion information are associated with the motion vector. In the disclosure, “motion information” is still used for the convenience of illustration, but it should be understood that “motion vector” can also be used for illustration.

Motion information applied to the current block can be stored, and motion information of previously coded blocks such as neighbouring blocks can be applied to subsequent coding blocks of the current picture based on a positional relationship. This utilizes spatial correlation, so this kind of coded motion information is called spatial motion information. Motion information applied to each block of the current picture can be stored, and motion information of previously coded picture can be applied to subsequent coding pictures based on a reference relationship. This utilizes temporal correlation, so this kind of motion information of coded picture is called temporal motion information. The motion information applied to each block in the current picture is usually stored in the following manner: a fixed-size matrix such as a 4×4 matrix is usually taken as a minimum unit, and each minimum unit stores a set of motion information separately. In this way, when coding each block, a minimum unit(s) corresponding to a position of the block can store motion information of the block. As such, when using spatial motion information or temporal motion information, motion information corresponding to a position can be directly found according to the position. For example, if traditional unidirectional prediction is applied to a 16×16 block, all 4×4 minimum units corresponding to the block will store motion information of this unidirectional prediction. If GPM or AWP is applied to a block, all minimum units corresponding to the block will store motion information determined according to the mode of GPM or AWP, 1^{st} motion information, 2^{nd} motion information, and a position of each minimum unit. In one manner, if all 4×4 samples corresponding to a minimum unit come from the 1st motion information, the minimum unit stores the 1st motion information. If all 4×4 samples corresponding to a minimum unit come from the 2^{nd} motion information, the minimum unit stores the 2^{nd} motion information. If all 4×4 samples corresponding to a minimum unit come from both the 1^{st} motion information and the 2^{nd} motion information, in AWP, one of the 1st motion information and the 2^{nd} motion information will be chosen and stored; and in GPM, two motion information will be combined as bidirectional motion information for storage if the two motion information correspond to different RPLs, and otherwise, only the 2^{nd} motion information will be stored.

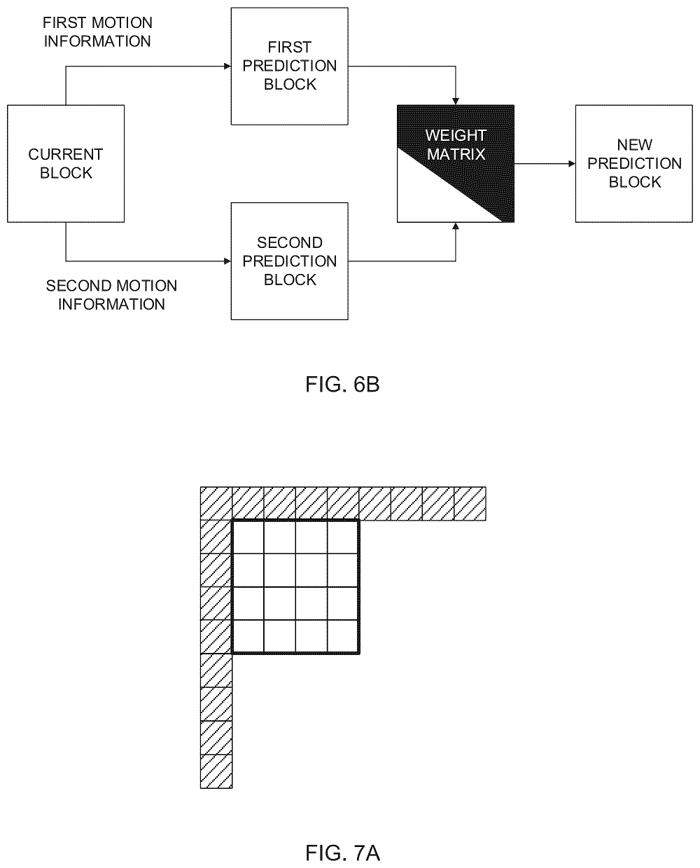

Optionally, the aforementioned mergeCandList is constructed based on spatial motion information, temporal motion information, history-based motion information, and some other motion information. Exemplarily, for the mergeCandList, positions 1 to 5 in FIG. 6A are used to derive the spatial motion information, and position 6 or 7 in FIG. 6A is used to derive the temporal motion information. For the history-based motion information, motion information of each block is added to a first-in-first-out list when coding the block, and the addition process may require some checks, such as whether the motion information duplicates existing motion information in the list. In this way, reference may be made to the motion information in the history-based list when coding the current block.

In some embodiments, the syntax description for GPM is that as illustrated in Table 1.

TABLE 1

| | |
|---|---|
| regular_merge_flag[x0][y0] | ae(v) |
| if( regular_merge_flag[x0][y0] == 1 ) { | |
| if( sps_mmvd_enabled_flag ) | |
| mmvd_merge_flag[x0][y0] | ae(v) |
| if( mmvd_merge_flag[x0][y0] == 1 ) { | |
| if( MaxNumMergeCand > 1 ) | |
| mmvd_cand_flag[x0][y0] | ae(v) |
| mmvd_distance_idx[x0][y0] | ae(v) |
| mmvd_direction_idx[x0][y0] | ae(v) |
| } else if( MaxNumMergeCand > 1 ) | |
| merge_idx[x0][y0] | ae(v) |
| } else { | |
| if( sps_ciip_enabled_flag && sps_gpm_enabled_flag && | |
| sh_slice_type == B && | |
| cu_skip_flag[x0][y0] == 0 && cbWidth >= 8 && | |
| cbHeight >= 8 && | |
| cbWidth < (8*cbHeight) && cbHeight < (8*cbWidth) && | |
| cbWidth < 128 && cbHeight < 128 ) | |
| ciip_flag[x0][y0] | ae(v) |
| if( ciip_flag[x0][y0] && MaxNumMergeCand > 1 ) | |
| merge_idx[x0][y0] | ae(v) |
| if( !ciip_flag[x0][y0] ) { | |
| merge_gpm_partition_idx[x0][y0] | ae(v) |
| merge_gpm_idx0[x0][y0] | ae(v) |
| if( MaxNumGpmMergeCand > 2 ) | |
| merge_gpm_idx1[x0][y0] | ae(v) |
| } | |
| } | |

As illustrated in Table 1, in a merge mode, if regular merge flag is not equal to 1, either combined inter-intra prediction (CIIP) or GPM can be applied to the current block. If CIIP is not applied to the current block, then GPM will be applied, as indicated by the syntax “if(!ciip_flag[x0][y0])” in Table 1.

As illustrated in the above Table 1, in GPM, transmission of three information in a bitstream, namely merge_gpm_partition_idx, merge_gpm_idx0, and merge_gpm_idx1, is required. x0 and y0 are used to determine coordinates (x0, y0) of a top-left luma sample of the current block relative to a top-left luma sample of the picture. merge_gpm_partition_idx is used to determine a partitioning shape of GPM, which is a “simulated partitioning” as described above. merge_gpm_partition_idx represents a weight matrix derivation mode or an index of the weight matrix derivation mode in the disclosure, or referred to as a weight derivation mode or an index of the weight derivation mode. merge_gpm_idx0 represents a 1st merge candidate index, and the first merge candidate index is used for determining first motion information, or referred to as a first merge candidate, according to mergeCandList. merge_gpm_idx 1 represents a 2^{nd} merge candidate index, and the second merge candidate index is used for determining second motion information, or called a second merge candidate, according to mergeCandList. merge_gpm_idx1 needs to be decoded only when MaxNumGpmMergeCand>2, i.e. the length of the candidate list is greater than 2; otherwise, merge_gpm_idx1 can be determined directly.

In some embodiments, a decoding process of GPM includes the following steps.

Information input for the decoding process includes: coordinates (xCb, yCb) of a top-left luma location of the current block relative to a top-left luma location of the picture, a width (cbWidth) of a luma component of the current block, a height (cbHeight) of a luma component of the current block, luma motion vectors mvA and mvB in 1/16 fractional-sample accuracy, chroma motion vectors mvCA and mvCB, reference picture indices refIdxA and refIdxB, and prediction list flags predListFlagA and predListFlagB.

Exemplarily, the motion information can be represented by a combination of motion vectors, reference picture indices, and prediction list flags. In VVC, two reference picture lists are supported, each of which can have multiple reference pictures. In unidirectional prediction, only one reference block in one reference picture in one reference picture list is used for reference, while in bidirectional prediction, two reference blocks each in one reference picture in one of the two reference picture lists are used for reference. In GPM in VVC, two unidirectional predictions are used. In mvA and mvB, mvCA and mvCB, refIdxA and refIdxB, predListFlagA and predListFlagB, “A” can be understood as a 1^{st} prediction mode, and “B” can be understood as a 2^{nd} prediction mode. Here, “X” is used to represent “A” or “B”, so that predListFlagX indicates whether a 1^{st} reference picture list or a 2^{nd} reference picture list is applied to X, refIdxX indicates a reference picture index in the reference picture list applied to X, mvX indicates a luma motion vector applied to X, and mvCX indicates a chroma motion vector applied to X. It should be noted that, in VVC, the motion information described in the disclosure can be considered as represented by a combination of motion vectors, reference picture indices, and prediction list flags.

Information output for the decoding process includes: an (cbWidth)×(cbHeight) array predSamplesL of luma prediction samples; an (cbWidth/SubWidthC)×(cbHeight/SubHeightC) array of chroma prediction samples for the component Cb, if necessary; and an (cbWidth/SubWidthC)×(cbHeight/SubHeightC) array of chroma prediction samples for the component Cr, if necessary.

Exemplarily, the luma component is taken as an example. The processing of the chroma component is similar to that of the luma component.

Let each of predSamplesLAL and predSamplesLBL have a size of (cbWidth)×(cbHeight), which are prediction sample arrays obtained based on two prediction modes. predSamplesL is derived as follows. predSamplesLAL and predSamplesLBL are determined separately according to the luma motion vectors mvA and mvB, the chroma motion vectors mvCA and mvCB, the reference picture indices refIdxA and refIdxB, and the prediction list flags predListFlagA and predListFlagB. In other words, prediction is performed according to motion information of the two prediction modes, and the detailed process thereof is not described herein. Generally, GPM is a merge mode, so that both of the two prediction modes of GPM can be considered as merge modes.

According to merge_gpm_partition_idx[xCb][yCb], a partition angle index variable angleIdx and a distance index variable distanceIdx of GPM are determined based on Table 2.

TABLE 2
Correspondence among angleIdx, distanceIdx, and merge_gpm_partition_idx

| merge_gpm_partition_idx | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_gpm_partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_gpm_partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_gpm_partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |

It should be noted that, GPM can be applied to each of the three components (Y, Cb, Cr). Therefore, in some standard texts, the process of generating a GPM prediction sample array for one component is encapsulated in a sub-process called “weighted sample prediction process for GPM”. This sub-process is invoked for all the three components, with different parameters for each component. Here, the luma component is taken as an example. A prediction array for a current luma block, predSamplesL[xL][yL] (where xL=0 . . . cbWidth−1, yL=0 . . . cbHeight−1), is derived from the weighted sample prediction process for GPM. nCbW is set to cbWidth, and nCbH is set to cbHeight. The prediction sample arrays predSamplesLAL and predSamplesLBL generated by applying the two prediction modes, as well as angleIdx and distanceIdx, are used as inputs.

In some embodiments, the weighted sample prediction and derivation process for GPM includes the following steps.

Inputs to this process are: a width nCbW of the current block, a height nCbH of the current block, two (nCbW)×(nCbH) prediction sample arrays predSamplesLA and predSamplesLB, a partition angle index variable angleIdxof GPM, a distance index variable distanceIdx of GPM, and a component index variable cIdx. Here, a luma component is taken as an example, so that cIdx=0, which indicates the luma component.

Output of this process is the (nCbW)×(nCbH) array pbSamples of prediction sample values of GPM.

Exemplarily, variables nW, nH, shift1, offset1, displacementX, displacementY, partFlip, and shiftHor are derived as follows:

```
  nW = ( cIdx = = 0 ) ? nCbW : nCbW * SubWidthC;
  nH = ( cIdx = = 0 ) ? nCbH : nCbH * SubHeightC;
  shift1 = Max( 5, 17 − BitDepth ), where BitDepth represents
  a coding bit depth;
  offset1 = 1 << ( shift1 − 1 ), where “<<” represents shift left;
  displacementX = angleIdx;
  displacementY = ( angleIdx + 8 ) % 32;
  partFlip = ( angleIdx >= 13 && angleIdx <= 27) ? 0 : 1;
  shiftHor = ( angleIdx % 16 = = 8 | | ( angleIdx % 16 != 0 &&
  nH >= nW ) ) ?
0 : 1.
```

Variables offsetX and offsetY are derived as follows:

```
  If shiftHor = 0:
    offsetX = ( −nW ) >> 1,
    offsetY = ( ( −nH ) >> 1 ) + ( angleIdx < 16 ? ( distanceIdx *
    nH ) >> 3 : −
( ( distanceIdx * nH ) >> 3 ) ).
  If shiftHor = 1:
    offsetX = ( ( −nW ) >> 1 ) + ( angleIdx < 16 ? ( distanceIdx *
    nW ) >> 3 : −
( ( distanceIdx * nW ) >> 3 ),
    offsetY = ( − nH ) >> 1.
```

Variables xL and yL are derived as follows:

xL=(cIdx==0)?x:x*SubWidthC,

yL=(cIdx==0)?y:y*SubHeightC.

Variable wValue specifying a weight of a prediction sample at a current location is derived as follows, where wValue is a weight of a predicted sample predSamplesLA[x][y] at (x, y) in a prediction array for a 1^{st} prediction mode, and (8−wValue) is a weight of a predicted sample predSamplesLB[x][y] at (x, y) in the prediction array for the 1^{st} prediction mode.

The distance matrix disLut is determined according to Table 3.

TABLE 3

| idx | 0 | 2 | 3 | 4 | 5 | 6 | 8 | 10 | 11 | 12 | 13 | 14 |
|---|---|---|---|---|---|---|---|---|---|---|---|---|
| disLut[idx] | 8 | 8 | 8 | 4 | 4 | 2 | 0 | −2 | −4 | −4 | −8 | −8 |
| idx | 16 | 18 | 19 | 20 | 21 | 22 | 24 | 26 | 27 | 28 | 29 | 30 |
| disLut[idx] | −8 | −8 | −8 | −4 | −4 | −2 | 0 | 2 | 4 | 4 | 8 | 8 |

```
  weightIdx = ( ( ( xL + offsetX ) << 1) + 1 ) * disLut[ displacementX
] + (((yL + offsetY ) << 1 ) + 1 ) * disLut[ displacementY ],
  weightIdxL = partFlip ? 32 + weightIdx : 32 − weightIdx,
  wValue = Clip3( 0, 8, ( weightIdxL + 4 ) >> 3 ).
```

The prediction sample values pbSamples[x][y] are derived as follows:

```
  pbSamples[ x ][ y ] = Clip3( 0, ( 1 << BitDepth ) − 1,
  ( predSamplesLA[ x ][ y ]
* wValue + predSamplesLB[ x ][ y ] * ( 8 − wValue ) + offset1 ) >>
shift1 ).
```

It should be noted that, for each position in the current block, a weight is derived and then a GPM prediction value pbSamples[x][y] is calculated. In this case, although the weights wValue do not have to be written in matrix form, it can be understood that if each wValue for each position is stored in a matrix, then a weight matrix is formed. The principle of calculating the GPM prediction value by separately calculating the weight for each sample and weighting is the same as the principle of calculating the GPM prediction sample array by calculating all the weights and then uniformly weighting. However, the expression of “weight matrix” in various elaborations in the disclosure is for the sake of better understanding, and drawings based on a weight matrix are more intuitive. In fact, elaborations can also be made based the weight of each position. For example, a weight matrix derivation mode may also be referred to as a weight derivation mode.

In some embodiments, as illustrated in FIG. 6B, a GPM decoding process can be expressed as follows. A bitstream is parsed to determine whether a GPM technology is applied to the current block. If the GPM technology is applied to the current block, a weight derivation mode (or a partitioning mode or a weight matrix derivation mode), first motion information, and second motion information are determined. A first prediction block is determined according to the first motion information, a second prediction block is determined according to the second motion information, a weight matrix is determined according to the weight matrix derivation mode, and a prediction block of the current block is determined according to the first prediction block, the second prediction block, and the weight matrix.

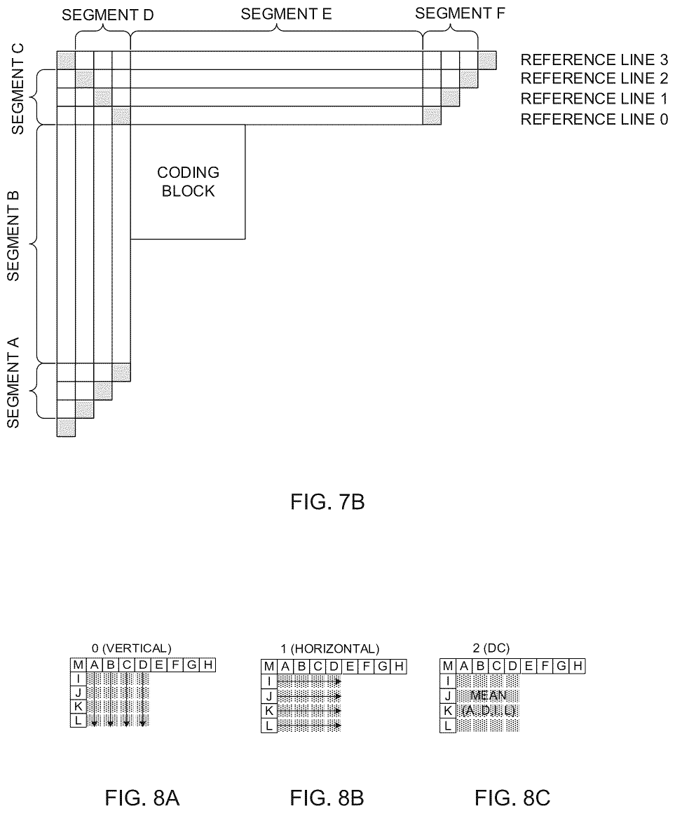

In an intra prediction method, reconstructed samples around the current block that have been coded are used as reference samples to predict the current block. FIG. 7A is a schematic diagram illustrating intra prediction. As illustrated in FIG. 7A, the current block is 4×4 in size, and samples on the left column and the above row of the current block are used as reference samples of the current block and are used for intra prediction of the current block. These reference samples may all be available, i.e. they have all been coded. Alternatively, some of the reference samples may not be available. For example, if the current block is on the leftmost of a picture, the reference samples on the left of the current block are not available. For another example, when coding the current block, the samples on the bottom left of the current block have not yet been coded, and in this case, reference samples on the bottom left are also not available. For the case where reference samples are not available, available reference samples, some values, or some methods may be used for filling, or no filling may be performed.

FIG. 7B is a schematic diagram illustrating intra prediction. As illustrated in FIG. 7B, with a multiple reference line (MRL) intra prediction method, more reference samples can be used to improve coding efficiency. For example, four reference rows/columns are used as the reference samples of the current block.

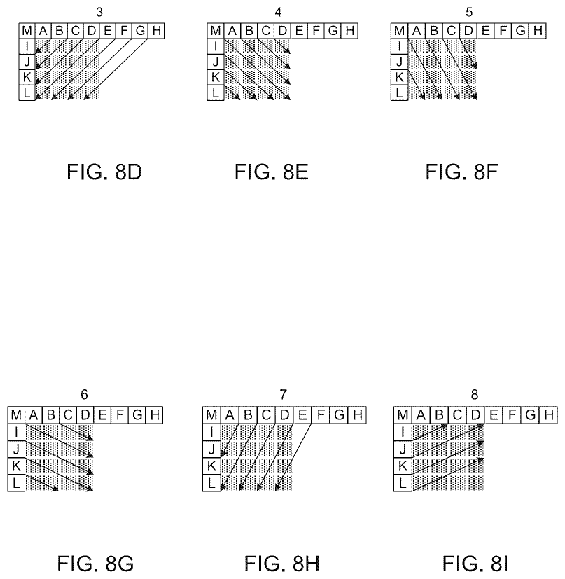

Further, there are multiple prediction modes for intra prediction. FIG. 8A˜FIG. 8I each are a schematic diagram illustrating intra prediction. As illustrated in FIG. 8A˜FIG. 8I, in H.264, there are nine modes for intra prediction of 4×4 blocks. In mode 0 illustrated in FIG. 8A, samples above the current block are copied to the current block vertically as prediction values. In mode 1 illustrated in FIG. 8B, reference samples on the left of the current block are copied to the current block horizontally as prediction values. In mode 2 (DC) illustrated in FIG. 8C, an average value of eight samples (A˜D and I˜L) is taken as the prediction value of all samples. In mode 3 to mode 8 illustrated in FIG. 8D˜FIG. 8I, reference samples are copied to corresponding positions in the current block according to a certain angle, and since some positions in the current block may not correspond exactly to the reference sample, a weighted average of reference samples or interpolated factional samples of the reference samples may be required.

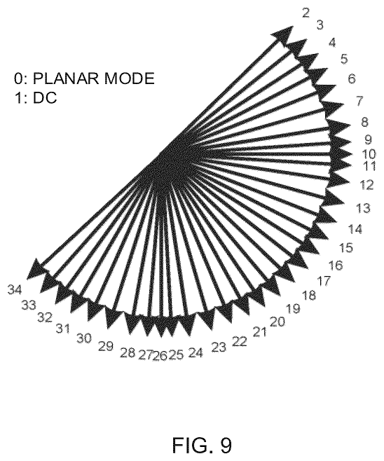

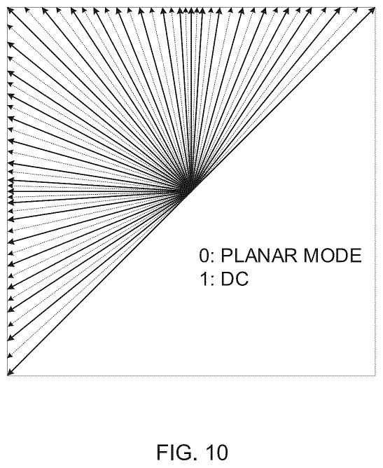

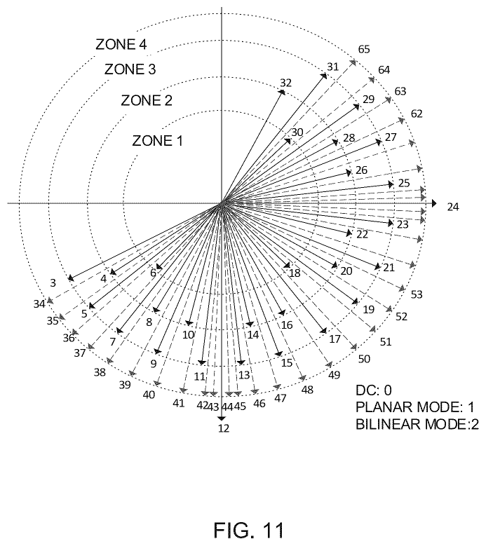

In addition, there are other modes such as the plane mode or the planar mode. With development of technology and increase in block size, there are an increasing number of angular prediction modes. FIG. 9 is a schematic diagram illustrating intra prediction modes. As illustrated in FIG. 9, in HEVC, a total of 35 prediction modes are used, including planar, DC, and 33 angular modes. FIG. 10 is a schematic diagram illustrating intra prediction modes. As illustrated in FIG. 10, in VVC, a total of 67 prediction modes are used, including planar, DC, and 65 angular modes. FIG. 11 is a schematic diagram illustrating intra prediction modes. As illustrated in FIG. 11, in AVS3, a total of 66 prediction modes are used, including DC, plane, bilinear, pulse code modulation (PCM), and 62 angular modes.

Furthermore, there are some techniques to improve the prediction, such as fractional sample interpolation which improves reference samples, filtering of prediction samples, etc. For example, in multiple intra prediction filter (MIPF) in AVS3, prediction values are generated by using different filters for different block sizes. For different positions of samples within the same block, a filter is used to generate prediction values for samples that are closer to the reference samples, while another filter is used to generate prediction values for samples that are away from the reference samples. With aid of technology for filtering prediction samples, such as intra prediction filter (IPF) in AVS3, the prediction values can be filtered based on the reference samples.

In intra prediction, an intra mode coding technology using a most probable mode (MPM) list can be used to improve coding efficiency. The mode list is constructed with intra prediction modes for surrounding coded blocks, intra prediction modes derived from the intra prediction modes for the surrounding coded blocks such as a neighbourhood mode, and some commonly-used or high-probability intra prediction modes such as DC, planar, and bilinear modes. Reference to the intra prediction modes for the surrounding coded blocks utilizes spatial correlation because textures have a certain spatial continuity. The MPM(s) can be used as a prediction for intra prediction modes. That is, it is assumed that the probability of using the MPM for the current block is higher than not using the MPM. Therefore, during binarization, fewer codewords will be assigned to the MPM to reduce overhead and improve coding efficiency.

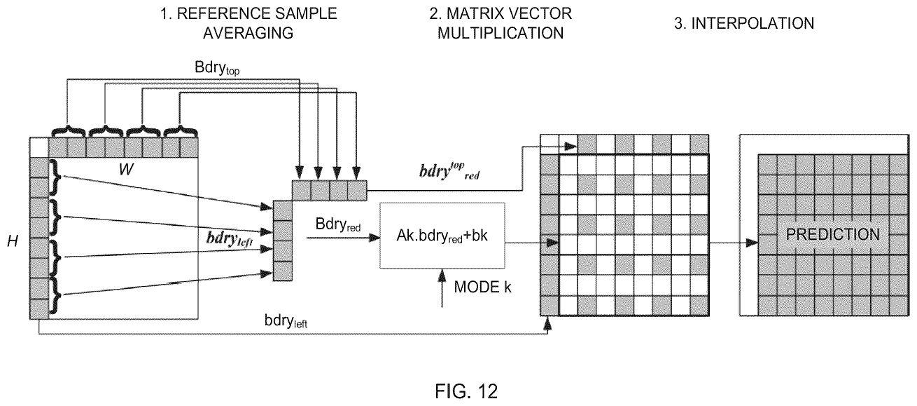

In some embodiments, matrix-based intra prediction (MIP), sometimes also written as matrix weighted intra prediction, can be applied for intra prediction. As illustrated in FIG. 12, in order to predict a block with the width of Wand the height of H, H reconstructed samples in a left column of the current block and W reconstructed samples in a top row of the current block are needed as inputs for the MIP. A prediction block in the MIP is mainly generated based on three operations: reference sample averaging, matrix vector multiplication, and interpolation. A core of MIP is matrix vector multiplication which can be regarded as a process of generating the prediction block from input samples (reference samples) by means of matrix vector multiplication. A variety of matrixes are provided in the MIP, different matrixes have different prediction methods, and same input samples will have different results using different matrixes. The process of reference sample averaging and interpolation is a compromise design between performance and complexity. For a larger block, reference sample averaging can be performed to achieve an approximate down-sampling effect, so that the input can be adapted to a smaller matrix, while interpolation achieves an up-sampling effect. In this way, there is no need to provide an MIP matrix for the block of each size, but only matrixes with one or more specific sizes are provided. With the increasing need for compression performance and improvement of hardware capabilities, a more complex MIP can appear in the next generation of standards.

The MIP mode is somewhat similar to the planar mode, but clearly, the MIP mode is more complex and flexible than the planar mode.

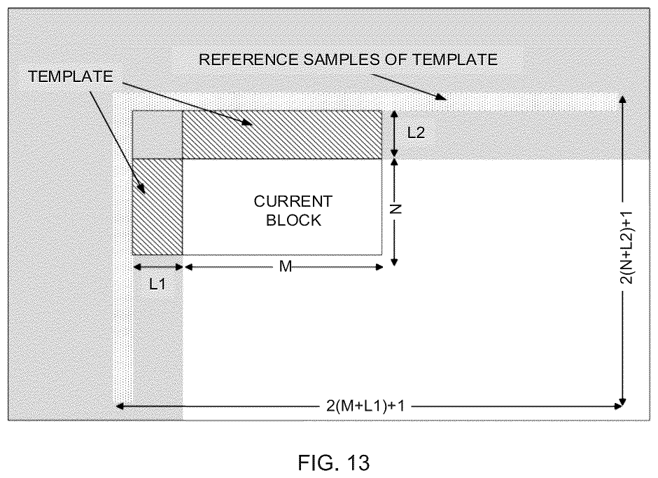

In some embodiments, template-based intra-prediction mode derivation (TIMD) can be applied as an intra-prediction technique. Exemplarily, as illustrated in FIG. 13, for the current block, a left area and a top area of the current block are used as a template. Except for the boundary case, when coding the current block, theoretically, reconstructed values at the left and the top of the current block can be obtained. This is also the basis for numerous template matching methods. In TIMD, the left area and the top area of the current block illustrated in FIG. 13 are used as the template, and samples neighbouring the left and the top of the template are used as reference samples of the template. A decoder can predict the template by applying a certain intra prediction mode, and compare a prediction value with a reconstructed value to obtain a cost of the intra prediction mode for the template. For example, the cost is a sum of absolute difference (SAD), a sum of absolute transformed difference (SATD), or a sum of squared error (SSE). Since the template neighbours the current block, the template has a correlation with the current block. Therefore, performance of a prediction mode on the template can be used to estimate performance of the prediction mode on the current block. In TIMD, prediction is performed on the template by applying some candidate intra prediction modes to obtain costs of the candidate intra prediction modes for the template, and a prediction value(s) under one or two intra prediction modes with the lowest cost(s) is taken as an intra prediction value(s) of the current block.

It is found from studies that if costs of two intra prediction modes for the template differ slightly, compression performance may be improved by weighted averaging of prediction values under the two intra prediction modes. Weights of the prediction values under the two prediction modes depend on the costs. In some embodiments, the weights are inversely proportional to the costs.

To summarize, in TIMD, the intra prediction modes are selected according to prediction performance of the intra prediction modes on the template, and two intra prediction modes can be weighted according to the costs of the two intra prediction modes for the template. The advantage of TIMD is that if the TIMD mode is selected for the current block, instead of indicating which intra prediction mode is applied, the intra prediction mode is derived by the decoder itself through the above procedure, thereby saving overhead to a certain extent.

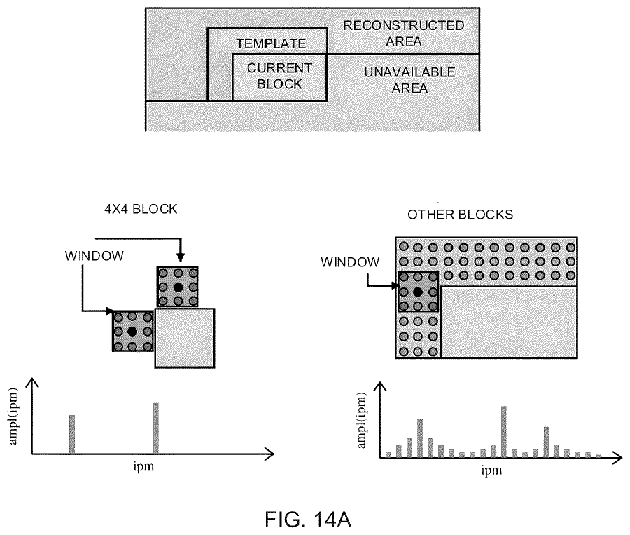

In some embodiments, decoder-side intra-prediction mode derivation (DIMD) can be applied as an intra-prediction technique. In DIMD, similarly, the prediction mode is derived by using reconstructed samples at the left and top of the current block. Instead of performing prediction on a template, gradients of reconstructed samples are analyzed. As illustrated in FIG. 14A, in DIMD, a gradient of a center sample of a window is analyzed, and an intra prediction mode is derived according to the gradient. As such, a result like a histogram in FIG. 14A can be obtained by analyzing all samples that need to be checked. The histogram is only intended to facilitate understanding, and may be implemented in various simple forms during implementation. In some embodiments, in DIMD, two intra prediction modes with the highest values in the histogram, together with the planar mode, are selected, and then prediction values under the three intra prediction modes are weighted, where the weights depend on the analysis result.

In an example, the process of prediction in DIMD is illustrated in FIG. 14B. Two intra prediction modes with the highest values in the histogram, that is, intra prediction modes corresponding to M1 and M2, are selected together with the planar mode, namely three intra prediction modes in total. Weights w1, w2, and w3 corresponding to the three intra prediction modes are determined, and prediction values Pred1, Pred2, and Pred3 corresponding to the three intra prediction modes are determined. The prediction values corresponding to the three intra prediction modes are weighted based on the corresponding weights to obtain a final prediction block.

It can be seen from the above that in DIMD, an intra prediction mode is selected by means of gradient analysis on reconstructed samples, and two intra prediction modes together with the planar mode can be weighted according to the analysis result. The advantage of DIMD is that if the DIMD mode is applied to the current block, instead of indicating which intra prediction mode is applied, the intra prediction mode is derived by the decoder itself through the foregoing procedure, thereby saving overhead to a certain extent.

There are many similarities between TIMD and DIMD, and even in some embodiments, their names are interchangeable. They all support weighting of prediction values under two or more intra prediction modes.

In GPM, two inter-prediction blocks are combined by using a weight matrix. In practice, usage of the weight matrix can be extended to combining any two prediction blocks, such as two inter-prediction blocks, two intra-prediction blocks, and one inter-prediction block and one intra-prediction block. A prediction block(s) of intra block copy (IBC) or palette can also be used as one or two of the prediction blocks in screen content coding.

In the disclosure, intra, inter, IBC, and palette are referred to as different prediction manners. For ease of elaboration, they are referred to as prediction modes. The prediction mode means that a coder can generate information of a prediction block of the current block according to the prediction mode. For example, in intra prediction, the prediction mode can be a certain intra prediction mode, such as DC, planar, and various intra angular prediction modes. One or more auxiliary information can also be added, for example, an optimization method for intra reference samples, an optimization method (for example, filtering) after a preliminary prediction block is generated, and the like. For example, in inter prediction, the prediction mode can be a skip mode, a merge mode, a merge mode with motion vector difference (MMVD), or an advanced motion vector prediction (AMVP) mode. The inter prediction mode can be unidirectional prediction, bidirectional prediction, or multi-hypothesis prediction. If unidirectional prediction is applied to the inter prediction mode, one motion information needs to be determined according to the prediction mode, and a prediction block can be determined according to the motion information. If bidirectional prediction is applied to the inter prediction mode, two motion information needs to be determined according to the prediction mode, and the prediction block can be determined according to the two motion information.

In this way, information that needs to be determined for GPM can be expressed as one weight derivation mode and two prediction modes. The weight derivation mode is used to determine a weight matrix or weights, and the two prediction modes are each used determine a prediction block or prediction value. The weight derivation mode is sometimes referred to as a partitioning mode, but since it is simulated partitioning, the disclosure tends to refer to the partitioning mode as a weight derivation mode.

Optionally, the two prediction modes may come from the same or different prediction modes, where the prediction mode includes but is not limited to intra prediction, inter prediction, IBC, and palette.

A specific example is as follows. GPM is applied to the current block and this example is applied to an inter-coded block, the intra prediction and the merge mode in the inter prediction are allowed to be used. As illustrated in Table 4, a syntax element intra_mode_idx is added, so as to indicate which prediction mode is an intra prediction mode. For example, if intra_mode_idx=0, it indicates that two prediction modes each are an inter prediction mode, that is, mode0IsInter=1 and mode0IsInter=1. If intra_mode_idx=1, it indicates that a 1^{st} prediction mode is an intra prediction mode and a 2^{nd} prediction mode is an inter prediction mode, that is, mode0IsInter=0 and mode0IsInter=1. If intra_mode_idx=2, it indicates that the 1^{st} prediction mode is an inter prediction mode and the 2^{nd} prediction mode is an intra prediction mode, that is, mode0IsInter=1 and mode0IsInter=0. If intra_mode_idx=3, it indicates that the two prediction modes each are an intra prediction mode, that is, mode0IsInter=0, and mode0IsInter=0.

TABLE 4

| | |
|---|---|
| { | |
| merge_gpm_partition_idx[x0][y0] | ae(v) |
| intra_mode_idx[x0][y0] | ae(v) |
| if( mode0IsInter ) | |
| merge_gpm_idx0[x0][y0] | ae(v) |
| if( (!mode0IsInter && mode1IsInter) \|\| | |
| (MaxNumGpmMergeCand > 2 && mode0IsInter && | |
| mode1IsInter)) | |
| merge_gpm_idx1[x0][y0] | ae(v) |
| } | |

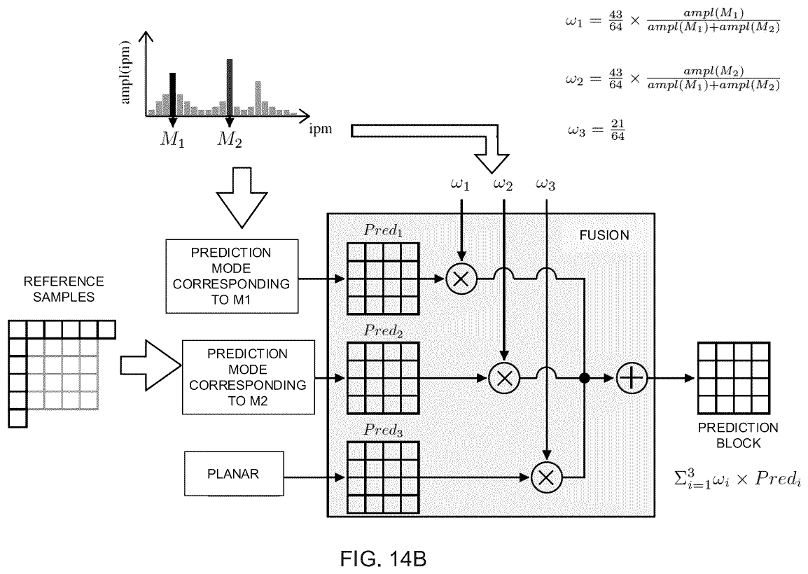

In some embodiments, as illustrated in FIG. 15, a GPM decoding process can be expressed as follows. A bitstream is parsed to determine whether a GPM technology is applied to the current block. If the GPM technology is applied to the current block, a weight derivation mode (or a partitioning mode or a weight matrix derivation mode), a 1^{st} prediction mode, and a 2^{nd} prediction mode are determined. A first prediction block is determined according to the 1^{st} prediction mode, a second prediction block is determined according to the 2^{nd} prediction mode, a weight matrix is determined according to the weight matrix derivation mode, and a prediction block of the current block is determined according to the first prediction block, the second prediction block, and the weight matrix.

Template matching is originally used in inter prediction. In template matching, by utilizing correlation between neighbouring samples, some regions neighbouring the current block are taken as a template. Before coding the current block, blocks on the left and the top of the current block have already been coded according to a coding order. However, when implemented by an existing hardware decoder, it may not be ensured that blocks on the left and the top of the current block have already been decoded before decoding the current block, where the current block is an inter block. For example, in HEVC, when generating a prediction block for an inter-coding block, neighbouring reconstructed samples are not required, and therefore, a prediction process for the inter block can be performed in parallel. However, for an intra-coding block, reconstructed samples on the left and on the top are required as reference samples. Theoretically, samples on the left and on the top are available, that is, this can be realized by making corresponding adjustments on hardware design. Samples on the right and on the bottom are unavailable based on a coding order in an existing standard such as VVC.

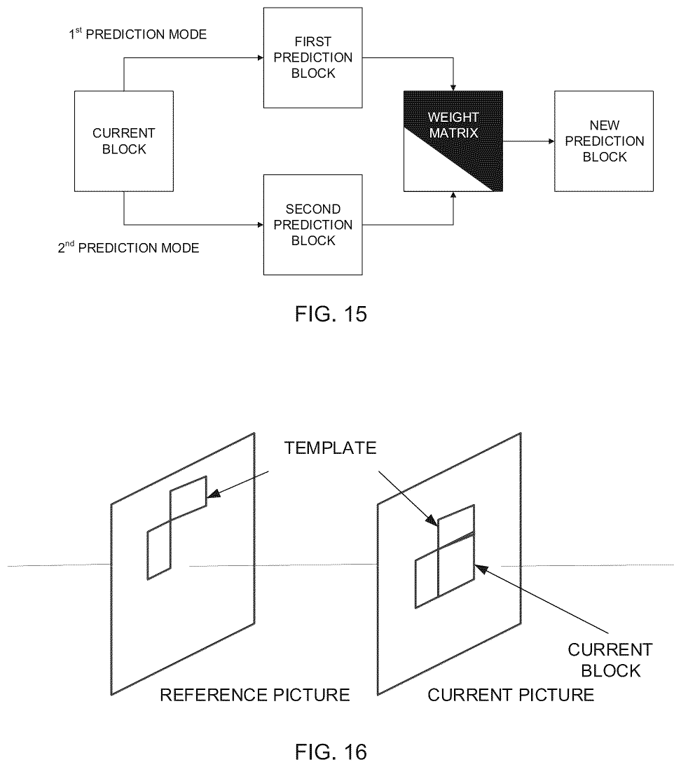

As illustrated in FIG. 16, rectangular regions on the left and the top of the current block are set as a template, where the height of the left part of the template is usually the same as the height of the current block, and the width of the top part of the template is usually the same as the width of the current block. The template can also have a different height or width from the current block. A best matching position of the template is found in a reference picture, so as to determine motion information or a motion vector of the current block. This process can be generally described as follows. In a certain reference picture, search within a certain range starting from a start position. A search rule can be pre-set, such as a search range and a search step size. Upon moving to a position each time, a degree of matching between a template corresponding to the position and a template neighbouring the current block is calculated. The degree of matching can be measured according to some distortion costs, such as an SAD and an SATD. A transform used in the SATD is usually a Hadamard transform or a mean-square error (MSE). A lower value of the SAD, the SATD, or the MSE indicates a higher degree of matching. A cost is calculated based on a prediction block of the template corresponding to the position and a reconstructed block of the template neighbouring the current block. In addition to searching for a position of an integer sample, searching for a position of a fractional sample may also be performed. The motion information of the current block is determined according to a position with the highest degree of matching found through searching. Due to correlation between neighbouring samples, motion information suitable for the template may also be motion information suitable for the current block. Template matching may not be applicable to some blocks, and therefore, whether template matching is applied to the current block can be determined according to some methods, for example, a control switch is used for the current block to indicate whether to apply template matching. Such template matching is also called decoder side motion vector derivation (DMVD). Both an encoder and a decoder can perform searching based on a template to derive motion information or find better motion information based on original motion information. In order to ensure consistency between encoding and decoding, the encoder and the decoder perform searching based on the same rule instead of transmitting a specific motion vector or motion vector difference. With template matching, it is possible to improve compression performance, but the decoder still needs to perform searching, which causes increase in decoder complexity.

The above is a method for applying template matching to inter prediction. Template matching can also be applied to intra prediction, for example, a template is used to determine an intra prediction mode. For the current block, a region within a certain range from the top and the left of the current block can be used as a template, such as a left rectangular region and a top rectangular region illustrated in the foregoing figure. When coding the current block, reconstructed samples in the template are available. This process can be generally described as follows. A set of candidate intra prediction modes is determined for the current block, where the candidate intra prediction modes constitute a subset of all available intra prediction modes, or the candidate intra prediction modes can be a universal set of all available intra prediction modes, which can be determined based on the trade-off between performance and complexity. The set of candidate intra prediction modes can be determined according to an MPM or some rules, such as equidistant screening. A cost, such as the SAD, the SATD, and the MSE, of each candidate intra prediction mode for the template is calculated. Prediction is performed on the template according to the mode to obtain a prediction block, and the cost is calculated according to the prediction block and a reconstructed block of the template. A mode with lower cost may match the template better, and due to similarity between neighbouring samples, an intra prediction mode that matches well with the template may also be an intra prediction mode that matches well with the current block. One or more modes with low cost are selected. The foregoing two steps can be repeated. For example, after one or more modes with low cost are selected, a set of candidate intra prediction modes is determined, cost is calculated for the newly determined set of candidate intra prediction modes, and one or more modes with lower cost are selected. This can also be understood as a rough selection and a fine selection. The one intra prediction mode finally chosen is determined as the intra prediction mode for the current block, or several intra prediction modes finally chosen are taken as candidates of the intra prediction mode for the current block. The set of candidate intra prediction modes can also be sorted by means of template matching. For example, an MPM list is sorted, that is, for each mode in the MPM list, a prediction block is obtained for the template according to the mode and a cost thereof is determined, and these modes are sorted in an ascending order of cost. Generally, a mode at the front in the MPM list corresponds to lower overhead in a bitstream, which can also improve compression efficiency.

Template matching can be used to determine two prediction modes of GPM. If template matching is applied to GPM, one control switch can be used for the current block to control whether template matching is applied to the two prediction modes for the current block, or two control switches can be used respectively to control whether template matching is applied to each of the two prediction modes.

Another aspect is how to apply template matching. For example, if GPM is applied in the merge mode, for example, in GPM in VVC, merge_gpm_idxX is used to determine motion information from mergeCandList, where X=0 or 1. For X^{th} motion information, one method is to perform optimization by means of template matching based on the foregoing motion information. That is, the motion information is determined from mergeCandList according to merge_gpm_idxX. If template matching is applied to the motion information, template matching is used to perform optimization based on the motion information. Another method is to determine the motion information directly by searching based on default motion information, instead of using merge_gpm_idxX to determine the motion information from mergeCandList.

If an X^{th} prediction mode is an intra prediction mode and template matching is applied to an X^{th} prediction mode for the current block, template matching can be used to determine an intra prediction mode, and an index of the intra prediction mode does not need to be indicated in a bitstream. Alternatively, a candidate set or an MPM list is determined by means of template matching, and an index of the intra prediction mode needs to be indicated in a bitstream.

In an inter-and-intra prediction method for GPM, a prediction value for GPM is obtained by weighting an intra prediction value and an inter prediction value according to weights for a GPM mode. Prediction mode information (motion information) of inter prediction is derived in a similar manner as that in the VVC standard. With regard to a prediction mode for intra prediction, an intra prediction mode candidate list needs to be constructed for a corresponding part under the GPM mode, where the list may also be referred to as an MPM list. The encoder signals an index of an intra prediction mode selected for the current block into a bitstream. During decoding, the decoder constructs the MPM list for the GPM mode in the same manner, and determines the intra prediction mode according to the index of the intra prediction mode obtained by decoding. Exemplarily, the corresponding part under the GPM mode may be understood as a white part or a black part in the partitioning diagram in FIG. 4 or FIG. 5, and may be hereinafter referred to as a first part and a second part for the convenience of illustration. In an example, the first part is the white part, the second part is the black part, the first part corresponds to a 1^{st} prediction mode, and the second part corresponds to a 2^{nd} prediction mode. The first part and the second part are more intuitive and easier to understand, but in practice, the first part and the second part may not appear in a specific algorithm.

When constructing an MPM list of intra prediction modes for a corresponding part under a GPM weight derivation mode, several preset intra prediction modes are added to the MPM list sequentially until the length of the list reaches 3. Optionally, the preset several intra prediction modes include: an intra prediction mode derived based on DIMD and an intra prediction mode derived based on TIMD.

It can be seen from the foregoing elaborations that, GPM has three elements, namely one weight matrix and two prediction modes. With GPM, it is more conducive to autonomous combination by using the weight matrix. However, on the other hand, in GPM, more information needs to be determined, which results in more overhead in the bitstream. Taking GPM as an example, optionally, GPM is applied in the merge mode. The weight matrix is determined according to merge_gpm_partition_idx in a bitstream, the 1^{st} prediction mode is determined according to merge_gpm_idx0 in the bitstream, and the 2^{nd} prediction mode is determined according to merge_gpm_idx1 in the bitstream. There are multiple possible choices for each of the weight matrix and the two prediction modes. For example, there are 64 possible choices for the weight matrix in VVC, and merge_gpm_idx0 and merge_gpm_idx1 each allow up to 6 possible choices in VVC, but it is specified in VVC that merge_gpm_idx0 is different from merge_gpm_idx1, and accordingly, there are 65×6×5 possible choices for GPM. If MMVD is applied for optimizing two motion information (prediction modes), there can also be multiple possible choices for each prediction mode, which leads to a huge amount. On the other hand, it can be found that the template matching method can also be applied for optimizing two motion information (prediction modes), which additionally provides more possible choices. However, even if template matching is applied for optimizing two motion information (prediction modes), in the current state of technology evolution, a block-level switch is still needed to indicate whether template matching is applied to the current block.

If two intra prediction modes are applied for GPM, 67 common intra prediction modes in VVC can be applied to each of the two intra prediction modes, and the two intra prediction modes are different, then there are 64×67×66 possible choices. In order to save overhead, there can be a restriction that only a subset of all the common intra prediction modes can be applied to each prediction mode, but there are still a large number of possible choices.

If one intra prediction mode and one inter prediction mode are applied for GPM, the number of possible choices can be obtained according to the foregoing case of the intra prediction mode and the inter prediction mode.

In some embodiments, indications of one weight derivation mode and two prediction modes in GPM are signalled into and parsed from a bitstream by using their respective syntax elements. For example, the weight derivation mode has one or more syntax elements of its own, the 1^{st} prediction mode has one or more syntax elements of its own, and the 2^{nd} prediction mode also has one or more syntax elements of its own. There can be a restriction specified in the standard that the 2^{nd} prediction mode cannot be the same as the 1^{st} prediction mode in some cases, or some optimization methods can be applied to both of the two prediction modes (which can also be understood as applied to the current block), but the three are relatively independent in signalling and parsing of syntax elements. “Relatively independent” herein may also be understood as having a certain association, but other possible choices are still independent after the restriction is eliminated.

For equally likely events, it is suitable to apply fixed-length coding. For the case where probabilities differ significantly, a shorter code is assigned to a high-probability event, while a longer code is assigned to a low-probability event, thereby improving encoding efficiency. For the weight derivation mode and the prediction mode that are in two different dimensions, probability estimation of one of the two dimensions is separated from probability estimation of the other one of the two dimensions.

Since one weight derivation mode and two prediction modes are applied together to generate a prediction block, and the prediction block is applied to the current block, there is an association between the one weight derivation mode and the two prediction modes. For example, the current block includes edges of two objects that are in relative motion, which is an ideal scenario for inter-GPM. In this case, theoretically, such “partitioning” should be performed on the edges of the objects. However, in practice, the number of possible choices for “partitioning” is limited, and it is impossible to cover all of the edges. In some cases, similar “partitioning” is selected, and then there is more than one such similar “partitioning”. The selection depends on which “partitioning” leads to the optimal result when combined with the two prediction modes. Likewise, which prediction mode is to be selected sometimes also depends on which combination leads to the optimal result. This is because for a part to which the prediction mode is applied, for a natural video, it is still difficult to match the current block completely. The prediction mode finally selected may lead to the highest coding efficiency. Another scenario in which GPM is commonly applied is that the current block includes a part where there is relative motion in an object, such as a position where an arm swings and thus causes twisting and deformation. For such part, “partitioning” is more indistinct, and may finally depend on which combination leads to the optimal result. Another scenario is intra prediction. Since the texture of some parts of a natural picture is very complex, there is gradual transition from one kind of texture to another kind of texture in some parts, and some parts may be difficult to be represented by using a single direction. With intra-GPM, a more complex prediction block can be provided. However, an intra-coded block typically have a larger residual relative to an inter-coded block under the same quantization level. Therefore, which prediction mode is to be selected may ultimately depend on which combination leads to the optimal result.

The “combination” mentioned above in various places means that instead of selecting the weight derivation mode and the prediction mode(s) separately in two or three dimensions, a combination of a weight derivation mode and prediction modes is selected by considering the weight derivation mode in conjunction with the prediction modes. When implemented by a syntax element, a syntax element for a “combination” is used, and one weight derivation mode and two prediction modes can be determined according to the combination.

That is, the encoder and the decoder may each generate N candidate combinations consistently. For example, the encoder and the decoder each construct a list of N candidate combinations, where each candidate combination can be used to derive a combination of one weight derivation mode and two prediction modes. The encoder only needs to signal into the bitstream which candidate combination is selected, and the decoder parses to obtain which candidate combination is selected by the encoder. In the disclosure, the list is referred to as a GPM combination candidate list or a candidate combination list.

In an example, combinations in the GPM combination candidate list are usually ranked in a descending order of probabilities of the combinations being selected. In this case, shorter codewords than those in an existing method may be assigned to candidate combinations ranked at the front, while longer codewords are assigned to some combinations which are less likely to be selected, which improves overall coding efficiency. Compared with the existing method in which there are three parts, by adopting the method of the solution, theoretically, it is more conducive to flexibility, and it is easier to approximate the most efficient correspondence between probabilities and codewords.

As mentioned above, in some cases, there is a huge number of possible combinations for GPM, and longer codewords are required to indicate such huge number of candidates. However, if some combinations with low probability of occurrence can be excluded in advance, a cost of a combination with high probability of occurrence can also be reduced. Although the case with low probability of occurrence can also be excluded with regard to each part in the existing method, by adopting a combination-based manner, it is more conducive to flexibility. For example, in the existing method, if one “partitioning” is excluded, all possible choices including such “partitioning” are excluded.

Another advantage is that the syntax is simpler, and there is no need for making determination with regard to various cases when parsing.

Regarding how to encode gpm_cand_idx, it depends on the probability as described above. In an example, exponential-Golomb coding is applied. If the number of candidates is small, that is, only a few modes with the highest probability can be selected, then fixed-length coding may also be applied. For example, when there are only 16 candidates, the 16 candidates are encoded with the same bit length.

For blocks of different sizes, different numbers of candidate combinations may be set. For example, for a small block, prediction results under similar weight derivation modes or prediction modes differ slightly, while for a larger block, prediction results under similar weight derivation modes or prediction modes will have more significant difference. Therefore, in one manner, a small number of candidate combinations is set for a small block, while a large number of candidate combinations is set for a large block. The block can be determined as large or small according to the width and height of the block or the number of samples in the block. In an example, the number of candidates is set to 8 for a block in which the number of samples is smaller than (or smaller than or equal to) 256, and the number of candidates is set to 16 for a block in which the number of samples is greater than or equal to (or greater than) 256.

The process of constructing the GPM combination candidate list will be described below.

In some embodiments, more related information can be used to analyze the probability of occurrence of each combination, such as mode information of a neighbouring block and reconstructed samples.

In one manner, the GPM combination candidate list is constructed based on a template.

In general, the height of a top template is consistent with the width of a left template, and the value may be 1, 2, 4, etc. As an example, when constructing the GPM combination candidate list based on the template, by using a top template with a height of 1 and/or a left template with a width of 1, it is possible to reduce complexity of calculation appropriately. It should be noted that, “a top template with a height of 1” may mean that the top template of the current block includes one row of decoded or encoded samples neighbouring the top of the current block, and “a left template with a width of 1” may mean that the left template of the current block includes one column of decoded or encoded samples neighbouring the left of the current block.

In the case of using a template, since more related information, i.e. reconstructed information around the current block, can be used for the current block, it is possible to better utilize correlation between the foregoing three elements. In other words, the current block is estimated by using the reconstructed information around the current block.

In one manner, for each combination, a template is predicted by means of GPM, to obtain a prediction block of the template under the combination. Since a reconstructed value has been obtained for the template, a prediction distortion cost, such as an SAD, an SATD, or an SSE, can be calculated according to the prediction block of the template under the combination and a reconstructed block of the template. Various combinations are ranked according to the respective prediction distortion costs, or a list for which only the first N combinations with the minimum predictive distortion costs are maintained is constructed. In this way, the GPM combination candidate list can be constructed.

In the foregoing method, for a certain combination, a first prediction value of the template is generated by applying a 1^{st} prediction mode, a second prediction value of the template is generated by applying a 2^{nd} prediction mode, weights for sample positions in the template are derived according to a weight derivation mode, and a prediction value of the template is determined according to the first prediction value, the second prediction value, and the weights.

The encoder and the decoder need to adopt the same method for constructing the GPM combination candidate list, so as to ensure consistency between encoding and decoding. As mentioned above, the number of all possible GPM combinations may be huge. The above method is an exhaustive approach. During implementation, the GPM combination candidate list can be constructed by means of a fast algorithm, but the algorithm adopted by the encoder should be the same as that adopted by the decoder. For example, hierarchical screening is performed on various combinations. Alternatively, some combinations which are inferred to have high probability according to known information are firstly checked, and some early termination conditions are set.

In some embodiments, the embodiments are applied to an intra-coded block, but not applicable to a block subject to screen content coding. This does not mean that the solution cannot be applied to a block subject to screen content coding, but is only intended for elaborating the solution by using the simplest example. The reason is that for a block that is intra coded but not subject to screen content coding, only intra prediction modes need to be taken into consideration, without considering a mode for screen content coding such as IBC or palette as well as various inter modes. The solution can be applied to any case where GPM is applicable, as described above.

It is assumed herein that there are 64 possible weight derivation modes and 67 possible intra prediction modes for GPM, which can be found from the VVC standard, but does not mean that there are only 64 possible types of weights for GPM or does not limit the specific types of the 64 possible types of weights for GPM. It should be noted that, using of 64 types for GPM in VVC is with respect to the trade-off between improving prediction effect and reducing overhead in the bitstream. However, in the solution, encoding of the weight derivation mode is not implemented based on a fixed logic, and theoretically, more types of weights are applicable and can be applied more flexibly in the solution. Likewise, it does not mean that there are only 67 intra prediction modes for GPM or does not limit the specific types of the 67 intra prediction modes for GPM, and theoretically, all possible intra prediction modes can be applied in GPM. For example, if an intra angular prediction mode is further detailed and there are more intra angular prediction modes introduced, then more intra angular prediction modes can be applied in GPM, for example, an MIP mode in VVC can also be applied in the solution. However, considering that there are multiple sub-modes of MIP, MIP is not elaborated in embodiments for ease of understanding. In addition, there are some wide-angle modes, which can also be applied in the disclosure, but will not be elaborated in embodiments.

If two intra prediction modes are not allowed to be the same, there are 64*67*66 possible combinations in total in embodiments. If an exhaustive approach is adopted, the template is predicted by applying all of these possible combinations, and distortion costs of these combinations are calculated. Alternatively, some intra prediction modes may not be tried, because an MPM list for the current block can be obtained according to a prediction mode(s) for a neighbouring block(s). For example, in VVC, an MPM list with a length of 6 can be obtained for the current block. In addition, in some subsequent evolved technologies, there is a scheme of secondary MPM, where an MPM list with a length of 22 can be derived, that is, the length of a first MPM list and the length of a second MPM list are 22 in total. In the solution, the MPM can be used for selection of intra prediction modes. Further, an MPM list applicable to a GPM mode for the current block can also be constructed. For example, prediction modes applied to all neighbouring blocks of the current block are added to the MPM list. For example, if the MPM list does not include special prediction modes such as DC, a horizontal prediction mode, or a vertical prediction mode, then one or more of the special prediction modes are added to candidate intra prediction modes of the solution. For example, intra prediction modes related to a weight partition line are added to the candidate intra prediction modes of the solution. In an example, one or more intra angular prediction modes parallel to or approximately parallel to the partition line are added; and in another example, one or more intra angular prediction modes perpendicular to or approximately perpendicular to the partition line are added. Optionally, intra prediction mode candidates of the solution may be determined according to a weight derivation mode. Optionally, the intra prediction mode candidates of the solution may be determined with regard to each of two intra prediction modes. To summarize, at least one GPM intra prediction mode candidate set/list can be obtained. The total number of available prediction modes may also be restricted to reduce complexity of a decoding end, for example, there is a restriction that at most six prediction modes can be applied. The above methods may be used separately or in any combination.

It can be seen from the foregoing elaborations that, when applying the intra prediction modes in GPM, an MPM list needs to be constructed, in other words, a list or set of candidate prediction modes needs to be selected, which is conducive to reducing overhead or reducing complexity. An example of complexity reduction is to reduce the number of possible combinations that need to be tried by performing selection on intra prediction modes in GPM combination-based coding described above, thereby reducing calculation burden and reducing complexity. However, currently, the constructed candidate prediction mode list is not accurate enough, for example, several preset categories of prediction modes are determined as candidate prediction modes, thus reducing accuracy of prediction of the current block.

In order to solve the above technical problem, in embodiments of the disclosure, during coding of a current block, N candidate weight derivation modes and a candidate prediction mode list are determined, where the candidate prediction mode list includes at least one candidate prediction mode, and the at least one candidate prediction mode includes a prediction mode determined based on partitioning a template of the current block. That is, in embodiments of the disclosure, when determining the candidate prediction mode, the prediction mode is derived from a template(s) obtained by partitioning, which can realize accurate derivation of a prediction mode. As such, by performing prediction based on the accurately-derived prediction mode, it is possible to improve accuracy of prediction, thereby improving coding performance.

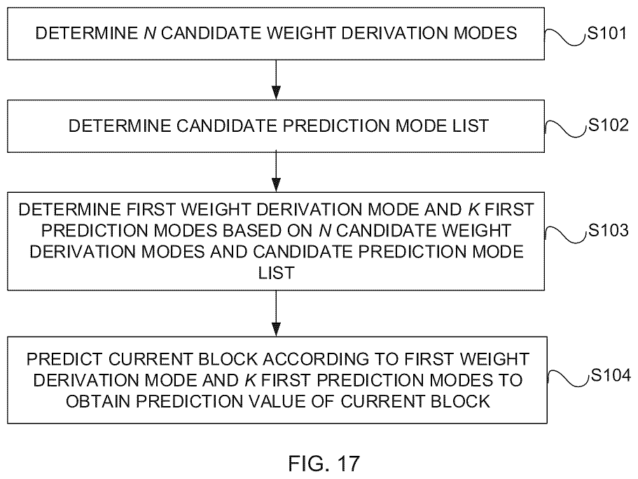

A video decoding method provided in embodiments of the disclosure will be described below with reference to FIG. 17 by taking a decoding end as an example.

FIG. 17 is a schematic flowchart of a video decoding method provided in an embodiment of the disclosure. The embodiment of the disclosure is applied to the video decoders illustrated in FIG. 1 and FIG. 3. As illustrated in FIG. 17, the method according to embodiments of the disclosure includes the following.

S101, N candidate weight derivation modes are determined.

N is a positive integer. Optionally, N is a preset value or a default value. Optionally, N is indicated by an encoding end to the decoding end. For example, at the encoding end, N candidate weight derivation modes are determined and then Nis signalled into a bitstream. In this way, at the decoding end, N is obtained by decoding the bitstream. Optionally, N may also be determined at the decoding end in other manners, which is not limited in embodiments of the disclosure.

It can be seen from the above that, in embodiments of the disclosure, a prediction block is generated based on one weight derivation mode and K prediction modes, and the prediction block is applied to a current block. In other words, weights are determined according to the weight derivation mode, the current block is predicted according to the K prediction modes to obtain K prediction values, and the K prediction values are weighted according to the weights, to obtain a prediction value of the current block.

That is, at the decoding end, when decoding the current block, the N candidate weight derivation modes and multiple candidate prediction modes need to be determined. Further, one weight derivation mode is selected from the N candidate weight derivation modes, and K prediction modes are selected from the multiple candidate prediction modes. Then the current block is predicted by applying the selected one weight derivation mode and K prediction modes, to obtain the prediction value of the current block.

In embodiments of the disclosure, there is no limitation on the manner for the decoding end to determine the N candidate weight derivation modes.

In a possible implementation, there are 56 weight derivation modes for AWP and 64 weight derivation modes for GPM. The N candidate weight derivation modes include at least one weight derivation mode in the 56 weight derivation modes for AWP, or include at least one weight derivation mode in the 64 weight derivation modes for GPM.

In a possible implementation, some of the weight derivation modes for AWP or GPM can be selected and taken as the N candidate weight derivation modes. That is, the N candidate weight derivation modes in embodiments of the disclosure are a subset of all the weight derivation modes for AWP or GPM. For example, for weight derivation modes, the same “partition” angle may correspond to multiple offsets. For example, weight derivation modes 10, 11, 12, and 13 illustrated in FIG. 4 or FIG. 5 have the same “partition” angle, but have different offsets. Therefore, in embodiments of the disclosure, modes corresponding to some offsets can be removed, and modes corresponding to some “partition” angles can also be removed. As such, it is possible to reduce the total number of possible combinations, and on the other hand, to make various possible combinations differ more significantly. Different selection methods may be set for blocks of different sizes. For example, fewer weight derivation modes are set for a small block, while more weight derivation modes are set for a large block. Different selection methods may also be set for blocks of different shapes, where the block shape can refer to the ratio of width to height.

In this implementation, the manner for selecting the N candidate weight derivation modes at the encoding end is the same as that at the decoding end. In an example, the manner for selecting the N candidate weight derivation modes is default at both the encoding end and the decoding end. In another example, at the encoding end, the manner for selecting the N candidate weight derivation modes may be indicated to the decoding end, so that at the decoding end, the N candidate weight derivation modes that are the same as those at the encoding end can be selected in the same manner.

In some embodiments, a weight derivation mode corresponding to a preset partition angle and/or a preset offset is removed from M preset weight derivation modes, to obtain the N weight derivation modes. In the weight derivation modes, the same partition angle may correspond to multiple offsets. As illustrated in FIG. 4, weight derivation modes 10, 11, 12, and 13 have the same partition angle, but have different offsets. Therefore, weight derivation modes corresponding to some preset offsets can be removed, and/or weight derivation modes corresponding to some preset partition angles can be removed.

In some embodiments, selection conditions corresponding to different blocks can be different. In this way, when determining N weight derivation modes corresponding to the current block, a selection condition corresponding to the current block is firstly determined, and then N weight derivation modes are selected from the M preset weight derivation modes according to the selection condition corresponding to the current block.

In some embodiments, the selection condition corresponding to the current block includes a selection condition corresponding to the size of the current block and/or a selection condition corresponding to the shape of the current block. During prediction, for a small block, prediction results under similar weight derivation modes differ slightly, while for a large block, prediction results under similar weight derivation modes will have more significant difference. Therefore, in embodiments of the disclosure, different values of N are set for blocks of different sizes, i.e. a large value of N is set for a large block, while a small value of N is set for a small block.

In a possible implementation, the N candidate weight derivation modes are indicated to the decoding end.

In some embodiments, the selection condition is implemented by an array. The array includes N elements, and the N elements are in one-to-one correspondence with the N weight derivation modes. An element corresponding to each weight derivation mode indicates whether the weight derivation mode is applicable.

The array can be a one-dimensional array or a two-dimensional array.

For example, taking GPM as an example, the total number of possible weight derivation modes is 64. At the encoding end, a look-up table including 64 elements is set, where a value of each element indicates whether to apply a weight derivation mode corresponding to the element.

In an example, taking a one-dimensional array as an example, a specific example is as follows, in which an array of g_sgpm_splitDir is set:

g_sgpm_splitDir[64] = {
1,1,1,0,1,0,1,0,
1,0,1,0,1,0,1,0,
1,0,1,1,1,0,1,0,
1,0,1,0,1,0,1,0,
0,0,0,0,1,1,0,1,
0,0,1,0,0,1,0,0,
1,0,1,1,0,1,0,0,
1,0,0,1,0,0,1,0
};

If the value of g_sgpm_splitDir[x] is 1, it indicates that a weight derivation mode with an index of x is applicable; otherwise, it indicates that the weight derivation mode with an index of x is not applicable. In this example, at the decoding end, 26 candidate weight derivation modes are determined based on the array.

In another example, the N candidate weight derivation modes may be indicated by one array, where the array includes only an index of a weight derivation mode that is applicable. For example, 26 candidate weight derivation modes are indicated by an array g_sgpm_splitDir[26]={0,1,6,8,10,12,14,16,18,19,20,22,24,26,28,30,36,37,42,45,48,50,51,53,56,59} with a length of 26. At the decoding end, based on indexes of weight derivation modes in the array, weight derivation modes corresponding to the indexes are determined as the candidate weight derivation modes, thereby obtaining 26 candidate weight derivation modes.

In some embodiments, if the selection condition corresponding to the current block includes the selection condition corresponding to the size of the current block and the selection condition corresponding to the shape of the current block, and for the same weight derivation mode, if the selection condition corresponding to the size of the current block and the selection condition corresponding to the shape of the current block both indicate that the weight derivation mode is applicable, the weight derivation mode is determined as one of the N weight derivation modes. If at least one of the selection condition corresponding to the size of the current block or the selection condition corresponding to the shape of the current block indicates that the weight derivation mode is not applicable, it is determined that the weight derivation mode does not belong to the N weight derivation modes.

In some embodiments, selection conditions corresponding to different block sizes and selection conditions corresponding to different block shapes can be implemented separately by multiple arrays.

In some embodiments, selection conditions corresponding to different block sizes and selection conditions corresponding to different block shapes can be implemented by two-dimensional arrays, that is, one two-dimensional array includes both the selection condition corresponding to the block size and the selection condition corresponding to the block shape.

Exemplarily, for a block with a size of A and a shape of B, a selection condition corresponding to the block is illustrated below, and the selection condition is represented by a two-dimensional array:

g_sgpm_splitDir[64] = {
(1,1),(1,1),(1,1),(1,0),(1,0),(0,0),(1,0),(1,1),
(1,1),(0,0),(1,1),(1,0),(1,0),(0,0),(1,0),(1,1),
(0,1),(0,0),(1,1),(0,0),(1,0),(0,0),(1,0),(0,0),
(1,1),(0,0),(0,1),(1,0),(1,0),(1,0),(1,0),(0,0),
(0,0),(0,0),(1,1),(0,0),(1,1),(1,1),(1,0),(0,1),
(0,0),(0,0),(1,1),(0,0),(1,0),(0,0),(1,0),(0,0),
(1,0),(0,0),(1,1),(1,0),(1,0),(1,0),(0,0),(0,0),
(1,1),(0,0),(1,1),(0,0),(0,0),(1,0),(1,1),(0,0)
};

If both values of g_sgpm_splitDir[x] are 1, it indicates that a weight derivation mode with an index of x is applicable; and if one of the values of g_sgpm_splitDir[x] is 0, it indicates that the weight derivation mode with an index of x is not applicable. For example, g_sgpm_splitDir[4]=(1,0) indicates that weight derivation mode 4 is applicable to a block with a size of A, but is not applicable to a block with a shape of B. Therefore, if the size of a block is A and the shape of the block is B, the weight derivation mode is not applicable.

It should be noted that, in the foregoing elaborations, the 64 weight derivation modes for GPM are taken as an example, but the weight derivation mode in embodiments of the disclosure includes, but is not limited to, the 64 weight derivation modes for GPM and the 56 weight derivation modes for AMP.

In some embodiments, at the decoding end, before determining the N candidate weight derivation modes, whether K different prediction modes are applied to the current block for weighted prediction needs to be determined. If it is determined at the decoding end that K different prediction modes are applied to the current block for weighted prediction, the foregoing S101 is performed to determine the N candidate weight derivation modes. If it is determined at the decoding end that K different prediction modes are not applied to the current block for weighted prediction, S101 is skipped.

In a possible implementation, at the decoding end, whether K different prediction modes are applied to the current block for weighted prediction can be determined by determining a prediction-mode parameter for the current block.

Optionally, in embodiments of the disclosure, the prediction-mode parameter can indicate whether a GPM mode or an AWP mode can be applied to the current block, that is, indicate whether K different prediction modes can be applied for prediction of the current block.

It can be understood that, in embodiments of the disclosure, the prediction-mode parameter can be understood as a flag indicating whether the GPM mode or the AWP mode is applied. Specifically, an encoder can use a variable as the prediction-mode parameter, so that the prediction-mode parameter can be set by setting the value of the variable. Exemplarily, in the disclosure, if the GPM mode or the AWP mode is applied to the current block, the encoder can set the value of the prediction-mode parameter to indicate that the GPM mode or the AWP mode is applied to the current block, and specifically, the encoder can set the value of the variable to 1. Exemplarily, in the disclosure, if the GPM mode or the AWP mode is not applied to the current block, the encoder can set the value of the prediction-mode parameter to indicate that the GPM mode or the AWP mode is not applied to the current block, and specifically, the encoder can set the value of the variable to 0. Further, in embodiments of the disclosure, after setting the prediction-mode parameter, the encoder can signal the prediction-mode parameter into the bitstream and transmit the bitstream to a decoder, so that the decoder can obtain the prediction-mode parameter after parsing the bitstream.

Based on this, at the decoding end, the bitstream is decoded to obtain the prediction-mode parameter, and then whether the GPM mode or the AWP mode is applied to the current block is determined according to the prediction-mode parameter. If the GPM mode or the AWP mode is applied to the current block, i.e. K different prediction modes are applied for prediction, N candidate weight derivation modes corresponding to the current block are determined.

In some embodiments, in embodiments of the disclosure, a condition regarding whether the GPM mode or the AWP mode is applied to the current block can also be set, i.e. if the current block is determined to satisfy a preset condition, it is determined that K prediction modes are applied to the current block for weighted prediction, and then the N candidate weight derivation modes corresponding to the current block are determined.

Exemplarily, when applying the GPM mode or the AWP mode, restriction can be imposed on the size of the current block.

It can be understood that, in the prediction method provided in embodiments of the disclosure, K prediction values need to be generated by applying K different prediction modes, and then are weighted according to weights to obtain the prediction value of the current block. In order to reduce complexity and take into consideration the trade-off between compression performance and complexity, in embodiments of the disclosure, there can be a restriction that the GPM mode or the AWP mode is not applied to a block of a certain size. Therefore, in the disclosure, the decoder can firstly determine a size parameter of the current block, and then determine, according to the size parameter, whether the GPM mode or the AWP mode is applied to the current block.

In embodiments of the disclosure, the size parameter of the current block can include the height and the width of the current block, and in this case, the decoder can determine, according to the height and the width of the current block, whether the GPM mode or the AWP mode is applied to the current block.

Exemplarily, in the disclosure, if the width is greater than threshold 1 and the height is greater than threshold 2, it is determined that the GPM mode or the AWP mode can be applied to the current block. As can be seen, one possible restriction is that the GPM mode or the AWP mode can be applied only if the width of the block is greater than (or greater than or equal to) threshold 1 and the height of the block is greater than (or greater than or equal to) threshold 2. The values of threshold 1 and threshold 2 can be 4, 8, 16, 32, 128, 256, etc., and threshold 1 can be equal to threshold 2.

Exemplarily, in the disclosure, if the width is less than threshold 3 and the height is greater than threshold 4, it is determined that the GPM mode or the AWP mode can be applied to the current block. As can be seen, one possible restriction is that the GPM mode or the AWP mode can be applied only if the width of the block is less than (or less than or equal to) threshold 3 and the height of the block is greater than (or greater than or equal to) threshold 4. The values of threshold 3 and threshold 4 can be 4, 8, 16, 32, 128, 256, etc., and threshold 3 can be equal to threshold 4.

Further, in embodiments of the disclosure, the size of the block to which the GPM mode or the AWP mode can be applied can also be restricted by restricting a sample parameter.

Exemplarily, in the disclosure, the decoder can firstly determine a sample parameter of the current block, and then determine, according to the sample parameter and threshold 5, whether the GPM mode or the AWP mode can be applied to the current block. As can be seen, one possible restriction is that the GPM mode or the AWP mode can be applied only if the number of samples in the block is greater than (or greater than or equal to) threshold 5, where the value of threshold 5 can be 4, 8, 16, 32, 128, 256, 1024, etc.

That is, in the disclosure, the GPM mode or the AWP mode can be applied to the current block only if the size parameter of the current block satisfies the size requirement.

Exemplarily, in the disclosure, a picture-level flag can be used to determine whether the disclosure is applied to a current picture to-be-decoded. For example, it can be configured that the disclosure is applied to an intra frame (such as I frame) but is not applied to an inter frame (such as B frame or P frame). Alternatively, it can be configured that the disclosure is applied to an inter frame but is not applied to an intra frame. Alternatively, it can be configured that the disclosure is applied to some inter frames but is not applied to other inter frames. Since intra prediction can also be applied to an inter frame, the disclosure may also be applied to an inter frame.

In some embodiments, a flag below a picture level can be used to determine whether the disclosure is applied to the current block.

S102, a candidate prediction mode list is determined.

The candidate prediction mode list includes at least one candidate prediction mode, and the at least one candidate prediction mode includes a prediction mode determined based on partitioning a template of the current block.

In some embodiments, when using a template in TIMD, the whole template including a left template and a top template is used together to derive an intra prediction mode for TIMD. If a template at a certain side does not exist, for example, in a case that the current block is located at the left boundary or the top boundary of a picture, only a template that exists can be used in TIMD. However, if templates at both sides exist, these templates will be used together. When using neighbouring reconstructed samples in DIMD, left reconstructed samples and top reconstructed samples will be used together to derive an intra prediction mode for DIMD. If there is no reconstructed sample at a certain side, for example, in a case that the current block is on the left boundary or the top boundary of the picture, only reconstructed samples that exist can be used in DIMD. However, if both left reconstructed samples and top reconstructed samples exist, these reconstructed samples will be used together. This does not matter for a non-GPM block. However, for a GPM block, a correlation between a 1^{st} prediction mode and the left and top templates or the left and top reconstructed samples is different from a correlation between a 2^{nd} prediction mode and the left and top templates or the left and top reconstructed samples. If a prediction mode is derived from the whole template, the prediction mode derived will have low accuracy, and as a result, a candidate prediction mode list thus constructed will be inaccurate. If the current block is predicted based on the candidate prediction mode list that is inaccurate, it is hard to realize accurate prediction of the current block.

In order to solve the technical problem, in embodiments of the disclosure, partitioning is performed on the template of the current block, where partitioning of the template can be understood as partitioning the template into multiple sub-templates, or partitioning a reconstructed sample area in which the template is located into multiple reconstructed sample sub-areas. In this way, by deriving the prediction mode from the template obtained by partitioning or the reconstructed sample area obtained by partitioning, it is possible to improve accuracy of prediction mode derivation, thereby improving accuracy of construction of the candidate prediction mode list. By performing prediction based on a candidate prediction mode list that is constructed accurately, it is possible to improve prediction accuracy, thereby improving decoding performance.

In embodiments of the disclosure, there is no limitation on the manner for determining the candidate prediction mode list.

In some embodiments, determination of the candidate prediction mode list does not depend on the N candidate weight derivation modes. That is, the N candidate weight derivation modes correspond to one candidate prediction mode list, which can reduce complexity of determining the candidate prediction mode list, thereby improving decoding efficiency. It should be noted that, in embodiments, since the candidate prediction mode list does not depend on the N candidate weight derivation modes, there is no restriction on the order between the foregoing S102 and S101, that is, S102 may be performed after S101, or may be performed before S101, or may be performed concurrently with S101, which is not limited in embodiments of the disclosure.

In some embodiments, S102 includes the following step S102-A.

S102-A, for each first candidate weight derivation mode in the N candidate weight derivation modes, a candidate prediction mode list corresponding to the first candidate weight derivation mode is determined.

In an example, the first candidate weight derivation mode is any one of the N candidate weight derivation modes. That is, in this example, at least one candidate prediction mode list needs to be determined for each of the N candidate weight derivation modes. It can be seen from the above that one weight derivation mode corresponds to K prediction modes, and the candidate prediction mode list is used for determining prediction modes. Therefore, in a possible implementation of this example, a candidate prediction mode list is determined for at least one prediction mode in K prediction modes corresponding to each of the N candidate weight derivation modes.

In another example, if the first candidate weight derivation mode belongs to one category of candidate weight derivation modes in the N candidate weight derivation modes, in embodiments of the disclosure, the N candidate weight derivation modes need to be classified, and at least one candidate prediction mode list is constructed for each category of candidate weight derivation modes.

Specifically, at the decoding end, angle indexes corresponding to the N candidate weight derivation modes are determined, for example, an angle index corresponding to each of the N candidate weight derivation modes is determined. For the method for determining the angle index, reference can be made to the elaborations in the foregoing embodiments, which is not described again herein. Then, at the decoding end, the N candidate weight derivation modes are classified into M categories of candidate weight derivation modes based on the angle indexes corresponding to the candidate weight derivation modes. Candidate weight derivation modes in the same category of candidate weight derivation modes correspond to the same angle index. That is, at the decoding end, based on the angle indexes corresponding to the candidate weight derivation modes, candidate weight derivation modes with the same angle index are classified into one category, thereby obtaining M categories of candidate weight derivation modes, where each category of candidate weight derivation modes at least includes one candidate weight derivation mode. Further, a j^{th} category of candidate weight derivation modes in the M categories of candidate weight derivation modes is determined as the first weight derivation mode(s), where j is a positive integer and j≤M. In this example, at least one candidate prediction mode list is determined for each category of candidate weight derivation modes in the N candidate weight derivation modes.

In embodiments of the disclosure, the manner of determining the candidate prediction mode list is the same for each first candidate weight derivation mode in the N candidate weight derivation modes. For ease of illustration, in embodiments of the disclosure, determination of a candidate prediction mode list corresponding to one first candidate weight derivation mode is taken as an example for illustration.

The manner for determining the candidate prediction mode list corresponding to the first candidate weight derivation mode in S102-A is introduced below.

In some embodiments, the first candidate weight derivation mode corresponds to one candidate prediction mode list.

In some embodiments, S102-A includes the following step S102-A1.

S102-A1, a candidate prediction mode list for at least one prediction mode in K prediction modes corresponding to the first candidate weight derivation mode is determined.

In embodiments, a candidate prediction mode list is determined for at least one prediction mode in the K prediction modes corresponding to the first candidate weight derivation mode. Assuming that K=2, optionally, one candidate prediction mode list may be determined for a 1^{st} prediction mode, but skip determining a candidate prediction mode list for a 2^{nd} candidate prediction mode; optionally, one candidate prediction mode list may be determined for the 2^{nd} prediction mode, but skip determining a candidate prediction mode list for the 1^{st} candidate prediction mode; optionally, one candidate prediction mode list may be determined for the 1^{st} prediction mode, and one candidate prediction mode list is determined for the 2^{nd} candidate prediction mode; optionally, one common candidate prediction mode list is determined for the 1^{st} prediction mode and the 2^{nd} prediction mode.

In embodiments of the disclosure, the candidate prediction mode list is determined for at least one prediction mode corresponding to the first candidate weight derivation mode, and as such, at least one prediction mode corresponding to the first candidate weight derivation mode is determined accurately from the candidate prediction mode list constructed.

In some embodiments, if the at least one prediction mode corresponds to one candidate prediction mode list, the foregoing S102-A1 includes the following steps S102-A1-11 and S102-A1-12.

S102-A1-11, a candidate prediction mode list for an I^{th} prediction mode in the at least one prediction mode is determined, where i is a positive integer.

S102-A1-12, the candidate prediction mode list for the at least one prediction mode is determined based on the candidate prediction mode list for the I^{th} prediction mode.

In the embodiments, the at least one prediction mode corresponding to the first candidate weight derivation mode corresponds to one candidate prediction mode list, that is, the at least one prediction mode corresponds to the same candidate prediction mode list, i.e. corresponds to one candidate prediction mode list. In this way, it is possible to reduce complexity of determining the candidate prediction mode list, thereby improving decoding efficiency. In this case, at the decoding end, one candidate prediction mode list is determined for the at least one prediction mode.

Specifically, the candidate prediction mode list for the I^{th} prediction mode in the at least one prediction mode is determined. Optionally, the I^{th} prediction mode is any one prediction mode in the at least one prediction mode. Then, the candidate prediction mode list for the at least one prediction mode is determined based on the candidate prediction mode list for the I^{th} prediction mode.

The manner for determining the candidate prediction mode list for the at least one prediction mode based on the candidate prediction mode list for the I^{th} prediction mode in S102-A1-12 includes, but is not limited to, the following manners.

Manner 1: the candidate prediction mode list for the I^{th} prediction mode is determined directly as the candidate prediction mode list for the at least one prediction mode.

Manner 2: whether the candidate prediction mode list for the I^{th} prediction mode includes a preset prediction mode is determined. If the candidate prediction mode list for the I^{th} prediction mode includes the preset prediction mode, the candidate prediction mode list for the I^{th} prediction mode is determined as the candidate prediction mode list for the at least one prediction mode. If the candidate prediction mode list for the I^{th} prediction mode does not include the preset prediction mode, the preset prediction mode is added to the candidate prediction mode list for the I^{th} prediction mode, to obtain the candidate prediction mode list for the at least one prediction mode.

In embodiments of the disclosure, there is no limitation on the preset prediction mode in the foregoing manner 2, and the preset prediction mode is determined according to actual needs.

The foregoing embodiments have introduced the process of determining the candidate prediction mode list for the at least one prediction mode for the case where the at least one prediction mode corresponds to one candidate prediction mode list.

In some embodiments, if each prediction mode in the at least one prediction mode corresponds to one candidate prediction mode list, the foregoing S102-A1 includes the following step S102-A1-21.

S102-A1-21, for an I^{th} prediction mode in the at least one prediction mode, a candidate prediction mode list for the I^{th} prediction mode is determined, where i is a positive integer.

In the embodiments, each prediction mode in the at least one prediction mode corresponds to one candidate prediction mode list. Therefore, at the decoding end, one candidate prediction mode list is determined for each prediction mode in the at least one prediction mode corresponding to the first candidate weight derivation mode. For example, the at least one prediction mode includes a 1^{st} prediction mode and a 2^{nd} prediction mode corresponding to the first candidate weight derivation mode, and accordingly, at the decoding end, one candidate prediction mode list is determined for the 1^{st} prediction mode and one candidate prediction mode list is determined for the 2^{nd} prediction mode.

In the embodiments, the process of determining one candidate prediction mode list corresponding to each prediction mode in the at least one prediction mode is the same. For ease of illustration, in embodiments of the disclosure, determination of the candidate prediction mode list for the I^{th} prediction mode in the at least one prediction mode is taken as an example for illustration.

The process of determining the candidate prediction mode list for the I^{th} prediction mode in S102-A1-11 and S102-A1-21 is described below.

In embodiments of the disclosure, there is no limitation on the type of a candidate prediction mode(s) in the candidate prediction mode list for the I^{th} prediction mode.

In some embodiments, the candidate prediction mode list for the I^{th} prediction mode includes at least one of: a first candidate prediction mode determined based on the template of the current block or a second candidate prediction mode determined based on gradients of reconstructed samples in the template.

Case 1: if the candidate prediction mode list for the I^{th} prediction mode includes the first candidate prediction mode, embodiments of the disclosure include the following step 11 to step 14.

Step 11, the template of the current block is partitioned into P sub-templates, where P is a positive integer and P>1.

It can be seen from the above that, the template of the current block includes the left template of the current block and the top template of the current block. Currently, the whole template of the current block is used to derive the first candidate prediction mode. For example, in TIMD, the whole template of the current block is used to derive a prediction mode, and as a result, the first candidate prediction mode thus derived is not accurate enough.

According to embodiments of the disclosure, the template of the current block is partitioned into P sub-templates, then the first candidate prediction mode is derived from the P sub-templates and/or the template of the current block, and the first candidate prediction mode is added to the candidate prediction mode list for the I^{th} prediction mode, which can improve accuracy of the candidate prediction mode list for the I^{th} prediction mode.

In embodiments of the disclosure, the manner for partitioning the template of the current block includes, but is not limited to, the following manners.

Manner 1: at the decoding end, the template of the current block is partitioned based on the first candidate weight derivation mode. Specifically, an angle index corresponding to the first candidate weight derivation mode is determined, and the template of the current block is partitioned into P sub-templates based on the angle index.

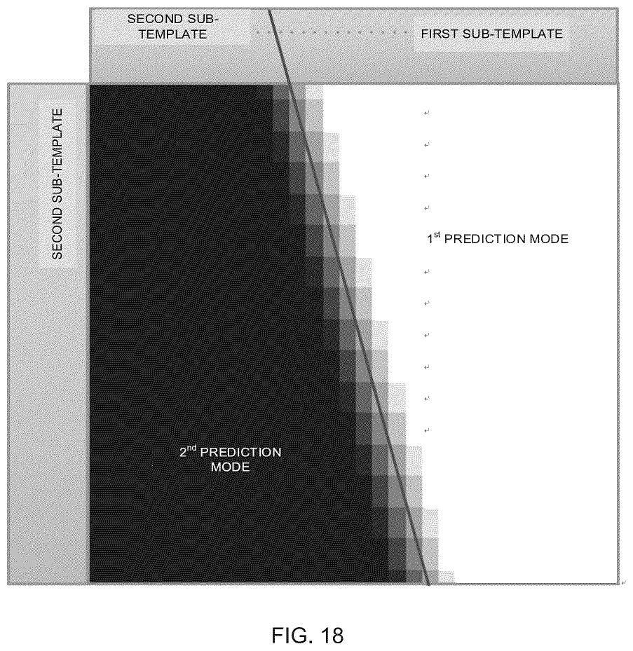

For example, as illustrated in FIG. 18, taking a weight derivation mode for GPM with an index of 2 as an example, a white area of a weight matrix for the current block means that a weight corresponding to a prediction value under a 1^{st} prediction mode is 100%, while a black area means that a weight corresponding to a prediction value under a 2^{nd} prediction mode is 100%. As illustrated in FIG. 18, the 1^{st} prediction mode is correlated with the top template of the current block, and the 2^{nd} prediction mode is correlated with the left template of the current block and part of the top template of the current block. However, currently, the whole template is used to derive a prediction mode, which results in inaccuracy of derivation of a prediction mode, thus increasing prediction error.

In order to solve the technical problem, in the disclosure, finer partitioning of the template can be realized based on a weight derivation mode. For example, as illustrated in FIG. 18, in the disclosure, the angle index corresponding to the first candidate weight derivation mode is determined, and a partition line of a weight matrix corresponding to the first candidate weight derivation mode can be determined according to the angle index. Then the partition line extends to the template region of the current block, so as to partition the template to obtain two sub-templates. For example, the two sub-templates are denoted as a first sub-template and a second sub-template, where the first sub-template corresponds to the 1^{st} prediction mode, and the second sub-template corresponds to the 2^{nd} prediction mode, i.e. the first sub-template is used for deriving a first candidate prediction mode corresponding to the 1^{st} prediction mode, and the second sub-template is used for deriving a first candidate prediction mode corresponding to the 2^{nd} prediction mode.

Manner 2: at the decoding end, the template of the current block is partitioned into P sub-templates based on the size of the current block. For example, if the size of the current block is less than a certain threshold, the template of the current block is partitioned into fewer sub-templates. If the size of the current block is greater than or equal to the threshold, the template of the current block is partitioned into more sub-templates.

The size of the current block includes the width or the height of the current block or the number of samples in the current block.

Optionally, if the size of the current block includes the width or the height of the current block, the foregoing threshold may be 8, 16, 32, or the like.

Optionally, if the size of the current block includes the number of samples in the current block, the foregoing threshold may be 64, 128, 256, 512, or the like.

In an example, the foregoing threshold is a default value.

In an example, the threshold may also be derived according to a high-level flag, for example, a flag of a sequence parameter set (SPS) is set to indicate the value of the threshold.

Manner 3: the left template and/or the top template of the current block is partitioned to obtain the P sub-templates. For example, the left template of the current block is partitioned evenly into halves, quarters, or the like; and/or the top template of the current block is partitioned evenly into halves, quarters, or the like.

It should be noted that, at the decoding end, instead of partitioning the template of the current block into P sub-templates in the foregoing manners 1 to 3, the template can also be partitioned in other manners, which is not limited in embodiments of the disclosure.

At the decoding end, after the template of the current block is partitioned into P sub-templates, step 12 is performed.

Step 12, Q prediction templates are selected from the P sub-templates and/or the template of the current block, where Q is a positive integer and Q≤P+1.

In embodiments of the disclosure, in order to improve accuracy of the first candidate prediction mode, the template of the current block is partitioned into P sub-templates through the foregoing step 11, then the Q prediction templates are selected from the P sub-templates and/or the template of the current block, and the first candidate prediction mode is derived from the Q prediction templates, so as to realize accurate derivation of the first candidate prediction mode. Finally, the first candidate prediction mode derived is added to the candidate prediction mode list corresponding to the I^{th} prediction mode.

In embodiments of the disclosure, the prediction template may be understood as a template used to derive a prediction mode, and the prediction template may be the sub-template or the template of the current block described above.

In embodiments of the disclosure, there is no limitation on the manner for selecting the Q prediction templates from the P sub-templates and/or the template of the current block.

In some embodiments, the Q prediction templates are selected from the P sub-templates and/or the template of the current block based on a default condition. For example, the Q prediction templates are selected from the P sub-templates.

In some embodiments, the Q prediction templates are selected from the P sub-templates and/or template of the current block through the following steps 12-1 to 12-3.

Step 12-1, an angle index corresponding to the first candidate weight derivation mode is determined.

Step 12-2, an available neighbouring block(s) corresponding to the I^{th} prediction mode is determined based on the angle index.

Step 12-3, the Q prediction templates are selected from the P sub-templates and/or the template of the current block based on the available neighbouring block corresponding to the I^{th} prediction mode.

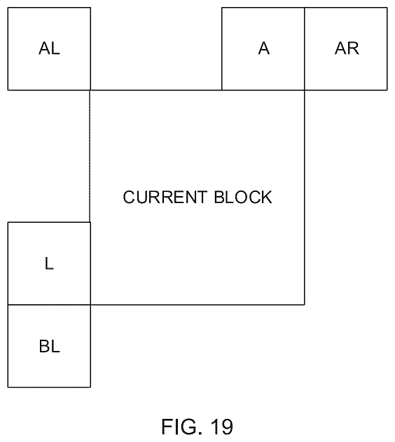

In the embodiments, it is assumed that five neighbouring blocks are available for the current block, where locations of the five neighbouring blocks are illustrated in FIG. 19. The coordinate of the top-left corner of the current block is denoted as (x0, y0), the width of the current block is denoted as width, and the height of the current block is denoted as height. The five neighbouring blocks are: neighbouring block AL determined according to coordinate (x0−1, y0−1), neighbouring block A determined according to coordinate (x0+width−1, y0−1), neighbouring block AR determined according to coordinate (x0+width, y0−1), neighbouring block L determined according to coordinate (x0−1, y0+height−1), and neighbouring block BL determined according to coordinate (x0−1, y0+height). A can be understood as a top neighbouring block of the current block, L can be understood as a left neighbouring block of the current block, AR can be understood as a top-right neighbouring block of the current block, AL can be understood as a top-left neighbouring block of the current block, BL can be understood as a bottom-left neighbouring block of the current block.

In an example, a correspondence between angle indexes, first parts (the 1^{st} prediction mode), second parts (the 2^{nd} prediction mode), and neighbouring blocks is illustrated in Table 5.

TABLE 5

| Angle index | 0 | 2 | 3 | 4 | 5 | 8 | 11 | 12 | 13 | 14 |
|---|---|---|---|---|---|---|---|---|---|---|
| First part | A | A | A | A | L + A | L + A | L + A | L + A | A | A |
| Second part | L + A | L + A | L + A | L | L | L | L | L + A | L + A | L + A |
| Angle index | 16 | 18 | 19 | 20 | 21 | 24 | 27 | 28 | 29 | 30 |
| First part | A | A | A | A | L + A | L + A | L + A | L + A | A | A |
| Second part | L + A | L + A | L + A | L | L | L | L | L + A | L + A | L + A |

In the foregoing Table 5, A can be understood as the top neighbouring block of the current block, L can be understood as the left neighbouring block of the current block, and L+A can be understood as the left neighbouring block and the top neighbouring block of the current block.

In the embodiments, at the decoding end, the angle index corresponding to the first candidate weight derivation mode is determined, a range of the available neighbouring block corresponding to the I^{th} prediction mode is determined based on the angle index, and then the Q prediction templates are selected from the P sub-templates and/or the template of the current block based on the available neighbouring block corresponding to the I^{th} prediction mode, and as such, the Q prediction templates selected are correlated with the I^{th} prediction mode. In this way, a first candidate prediction mode corresponding to the I^{th} prediction mode can be accurately determined based on the Q prediction templates correlated with the I^{th} prediction mode.

Exemplarily, if the I^{th} prediction mode is a 1^{st} prediction mode corresponding to the first candidate weight derivation mode, the available neighbouring block corresponding to the I^{th} prediction mode is determined from neighbouring blocks corresponding to the first part. For example, if the angle index corresponding to the first candidate weight derivation mode is 2, it can be determined according to Table 5 that the available neighbouring block corresponding to the I^{th} prediction mode is A.

Exemplarily, if the I^{th} prediction mode is a 2^{nd} prediction mode corresponding to the first candidate weight derivation mode, the available neighbouring block corresponding to the I^{th} prediction mode is determined from neighbouring blocks corresponding to the second part. For example, if the angle index corresponding to the first candidate weight derivation mode is 2, it can be determined according to Table 5 that the available neighbouring block corresponding to the I^{th} prediction mode is L+A.

Then, the Q prediction templates are selected from the P sub-templates and/or the template of the current block based on the available neighbouring block corresponding to the I^{th} prediction mode.

Example 1, if the available neighbouring block corresponding to the I^{th} prediction mode includes the top neighbouring block of the current block, a sub-template(s) at the top of the current block in the P sub-templates is determined as a prediction template(s) in the Q prediction templates.

In a possible implementation, in this example, each sub-template at the top of the current block in the P sub-templates can be determined as one of the Q prediction templates.

In a possible implementation, in this example, sub-templates at the top of the current block in the P sub-templates can be merged into one or more prediction templates in the Q prediction templates. For example, the sub-templates at the top of the current block in the P sub-templates are: sub-template a, sub-template b, and sub-template c. Sub-template a, sub-template b, and sub-template c are merged into one prediction template. Alternatively, any two of sub-template a, sub-template b, and sub-template c are merged into one prediction template, and the remaining one sub-template is separately taken as one prediction template.

Example 2, if the available neighbouring block corresponding to the I^{th} prediction mode includes the left neighbouring block of the current block, a sub-template(s) at the left of the current block in the P sub-templates is determined as a prediction template(s) in the Q prediction templates.

In a possible implementation, in this example, each sub-template at the left of the current block in the P sub-templates can be determined as one of the Q prediction templates.

In a possible implementation, in this example, sub-templates at the left of the current block in the P sub-templates can be merged into one or more prediction templates in the Q prediction templates. For example, the sub-templates at the left of the current block in the P sub-templates are: sub-template a, sub-template b, and sub-template c. Sub-template a, sub-template b, and sub-template c are merged into one prediction template. Alternatively, any two of sub-template a, sub-template b, and sub-template c are merged into one prediction template, and the remaining one sub-template is separately taken as one prediction template.

Example 3, if the available neighbouring block corresponding to the I^{th} prediction mode includes the left neighbouring block and the top neighbouring block of the current block, at least one of a sub-template(s) at the left of the current block in the P sub-templates, a sub-template(s) at the top of the current block in the P sub-templates, or the template of the current block is determined as a prediction template(s) in the Q prediction templates.

For example, if the available neighbouring block corresponding to the I^{th} prediction mode includes the left neighbouring block and the top neighbouring block of the current block, the sub-template at the left of the current block in the P sub-templates is determined as a prediction template in the Q prediction templates.

For another example, if the available neighbouring block corresponding to the I^{th} prediction mode includes the left neighbouring block and the top neighbouring block of the current block, the sub-template at the top of the current block in the P sub-templates is determined as a prediction template in the Q prediction templates.

For another example, if the available neighbouring block corresponding to the I^{th} prediction mode includes the left neighbouring block and the top neighbouring block of the current block, the template of the current block is determined as a prediction template in the Q prediction templates.

For another example, if the available neighbouring block corresponding to the I^{th} prediction mode includes the left neighbouring block and the top neighbouring block of the current block, the sub-template at the left of the current block in the P sub-templates, the sub-template at the top of the current block in the P sub-templates, and the template of the current block are determined as prediction templates in the Q prediction templates.

For another example, if the available neighbouring block corresponding to the I^{th} prediction mode includes the left neighbouring block and the top neighbouring block of the current block, at least one sub-template at the left of the current block in the P sub-templates and the template of the current block are determined as prediction templates in the Q prediction templates.

For another example, if the available neighbouring block corresponding to the I^{th} prediction mode includes the left neighbouring block and the top neighbouring block of the current block, at least one sub-template at the top of the current block in the P sub-templates and the template of the current block are determined as prediction templates in the Q prediction templates.

Since natural textures vary significantly, when reflected at a sample level, there are many positions with different degrees of gradual transition. For example, although a certain part does not neighbour the left or the top, since the texture is gradual, it may be difficult to distinguish the strength of correlation within a small range, especially for a small block. For a large block, it is easier to distinguish the strength of correlation if the distance is long.

To this end, step 12 includes the following. The Q prediction templates are selected from the P sub-templates and/or the template of the current block based on the size of the current block.

The size of the current block includes, but is not limited to, the width or the height of the block, the number of samples in the block, or the like.

In an example, if the size of the current block is less than or equal to a second threshold, the P sub-templates and the template of the current block are determined as prediction templates in the Q prediction templates. That is, if the size of the current block is less than or equal to the second threshold, instead of distinguishing prediction modes derived from the sub-templates and the whole template, these prediction modes are used directly as the first candidate prediction modes and added to the candidate prediction mode list corresponding to the I^{th} prediction mode.

In another example, if the size of the current block is less than or equal to a second threshold, the template of the current block is determined as a prediction template in the Q prediction templates. In this example, if the size of the current block is less than or equal to the second threshold, it is difficult to distinguish the strength of correlation. Therefore, a prediction mode derived from the template of the current block is determined directly as the first candidate prediction mode, and is added to the candidate prediction mode list corresponding to the I^{th} prediction mode.

In some embodiments, if the size of the current block is greater than a first threshold, the foregoing steps 12-1 to 12-3 are performed, that is, if the size of the current block is greater than the first threshold, step 12-1 is performed to determine the angle index corresponding to the first candidate weight derivation mode.

In embodiments of the disclosure, there is no limitation on the values of the first threshold and the second threshold.

Exemplarily, the first threshold is equal to the second threshold.

Optionally, if the size of the current block includes the width or the height of the current block, the first threshold and the second threshold may be 8, 16, 32, or the like.

Optionally, if the size of the current block includes the number of samples in the current block, the first threshold and the second threshold may be 64, 128, 256, 512, or the like.

In an example, the first threshold and the second threshold are default values.

In an example, the first threshold and the second threshold may also be derived from a high-level flag. For example, a flag of an SPS is set to indicate the first threshold and the second threshold.

At the decoding end, after selecting the Q prediction templates from the P sub-templates and/or the template of the current block through the foregoing steps, step 13 is performed.

Step 13, prediction modes derived from the Q prediction templates are determined.

At the decoding end, after selecting the Q prediction templates from the P sub-templates and/or the template of the current block through the foregoing steps, the Q prediction templates are used to derive prediction modes.

In an example, for each of the Q prediction templates, one prediction mode is derived from the prediction template, thereby deriving Q prediction modes.

In some embodiments, the manner for determining the prediction modes derived from the Q prediction templates may be as follows. For any one prediction template of the Q prediction templates, R alternative prediction modes are determined, where the R alternative prediction modes may be all prediction modes that are available, or may be several preset prediction modes, or may be several prediction modes corresponding to the prediction template, which is not limited in embodiments of the disclosure. Then, first costs when predicting the prediction template by applying the R alternative prediction modes respectively are determined. Since the prediction template is already reconstructed, for each of the R alternative prediction modes, the prediction template is predicted by applying the alternative prediction mode, to obtain a prediction value of the prediction template in the alternative prediction mode. For each alternative prediction mode, a first cost corresponding to the alternative prediction mode is obtained based on the prediction value and a reconstructed value in the alternative prediction mode. Optionally, the first cost may be an approximate cost such as a sum of absolute difference (SAD) or a sum of absolute transformed difference (SATD). Finally, a prediction mode derived from the prediction template is obtained based on the first costs corresponding to the R alternative prediction modes. For example, an alternative prediction mode corresponding to the minimum first cost among the R alternative prediction modes is determined as the prediction mode derived from the prediction template.

At the decoding end, after determining the prediction modes derived from the Q prediction templates through the foregoing steps, the following step 14 is performed.

Step 14, at least one prediction mode in the prediction modes derived from the Q prediction templates is determined as the first candidate prediction mode.

As can be seen from the foregoing illustration, the prediction modes derived from the Q prediction templates correspond to first costs. In some embodiments, at least one prediction mode can be selected from the prediction modes derived from the Q prediction templates based on the first costs and determined as the first candidate prediction mode.

For example, one or more prediction modes with the minimum first cost(s) among the prediction modes derived from the Q prediction templates are determined as the first candidate prediction mode(s).

In some embodiments, the prediction modes derived from the Q prediction templates are not filtered. Instead, the prediction modes derived from the Q prediction templates are determined directly as the first candidate prediction modes.

After the first candidate prediction mode is determined through the foregoing steps, the first candidate prediction mode thus determined is added to the candidate prediction mode list corresponding to the I^{th} prediction mode.

As can be seen, in embodiments of the disclosure, when determining the first candidate prediction mode, the template of the current block is partitioned into P sub-templates, and the first candidate prediction mode is derived from the P sub-templates and/or the template of the current block, which can improve accuracy of deriving the first candidate prediction mode, thereby improving quality of the candidate prediction mode list corresponding to the I^{th} prediction mode.

The above has introduced the process of determining the first candidate prediction mode if the candidate prediction mode list for the I^{th} prediction mode includes the first candidate prediction mode in the foregoing case 1.

The following will introduce the process of determining the second candidate prediction mode if the candidate prediction mode list for the I^{th} prediction mode includes the second candidate prediction mode in case 2.

Case 2: if the candidate prediction mode list for the I^{th} prediction mode includes the second candidate prediction mode, embodiments of the disclosure include the following steps 21 to 24.

Step 21: a reconstructed sample area in which template of the current block is located is partitioned into S reconstructed sample sub-areas, where S is a positive integer.

In embodiments of the disclosure, the reconstructed sample area in which the template of the current block is located includes a left neighbouring reconstructed sample area of the current block and a top neighbouring reconstructed sample area of the current block. Currently, the whole reconstructed sample area in which the template of the current block is located is used to derive the second candidate prediction mode. For example, in DIMD, the second candidate prediction mode derived from the whole reconstructed sample area in which the template of the current block is located is not accurate enough.

For ease of illustration, the reconstructed sample area in which the template of the current block is located is referred to as a reconstructed sample area.

According to embodiments of the disclosure, the reconstructed sample area in which the template of the current block is located is partitioned into S reconstructed sample sub-areas, then the second candidate prediction mode is derived from the S reconstructed sample sub-areas and/or the reconstructed sample area, and the second candidate prediction mode is added to the candidate prediction mode list for the I^{th} prediction mode, which can improve accuracy of the candidate prediction mode list for the I^{th} prediction mode.

In embodiments of the disclosure, the manner for partitioning the reconstructed sample area in which the template of the current block is located includes, but is not limited to, the following manners.

Manner 1: at the decoding end, the template of the current block is partitioned based on the first candidate weight derivation mode. Specifically, an angle index corresponding to the first candidate weight derivation mode is determined, and the reconstructed sample area in which the template of the current block is located is partitioned into S reconstructed sample sub-areas based on the angle index.

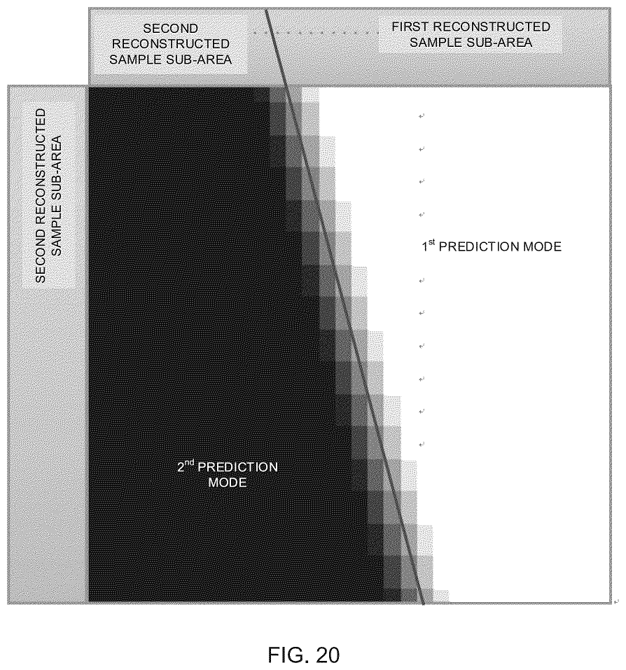

For example, as illustrated in FIG. 20, taking a weight derivation mode for GPM with an index of 2 as an example, a white area of a weight matrix for the current block means that a weight corresponding to a prediction value of a 1^{st} prediction mode is 100%, while a black area means that a weight corresponding to a prediction value of a 2^{nd} prediction mode is 100%. As illustrated in FIG. 20, the 1^{st} prediction mode is correlated with the top reconstructed sample area of the current block, and the 2^{nd} prediction mode is correlated with the left reconstructed sample area and part of the top reconstructed sample area of the current block. However, currently, the whole reconstructed sample area is used to derive a prediction mode, which results in inaccuracy of derivation of a prediction mode, thus increasing prediction error.

In order to solve the technical problem, in the disclosure, finer partitioning of the reconstructed sample area in which the template is located can be realized based on a weight derivation mode. For example, as illustrated in FIG. 19, in the disclosure, the angle index corresponding to the first candidate weight derivation mode is determined, and a partition line of a weight matrix corresponding to the first candidate weight derivation mode can be determined according to the angle index. Then, the partition line extends to the reconstructed sample area in which the template of the current block is located, so as to partition the reconstructed sample area to obtain two reconstructed sample sub-areas. For example, the two reconstructed sample sub-areas are denoted as a first reconstructed sample sub-area and a second reconstructed sample sub-area, where the first reconstructed sample sub-area corresponds to the 1^{st} prediction mode, and the second reconstructed sample sub-area corresponds to the 2^{nd} prediction mode, i.e. the first reconstructed sample sub-area is used for deriving a second candidate prediction mode corresponding to the 1^{st} prediction mode, and the second reconstructed sample sub-area is used for deriving a second candidate prediction mode corresponding to the 2^{nd} prediction mode.

Manner 2: at the decoding end, the reconstructed sample area in which the template of the current block is located is partitioned into S reconstructed sample sub-areas based on the size of the current block. For example, if the size of the current block is less than a certain threshold, the reconstructed sample area in which the template of the current block is located is partitioned into fewer reconstructed sample sub-areas. If the size of the current block is greater than or equal to the threshold, the reconstructed sample area in which the template of the current block is located is partitioned into more reconstructed sample sub-areas.

The size of the current block includes the width or the height of the current block or the number of samples in the current block.

Optionally, if the size of the current block includes the width or the height of the current block, the foregoing threshold may be 8, 16, 32, or the like.

Optionally, if the size of the current block includes the number of samples in the current block, the foregoing threshold may be 64, 128, 256, 512, or the like.

In an example, the foregoing threshold is a default value.

In an example, the threshold may also be derived according to a high-level flag, for example, a flag of an SPS is set to indicate the value of the threshold.

Manner 3: the left neighbouring reconstructed sample area and/or the top neighbouring reconstructed sample area of the current block is partitioned to obtain the S reconstructed sample sub-areas. For example, the left neighbouring sample area of the current block is partitioned evenly into halves, quarters, or the like; and/or the top neighbouring reconstructed sample area of the current block is partitioned evenly into halves, quarters, or the like.

It should be noted that, at the decoding end, instead of partitioning the reconstructed sample area in which the template of the current block is located into S reconstructed sample sub-areas in the foregoing manner 1 to manner 3, partitioning can also be performed in other manners, which is not limited in embodiments of the disclosure.

At the decoding end, after the reconstructed sample area in which the template of the current block is located is partitioned into S reconstructed sample sub-areas, the following step 22 is performed.

Step 22, G reconstructed sample prediction areas are selected from the S reconstructed sample sub-areas and/or the reconstructed sample area in which the template of the current block is located, where G is a positive integer and G≤S+1.

In embodiments of the disclosure, in order to improve accuracy of the second candidate prediction mode, the reconstructed sample area in which the template of the current block is located is partitioned into S reconstructed sample sub-areas through the foregoing step 21, then the G reconstructed sample prediction areas are selected from the S reconstructed sample sub-areas and/or the reconstructed sample area in which the template of the current block is located, and the second candidate prediction mode is derived from the G reconstructed sample prediction areas, so as to realize accurate derivation of the second candidate prediction mode. Finally, the second candidate prediction mode derived is added to the candidate prediction mode list corresponding to the I^{th} prediction mode.

In embodiments of the disclosure, the reconstructed sample prediction area may be understood as a reconstructed sample area used to derive a prediction mode, and the reconstructed sample prediction area may be the reconstructed sample sub-area or the reconstructed sample area in which the template of the current block is located.

In embodiments of the disclosure, there is no limitation on the manner for selecting the G reconstructed sample prediction areas from the S reconstructed sample sub-areas and/or the reconstructed sample area in which the template of the current block is located.

In some embodiments, based on a default condition, the G reconstructed sample prediction areas are selected from the S reconstructed sample sub-areas and/or the reconstructed sample area in which the template of the current block is located. For example, the G reconstructed sample prediction areas are selected from the S reconstructed sample sub-areas.

In some embodiments, the G reconstructed sample prediction areas are selected from the S reconstructed sample sub-areas and/or the reconstructed sample area in which the template of the current block is located through steps 22-1 to 22-3 below.

Step 22-1, an angle index corresponding to the first candidate weight derivation mode is determined.

Step 22-2, an available neighbouring block(s) corresponding to the I^{th} prediction mode is determined based on the angle index.

Step 22-3, based on the available neighbouring block corresponding to the I^{th} prediction mode, the G reconstructed sample prediction areas are selected from the S reconstructed sample sub-areas and/or the reconstructed sample area in which the template of the current block is located.

In the embodiments, it is assumed that five neighbouring blocks are available for current block, where locations of the five neighbouring blocks are illustrated in FIG. 19.

In an example, a correspondence between angle indexes, first parts (the 1^{st} prediction mode), second parts (the 2^{nd} prediction mode), and neighbouring blocks is illustrated in Table 5.

In the embodiments, at the decoding end, the angle index corresponding to the first candidate weight derivation mode is determined, the available neighbouring block corresponding to the I^{th} prediction mode is determined based on the angle index, and then based on the available neighbouring block corresponding to the I^{th} prediction mode, the G reconstructed sample prediction areas are selected from the S reconstructed sample sub-areas and/or the reconstructed sample area in which the template of the current block is located, so that the G reconstructed sample prediction areas selected are correlated with the I^{th} prediction mode. In this way, a second candidate prediction mode corresponding to the I^{th} prediction mode can be accurately determined based on the G reconstructed sample prediction areas correlated with the I^{th} prediction mode.

Exemplarily, if the I^{th} prediction mode is a 1^{st} prediction mode corresponding to the first candidate weight derivation mode, the available neighbouring block corresponding to the I^{th} prediction mode is determined from neighbouring blocks corresponding to the first part. For example, if the angle index corresponding to the first candidate weight derivation mode is 2, it can be determined according to Table 5 that the available neighbouring block corresponding to the I^{th} prediction mode is A.

Exemplarily, if the I^{th} prediction mode is a 2^{nd} prediction mode corresponding to the first candidate weight derivation mode, the available neighbouring block corresponding to the I^{th} prediction mode is determined from neighbouring blocks corresponding to the second part. For example, if the angle index corresponding to the first candidate weight derivation mode is 2, it can be determined according to Table 5 that the available neighbouring block corresponding to the I^{th} prediction mode is L+A.

Then, based on the available neighbouring block corresponding to the I^{th} prediction mode, the G reconstructed sample prediction areas are selected from the S reconstructed sample sub-areas and/or the reconstructed sample area in which the template of the current block is located.

Example 1, if the available neighbouring block corresponding to the I^{th} prediction mode includes the top neighbouring block of the current block, a reconstructed sample sub-area(s) at the top of the current block in the S reconstructed sample sub-areas is determined as a reconstructed sample prediction area(s) in the G reconstructed sample prediction areas.

In a possible implementation, in this example, each reconstructed sample sub-area at the top of the current block in the S reconstructed sample sub-areas can be determined as one of the G reconstructed sample prediction areas.

In a possible implementation, in this example, reconstructed sample sub-areas at the top of the current block in the S reconstructed sample sub-areas can be merged into one or more reconstructed sample prediction areas in the G reconstructed sample prediction areas. For example, the reconstructed sample sub-areas at the top of the current block in the S reconstructed sample sub-areas are: reconstructed sample sub-area a, reconstructed sample sub-area b, and reconstructed sample sub-area c. Reconstructed sample sub-area a, reconstructed sample sub-area b, and reconstructed sample sub-area c may be merged into one reconstructed sample prediction area. Alternatively, any two of reconstructed sample sub-area a, reconstructed sample sub-area b, and reconstructed sample sub-area c are merged into one reconstructed sample prediction area, and the remaining one reconstructed sample sub-area is separately taken as one reconstructed sample prediction area.

Example 2, if the available neighbouring block corresponding to the I^{th} prediction mode includes the left neighbouring block of the current block, a reconstructed sample sub-area(s) at the left of the current block in the S reconstructed sample sub-areas is determined as a reconstructed sample prediction area(s) in the G reconstructed sample prediction areas.

In a possible implementation, in this example, each reconstructed sample sub-area at the left of the current block in the S reconstructed sample sub-areas can be determined as one of the G reconstructed sample prediction areas.

In a possible implementation, in this example, reconstructed sample sub-areas at the left of the current block in the S reconstructed sample sub-areas can be merged into one or more reconstructed sample prediction areas in the G reconstructed sample prediction areas. For example, the reconstructed sample sub-areas at the left of the current block in the S reconstructed sample sub-areas are: reconstructed sample sub-area a, reconstructed sample sub-area b, and reconstructed sample sub-area c. Reconstructed sample sub-area a, reconstructed sample sub-area b, and reconstructed sample sub-area c may be merged into one reconstructed sample prediction area. Alternatively, any two of reconstructed sample sub-area a, reconstructed sample sub-area b, and reconstructed sample sub-area c are merged into one reconstructed sample prediction area, and the remaining one reconstructed sample sub-area is separately taken as one reconstructed sample prediction area.

Example 3, if the available neighbouring block corresponding to the I^{th} prediction mode includes the left neighbouring block and the top neighbouring block of the current block, at least one of a reconstructed sample sub-area(s) at the left of the current block in the S reconstructed sample sub-areas, a reconstructed sample sub-area(s) at the top of the current block in the S reconstructed sample sub-areas, or the reconstructed sample area in which the template of the current block is located is determined as a reconstructed sample prediction area(s) in the G reconstructed sample prediction areas.

For example, if the available neighbouring block corresponding to the I^{th} prediction mode includes the left neighbouring block and the top neighbouring block of the current block, the reconstructed sample sub-area at the left of the current block in the S reconstructed sample sub-areas is determined as a reconstructed sample prediction area in the G reconstructed sample prediction areas.

For another example, if the available neighbouring block corresponding to the I^{th} prediction mode includes the left neighbouring block and the top neighbouring block of the current block, the reconstructed sample sub-area at the top of the current block in the S reconstructed sample sub-areas is determined as a reconstructed sample prediction area in the G reconstructed sample prediction areas.

For another example, if the available neighbouring block corresponding to the I^{th} prediction mode includes the left neighbouring block and the top neighbouring block of the current block, the reconstructed sample area in which the template of the current block is located is determined as a reconstructed sample prediction area in the G reconstructed sample prediction areas.

For another example, if the available neighbouring block corresponding to the I^{th} prediction mode includes the left neighbouring block and the top neighbouring block of the current block, the reconstructed sample sub-area at the left of the current block in the S reconstructed sample sub-areas, the reconstructed sample sub-area at the top of the current block in the S reconstructed sample sub-areas, and the reconstructed sample area in which the template of the current block is located are determined as reconstructed sample prediction areas in the G reconstructed sample prediction areas.

For another example, if the available neighbouring block corresponding to the I^{th} prediction mode includes the left neighbouring block and the top neighbouring block of the current block, at least one reconstructed sample sub-area at the left of the current block in the S reconstructed sample sub-areas and the reconstructed sample area in which the template of the current block is located are determined as reconstructed sample prediction areas in the G reconstructed sample prediction areas.

For another example, if the available neighbouring block corresponding to the I^{th} prediction mode includes the left neighbouring block and the top neighbouring block of the current block, at least one reconstructed sample sub-area at the top of the current block in the S reconstructed sample sub-areas and the reconstructed sample area in which the template of the current block is located are determined as reconstructed sample prediction areas in the G reconstructed sample prediction areas.

Since natural textures vary significantly, when reflected at a sample level, there are many positions with different degrees of gradual transition. For example, although a certain part does not neighbour the left or the top, since the texture is gradual, it may be difficult to distinguish the strength of correlation within a small range, especially for a small block. For a large block, it is easier to distinguish the strength of correlation if the distance is long.

To this end, step 22 includes the following. The G reconstructed sample prediction areas are selected from the S reconstructed sample sub-areas and/or the reconstructed sample area based on the size of the current block.

The size of the current block includes, but is not limited to, the width or the height of the block, the number of samples in the block, or the like.

In an example, if the size of the current block is less than or equal to a fourth threshold, the S reconstructed sample sub-areas and the reconstructed sample area in which the template of the current block is located are determined as reconstructed sample prediction areas in the G reconstructed sample prediction areas. That is, if the size of the current block is less than or equal to the fourth threshold, instead of distinguishing prediction modes derived from the reconstructed sample sub-areas and the reconstructed sample area in which the whole template is located, these prediction modes are used directly as the second candidate prediction modes and added to the candidate prediction mode list corresponding to the I^{th} prediction mode.

In another example, if the size of the current block is less than or equal to a fourth threshold, the template of the current block is determined as a reconstructed sample prediction area in the G reconstructed sample prediction areas. In this example, if the size of the current block is less than or equal to the fourth threshold, it is difficult to distinguish the strength of the correlation. Therefore, a prediction mode derived from the reconstructed sample area in which the template of the current block is located is determined directly as the second candidate prediction mode and added to the candidate prediction mode list corresponding to the I^{th} prediction mode.

In some embodiments, if the size of the current block is greater than a third threshold, steps 22-1 to 22-3 are performed, that is, if the size of the current block is greater than the third threshold, step 22-1 is performed to determine the angle index corresponding to the first candidate weight derivation mode.

The values of the third threshold and the fourth threshold are not limited in embodiments of the disclosure.

Exemplarily, the third threshold is equal to the fourth threshold.

Optionally, if the size of the current block includes the width or the height of the current block, the third threshold and the fourth threshold each may be 8, 16, 32, or the like.

Optionally, if the size of the current block includes the number of samples in the current block, the third threshold and the fourth threshold each may be 64, 128, 256, 512, or the like.

In an example, the third threshold and the fourth threshold are default values.

In an example, the third threshold and the fourth threshold may also be derived according to a high-level flag. For example, a flag of an SPS is set to indicate the third threshold and the fourth threshold.

At the decoding end, after the G reconstructed sample prediction areas are selected from the S reconstructed sample sub-areas and/or the reconstructed sample area in which the template of the current block is located based on the foregoing steps, the following step 23 is performed.

Step 23, prediction modes derived from the G reconstructed sample prediction areas are determined.

At the decoding end, after the G reconstructed sample prediction areas are selected from the S reconstructed sample sub-areas and/or the reconstructed sample area in which the template of the current block is located through the foregoing steps, the G reconstructed sample prediction areas are used to derive prediction modes.

In an example, for each of the G reconstructed sample prediction areas, one prediction mode is derived from the reconstructed sample prediction area, thereby deriving G prediction modes.

In some embodiments, the manner for determining the prediction modes derived from the G reconstructed sample prediction areas may be as follows. For any one reconstructed sample prediction area in the G reconstructed sample prediction areas, gradients of center samples of the reconstructed sample prediction area are determined. A prediction mode derived from the reconstructed sample prediction area is determined based on the gradients of the center samples of the reconstructed sample prediction area.

At the decoding end, after determining the prediction modes derived from the G reconstructed sample prediction areas through the foregoing steps, step 24 is performed.

Step 24, at least one prediction mode in the prediction modes derived from the G reconstructed sample prediction areas is determined as the second candidate prediction mode.

In some embodiments, as can be seen from the foregoing illustration, the prediction modes derived from the G reconstructed sample prediction areas correspond to first costs, and at least one prediction mode can be selected from the prediction modes derived from the G reconstructed sample prediction areas based on the first costs and determined as the second candidate prediction mode.

For example, one or more prediction modes with the minimum first cost among the prediction modes derived from the G reconstructed sample prediction areas are determined as the second candidate prediction mode.

In some embodiments, instead of selecting from the prediction modes derived from the G reconstructed sample prediction areas, the prediction modes derived from the G reconstructed sample prediction areas are determined directly as the second candidate prediction mode.

After the second candidate prediction mode is determined through the foregoing steps, the second candidate prediction mode determined is added to the candidate prediction mode list corresponding to the I^{th} prediction mode.

As can be seen, in embodiments of the disclosure, when determining the second candidate prediction mode, the template of the current block is partitioned into S reconstructed sample sub-areas, and the second candidate prediction mode is derived from the S reconstructed sample sub-areas and/or the template of the current block, which can improve accuracy of deriving the second candidate prediction mode, thereby improving quality of the candidate prediction mode list corresponding to the I^{th} prediction mode.

The above has introduced the process of determining the second candidate prediction mode if the candidate prediction mode list for the I^{th} prediction mode includes the second candidate prediction mode in the foregoing case 2.

In some embodiments, the candidate prediction mode list for the I^{th} prediction mode further includes at least one of: a third candidate prediction mode corresponding to the first candidate weight derivation mode, a prediction mode for a neighbouring block of the current block, or a preset prediction mode.

In embodiments of the disclosure, the third candidate prediction mode corresponding to the first candidate weight derivation mode may be understood as a third candidate prediction mode determined based on the first candidate weight derivation mode. In embodiments of the disclosure, there is no limitation on the type of the third candidate prediction mode corresponding to the first candidate weight derivation mode.

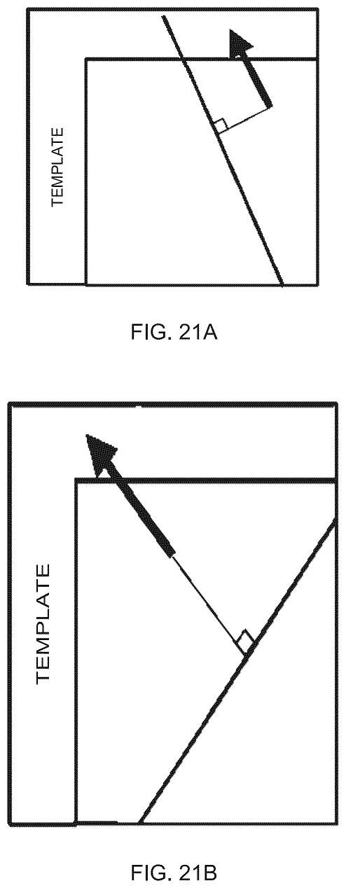

In an example, the third candidate prediction mode corresponding to the first candidate weight derivation mode includes a prediction mode with a prediction angle parallel to a partition line (or a weight boundary line) of the first candidate weight derivation mode. Exemplarily, as illustrated in FIG. 21A, assuming that the partition line of the first candidate weight derivation mode is marked by a diagonal line in the figure, at least one prediction mode with a prediction angle parallel to the partition line is determined as the third candidate prediction mode corresponding to the first candidate weight derivation mode.

In another example, the third candidate prediction mode corresponding to the first candidate weight derivation mode includes a prediction mode with a prediction angle perpendicular to a partition line (or a weight boundary line) of the first candidate weight derivation mode. Exemplarily, as illustrated in FIG. 21B, assuming that the partition line of the first candidate weight derivation mode is marked by a diagonal line in the figure, at least one prediction mode with a prediction angle is perpendicular to the partition line is determined as the third candidate prediction mode corresponding to the first candidate weight derivation mode.

In some embodiments, in order to accelerate determination of the third candidate prediction mode, a look-up table is constructed for angle indexes angleIdx and corresponding intra prediction modes. In this way, at the decoding end, the angle index of the first candidate weight derivation mode can be calculated, and an intra prediction mode with a prediction angle parallel to the partition line of the first candidate weight derivation mode can be obtained from the look-up table according to the angle index of the first candidate weight derivation mode. Optionally, an intra prediction mode with a prediction angle perpendicular to the partition line of the first candidate weight derivation mode can be calculated according to the intra prediction mode with the prediction angle parallel to the partition line of the first candidate weight derivation mode.

In some embodiments, when applying an intra prediction mode for the neighbouring block, intra prediction modes for at most five neighbouring blocks are applicable, where locations of the five neighbouring blocks are illustrated in FIG. 19. The coordinate of the top-left corner of the current block is denoted as (x0, y0), the width of the current block is denoted as width, and the height of the current block is denoted as height. The five neighbouring blocks are: neighbouring block AL determined according to coordinate (x0−1, y0−1), neighbouring block A determined according to coordinate (x0+width−1, y0−1), neighbouring block AR determined according to coordinate (x0+width, y0−1), neighbouring block L determined according to coordinate (x0−1, y0+height−1), and neighbouring block BL determined according to coordinate (x0−1, y0+height). According to whether the I^{th} prediction mode corresponds to the first part or the second part and the angle index angleIdx corresponding to the first candidate weight derivation mode, a range of the available neighbouring blocks is determined from the foregoing Table 5, where A may be understood as the top neighbouring block of the current block, and L may be understood as the left neighbouring block of the current block. If it is determined from Table 5 that the available neighbouring block corresponding to the I^{th} prediction mode is neighbouring block A, an intra prediction mode for neighbouring block A and an intra prediction mode for neighbouring block AR are added to the candidate prediction mode list corresponding to the I^{th} prediction mode. If it is determined from Table 5 that the available neighbouring block corresponding to the I^{th} prediction mode is neighbouring block L, an intra prediction mode for neighbouring block L and an intra prediction mode for neighbouring block BL are added to the candidate prediction mode list corresponding to the I^{th} prediction mode. If it is determined from Table 5 that the available neighbouring block corresponding to the I^{th} prediction mode is neighbouring blocks L+A, an intra prediction mode for neighbouring block A, an intra prediction mode for neighbouring block AR, an intra prediction mode for neighbouring block L, and an intra prediction mode for neighbouring block BL are added to the candidate prediction mode list corresponding to the I^{th} prediction mode. It can be seen from the above that, the prediction mode for neighbouring block AL is always applicable. Optionally, the order in which the neighbouring blocks are checked is L->A->BL->AR->AL.

In embodiments of the disclosure, there is no limitation on the type of the preset prediction mode. For example, the preset prediction mode may be at least one of: DC, a horizontal mode, a vertical mode, an angular mode, or a PLANAR mode.

In some embodiments, in order to reduce complexity of prediction, restriction is imposed on the length of the candidate prediction mode list. For example, the number of candidate prediction modes in the candidate prediction mode list for the I^{th} prediction mode is a preset number. The value of the preset number is not limited in embodiments of the disclosure, for example, the preset number is 3.

In some embodiments, according to a preset order, the preset number (such as 3) of prediction modes are selected from the first candidate prediction mode determined based on the template of the current block, the second candidate prediction mode determined based on the gradients of the reconstructed samples in the template of the current block, the prediction mode with the prediction angle parallel to the partition line of the first candidate weight derivation mode, the prediction mode with the prediction angle perpendicular to the partition line of the first candidate weight derivation mode, the prediction mode for the neighbouring block of the current block, and the PLANAR mode, to construct the candidate prediction mode list for the I^{th} prediction mode. In embodiments of the disclosure, no restriction is imposed on the preset order.

In an example, when constructing the candidate prediction mode list for the I^{th} prediction mode, the following types of prediction modes are sequentially added to the candidate prediction mode list until the length of the list reaches the preset number (such as 3):
1. The prediction mode with the prediction angle parallel to the partition line of the first candidate weight derivation mode;
2. The first candidate prediction mode determined based on the template of the current block. In some embodiments, the first candidate prediction mode is also referred to as a prediction mode derived based on TIMD;
3. The second candidate prediction mode determined based on the gradients of the reconstructed samples in the template of the current block. In some embodiments, the second candidate prediction mode is also referred to as a prediction mode derived based on DIMD;
4. The prediction mode for the neighbouring block of the current block;
5. The prediction mode with the prediction angle perpendicular to the partition line of the first candidate weight derivation mode;
6. The PLANAR mode.

The process of determining the candidate prediction mode list has been introduced in the foregoing embodiments.

At the decoding end, after determining the candidate prediction mode list through the foregoing steps, the following step S103 is performed.

S103, the first weight derivation mode and K first prediction modes are determined based on the N candidate weight derivation modes and the candidate prediction mode list.

At the decoding end, the N candidate weight derivation modes are determined through the foregoing step S101, and the candidate prediction mode list is determined through the foregoing step S102. Then one candidate weight derivation mode is selected from the N candidate weight derivation modes as the first weight derivation mode, and at least one first prediction mode in the K first prediction modes is determined from at least one candidate prediction mode in the candidate prediction mode list. Finally, the current block is predicted by applying the determined first weight derivation mode and K first prediction modes, to obtain a prediction value of the current block.

It should be noted that, the first weight derivation mode and the K first prediction modes are applied together to determine the prediction value of the current block. In some embodiments, the first weight derivation mode is also referred to as a weight derivation mode for the current block or a weight derivation mode corresponding to the current block. In some embodiments, the K first prediction modes are also referred to as K prediction modes for the current block or K prediction modes corresponding to the current block. In an example, if K=2, the K first prediction modes include a 1^{st} prediction mode and a 2^{nd} prediction mode corresponding to the current block. In some embodiments, the 1^{st} prediction mode is referred to as a first prediction mode, and the 2^{nd} prediction mode is referred to as a second prediction mode.

In embodiments of the disclosure, at the decoding end, there is no limitation on the manner for determining the first weight derivation mode and the K first prediction modes based on the N candidate weight derivation modes and the candidate prediction mode list.

In some embodiments, the candidate prediction mode list is a candidate prediction mode list corresponding to the K first prediction modes, that is, the K first prediction modes are all selected from the candidate prediction mode list. In this case, at the decoding end, the N candidate weight derivation modes are combined with candidate prediction modes in the candidate prediction mode list. For example, each candidate weight derivation mode in the N candidate weight derivation modes is combined with any K candidate prediction modes in the candidate prediction mode list to obtain multiple combinations, where each combination includes one candidate weight derivation mode and K candidate prediction modes. Then, for each combination, the template of the current block is predicted by applying a candidate weight derivation mode and K candidate prediction modes in the combination, and a cost of the combination is determined. Then one combination is determined from the multiple combinations based on the costs. For example, a combination with the minimum cost is selected from the multiple combinations, a candidate weight derivation mode in the combination with the minimum cost is determined as the first weight derivation mode, and K prediction modes in the combination with the minimum cost are determined as the K first prediction modes.

In some embodiments, the candidate prediction mode list is a candidate prediction mode list for a certain first prediction mode in the K first prediction modes, for example, K=2, and the candidate prediction mode list is a candidate prediction mode list for the 1^{st} prediction mode. In this case, at the decoding end, a set of optional prediction modes corresponding to the 2^{nd} prediction mode is determined. Then for each candidate weight derivation mode in the N candidate weight derivation modes, one candidate prediction mode is selected from the candidate prediction mode list for the 1^{st} prediction mode and taken as a possible choice for the 1^{st} prediction mode, and one prediction mode is selected from the set of optional prediction modes corresponding to the 2^{nd} prediction mode and taken as a possible choice for the 2^{nd} prediction mode, so as to obtain a combination of the candidate weight derivation mode, the possible choice for the 1^{st} prediction mode, and the possible choice for the 2^{nd} prediction mode. As such, multiple combinations can be obtained, where each combination includes one candidate weight derivation mode and two candidate prediction modes. Further, for each combination, the template of the current block is predicted by applying a candidate weight derivation mode and two candidate prediction modes in the combination, and a cost of the combination is determined. Then one combination is determined from the multiple combinations based on the costs. For example, a combination with the minimum cost is selected from the multiple combinations, a candidate weight derivation mode in the combination with the minimum cost is determined as the first weight derivation mode, and K prediction modes in the combination with the minimum cost is determined as the K first prediction modes.

In some embodiments, the candidate prediction mode list includes a candidate prediction mode list corresponding to each first prediction mode in the K first prediction modes, that is, at the decoding end, K candidate prediction mode lists are determined through the foregoing step S102, for example, assuming that K=2, that is, at the decoding end, a candidate prediction mode list for the 1^{st} prediction mode and a candidate prediction mode list for the 2^{nd} prediction mode are determined. In this case, at the decoding end, one candidate weight derivation mode is selected from the N candidate weight derivation modes, one candidate prediction mode is selected from the candidate prediction mode list for the 1^{st} prediction mode, and one candidate prediction mode is selected from the candidate prediction mode list for the 2^{nd} prediction mode. In this way, the selected one candidate weight derivation mode and two candidate prediction modes constitute one combination. According to the foregoing method, multiple combinations can be obtained, where each combination includes one candidate weight derivation mode and two candidate prediction modes. Then, for each combination, the template of the current block is predicted by applying a candidate weight derivation mode and two candidate prediction modes in the combination, and a cost of the combination is determined. Then, one combination is determined from the multiple combinations based on the costs. For example, a combination with the minimum cost is selected from the multiple combinations, a candidate weight derivation mode in the combination with the minimum cost is determined as the first weight derivation mode, and K prediction modes in the combination with the minimum cost are determined as the K first prediction modes.

Based on the above illustration, one weight derivation mode and K prediction modes can be applied together to the current block as a combination. In order to save codewords and reduce encoding cost, in some embodiments, a weight derivation mode and K prediction modes corresponding to the current block are used as a combination, namely a first combination, and the first combination is indicated by a first index. Compared with indicating separately the weight derivation mode and the K prediction modes, in [symbol] ents of the disclosure, fewer codewords are required, thereby reducing encoding

To this end, the above-described S103 includes the following steps S103-A to S103-C.

S103-A, the bitstream is decoded to obtain a first index, where the first index indicates a first combination, and the first combination includes a first weight derivation mode and K first prediction modes.

S103-B, a candidate combination list is determined based on the N candidate weight derivation modes and the candidate prediction mode list, where the candidate combination list includes at least one candidate combination, and the candidate combination includes one weight derivation mode and K prediction modes.

S103-C, based on the first index, a first combination is determined from the candidate combination list.

Embodiments of the present disclosure do not limit the specific form of a syntax element of the first index.

In a possible implementation, if GPM is used for the current block for prediction, gpm_cand_idx is used to represent the first index.

Since the first index is used to indicate the first combination, in some embodiments, the first index may also be referred to as a first combination index or an index of a first combination.

In an example, the syntax after introducing the first index to the bitstream is illustrated in Table 6:

TABLE 6

| | |
|---|---|
| if( condition for deriving that GPM is used for the current block | |
| ) { | |
| gpm_cand_idx[ x0 ][ y0 ] | ae(v) |
| } | |
| } | |

In this case, gpm_cand_idx is the first index.

Exemplarily, the candidate combination list is illustrated in Table 7:

TABLE 7

| Index | Candidate combination |
|---|---|
| 0 | Candidate combination 1 (including one weight derivation |
| | mode and K prediction modes) |
| 1 | Candidate combination 2 (including one weight derivation |
| | mode and K prediction modes) |
| . . . | . . . |
| i-1 | Candidate combination i (including one weight derivation |
| | mode and K prediction modes) |
| . . . | . . . |

As illustrated Table 7, the candidate combination list includes multiple candidate combinations, and any two candidate combinations in the multiple candidate combinations are not completely the same, i.e., any two candidate combinations differ in at least one of the weight derivation mode or the K prediction modes. For example, candidate combination 1 and candidate combination 2 have different weight derivation modes. Alternatively, candidate combination 1 and candidate combination 2 have the same weight derivation mode, but differ in at least one of the K prediction modes. Alternatively, candidate combination 1 and candidate combination 2 have different weight derivation modes, and also differ in at least one of the K prediction modes.

Exemplarily, in the foregoing Table 7, the order of a candidate combination in the candidate combination list is taken as an index of the candidate combination. Optionally, the index of the candidate combination in the candidate combination list can also be indicated in another manner, which is not limited in embodiments of the disclosure.

In this embodiment, at the decoding end, the bitstream is decoded to obtain the first index, the candidate combination list as illustrated in the above Table 7 is determined, and the first combination indicated by the first index is queried from the candidate combination list according to the first index, to obtain the first weight derivation mode and K prediction modes included in the first combination.

For example, the first index is index 1, and in the candidate combination list illustrated in Table 7, a candidate combination corresponding to index 1 is candidate combination 2, that is, the first combination indicated by the first index is candidate combination 2. In this case, at the decoding end, a weight derivation mode and K prediction modes in candidate combination 2 are determined as the first weight derivation mode and the K first prediction modes in the first combination, and prediction is performed on the current block by using the first weight derivation mode and the K first prediction modes, to obtain the prediction value of the current block.

In manner 2, the same candidate combination list can be determined at both the encoding end and the decoding end. For example, at both the encoding end and the decoding end, a list including X candidate combinations is determined, where each candidate combination includes one weight derivation mode and K prediction modes. At the encoding end, only one candidate combination finally chosen, for example, the first combination, needs to be signalled into the bitstream. At the decoding end, the first combination finally chosen at the encoding end is parsed. Specifically, at the decoding end, the bitstream is decoded to obtain the first index, and according to the first index, the first combination is determined from the candidate combination list determined at the decoding end.

The following describes the specific process of determining the candidate combination list based on the N candidate weight derivation modes and the candidate prediction mode list in S103-B.

Embodiments of the present disclosure do not limit the specific manner of determining the candidate combination list based on the N candidate weight derivation modes and the candidate prediction mode list in S103-B.

In some embodiments, the N candidate weight derivation modes are arbitrarily combined with multiple candidate prediction modes included in the candidate prediction mode list, with each combination including one weight derivation mode and two prediction modes. In this way, multiple combinations can be obtained. Using information related to the current block, the probabilities of occurrence of different combinations are analyzed, and the candidate combination list is constructed based on the probabilities of occurrence of respective combinations. Optionally, the information related to the current block includes mode information of neighbouring block(s) of the current block, reconstructed samples of the current block, etc.

In some embodiments, S103-B includes the following steps S103-B1 and S103-B2.

S103-B1, T second combinations are obtained based on the N candidate weight derivation modes and the candidate prediction mode list.

S103-B2, the candidate combination list is obtained based on the T second combinations.

In the above, any one of the T second combinations includes one weight derivation mode and K prediction modes, and the weight derivation mode and the K prediction modes included in any two of the T second combinations are not completely the same. Tis a positive integer greater than 1.

In this embodiment, the T second combinations are determined at the decoding end based on the N candidate weight derivation modes and the candidate prediction mode list. The present disclosure does not limit the specific number of the T second combinations, which may be such as 8, 16, 32, etc. Each of the T second combinations includes one weight derivation mode and K prediction modes, and the weight derivation mode and the K prediction modes included in any two of the T second combinations are not completely the same.

The embodiments of this disclosure do not limit the specific manner of obtaining the T second combinations based on the N candidate weight derivation modes and the candidate prediction mode list in the above S103-B1.

In some embodiments, if the candidate prediction mode list is the candidate prediction mode list corresponding to the K first prediction modes, that is, the K first prediction modes are all selected from this candidate prediction mode list, the N candidate weight derivation modes are combined with the candidate prediction modes included in the candidate prediction mode list at the decoding end. For example, each of the N candidate weight derivation modes is combined with any K candidate prediction modes in the candidate prediction mode list to obtain the T second combinations, with each second combination includes one candidate weight derivation mode and K candidate prediction modes.

In some embodiments, the candidate prediction mode list is the candidate prediction mode list for one of the K first prediction modes, for example, K=2 and the candidate prediction mode list mentioned above is the candidate prediction mode list for the first prediction mode. Then at the decoding end, a set of optional prediction modes corresponding to the second prediction mode is determined. Subsequently, for each of the N candidate weight derivation modes, at the decoding end, one candidate prediction mode is selected from the candidate prediction mode list for the first prediction mode as one possibility for the first prediction mode, and one prediction mode is selected from the set of optional prediction modes corresponding to the second prediction mode as one possibility for the second prediction mode. This results in a second combination composed of the candidate weight derivation mode, one possibility for the first prediction mode, and one possibility for the second prediction mode. In this way, T second combinations can be obtained, each of which includes one candidate weight derivation mode and two candidate prediction modes.

In some embodiments, the candidate prediction mode list includes the candidate prediction mode list corresponding to each of the K first prediction modes, that is to say, based on the step of S102, K candidate prediction mode lists are determined at the decoding end. For example, assuming K=2, at the decoding end, a candidate prediction mode list for the first prediction mode and a candidate prediction mode list for the second prediction mode are determined. In this case, one candidate weight derivation mode is selected from the N candidate weight derivation modes, one candidate prediction mode is selected from the candidate prediction mode list for the first prediction mode, and one candidate prediction mode is selected from the candidate prediction mode list for the second prediction mode at the decoding end. The selected one candidate weight derivation mode and the two candidate prediction modes form a second combination. By referring to the above method, T second combinations can be obtained, each of which includes one candidate weight derivation mode and two candidate prediction modes.

The manner for obtaining the candidate combination list based on the T second combinations in the above S103-B2 includes but is not limited to the following manners:
Manner 1: the T second combinations are sorted according to a preset rule to obtain the candidate combination list.
Manner 2: the above S103-B2 includes the following steps.

S103-B21, for any one of the T second combinations, a cost corresponding to the second combination when predicting the template of the current block using the weight derivation mode and the K prediction modes in the second combination, is determined.

S103-B22, the candidate combination list is determined based on the costs corresponding to the T second combinations.

In manner 2, for each of the T second combinations, the template of the current block is predicted using the weight derivation mode and the K prediction modes included in the second combination, to obtain a prediction value of the template corresponding to the second combination.

Specifically, for each of the T second combinations, the K prediction modes in the second combination are used to predict the template of the current block, resulting in K prediction values.

Then, based on the weight derivation mode in the second combination, a template weight corresponding to the second combination is determined.

In some embodiments, the template weight is determined according to the weight derivation mode as follows. An angle index, a distance index, and a blending parameter are determined according to the weight derivation mode, and the template weight is determined according to the angle index, the distance index, the blending parameter, and the size of the template.

In this disclosure, the method for deriving the template weight may be the same as the method for deriving the weight of the prediction value. For example, the angle index and the distance index are firstly determined according to the weight derivation mode.

The manner for determining the template weight according to the angle index, the distance index, and the size of the template includes, but is not limited to, the following manners.

Manner 1: a first parameter of samples in the template is determined according to the angle index, the distance index, and the size of the template. In some embodiments, the first parameter is also referred to as a weight index (weightIdx). Weights of the samples in the template are determined based on the first parameter of the samples in the template. The template weight is determined based on the weights of the samples in the template.

In a possible implementation, the template weight may be determined as follows.

The inputs to the template weight derivation process are: the width of the current block (nCbW), the height of the current block (nCbH); a width of the left template (nVmW), a height of the top template (nVmH); a “partition” angle index variable of GPM (angleId); a distance index variable of GPM (distanceIdx); a component index variable (cIdx). For example, in this disclosure, the luma component is used as an example, so cIdx is 0, indicating the luma component.

Variables nW, nH, shift1, offset1, displacementX, displacementY, partFlip, and shiftHor are derived as follows:

nW = ( cIdx = = 0 ) ? nCbW : nCbW * EubWidthC
nH = ( cIdx = = 0 ) ? nCbH : nCbH * EubHeightC
shift1 = Max( 5, 17 − BitDepth ) where BitDepth is a coding bit depth,
offset1 = 1 << ( shift1 − 1 )
displacementX = angleIdx
displacementY = ( angleIdx + 8 ) % 32
partFlip = ( angleIdx >= 13 && angleIdx <= 27 ) ? 0 : 1
shiftHor = ( angleIdx % 16 = = 8 | | ( angleIdx % 16 != 0 && nH >=
nW ) ) ? 0 : 1

Offsets offsetX and offsetY are derived as follows:

```
- if shiftHor = 0:
  offsetX = ( −nW ) >> 1
  offsetY = ( ( −nH ) >> 1 ) + ( angleIdx < 16 ? ( distanceIdx *
  nH ) >> 3 :
    −( ( distanceIdx * nH ) >> 3 ) )
- otherwise (i. e. shiftHor = 1):
  offsetX = ( ( −nW ) >> 1 ) + ( angleIdx < 16 ? ( distanceIdx *
  nW ) >> 3 :
    −( ( distanceIdx * nW) >> 3 )
  offsetY = ( − nH ) >> 1
```

The template weight matrix wVemplateValue[x][y] (where x=−nVmW . . . nCbW−1, y=−nVmH . . . nCbH−1, excluding the case where both x and y are greater than or equal to 0) is derived as follows, with the top-left corner of the current block as the coordinate origin (0, 0):
The variables xL and yL are derived as follows:

xL = (cIdx == 0) ? x : x * EubWidthC
yL = (cIdx == 0) ? y : y * EubHeightC

where disLut is determined according to the above Table 3.

The first parameter weightIdx is derived as follows:

weightIdx = ( ( ( xL + offsetX ) << 1 ) + 1 ) * disLut[ displacementX ] +
( ( ( yL + offsetY ) << 1 ) + 1 ) * disLut[ displacementY ]

In some embodiments, after determining the first parameter weightIdx according to the above method, the weight of the sample in the template is determined according to the formula:

weightIdxL = partFlip ? 32 + weightIdx : 32 − weightIdx
wVemplateValue[x][y] = Clip3(0, 8, (weightIdxL + 4) >> 3)

where wVemplateValue[x][y] is the weight of the sample (x, y) in the template, weightIdxL is the weight index in the first component (e.g., luma component), wVemplateValue[x][y] is the weight of the sample (x, y) in the template, partFlip is an intermediate variable determined according to the angle index angleIdx, for example, as described above: partFlip=(angleIdx>=13 && angleIdx<=27) ? 0:1. That is to say, the value of partFlip is 1 or 0. When partFlip is 0, weightIdxL is 32−weightIdx, and when partFlip is 1, weightIdxL is 32+weightIdx. It should be noted that the value 32 here is only an example and this disclosure is not limited to this.

Manner 2: the weight of the sample in the template is determined based on the first parameter weightIdx of the sample in the template, a first threshold, and a second threshold.

To reduce computational complexity of the template weight, in manner 2, the weight of the sample in the template is limited to either the first threshold or the second threshold. That is to say, the weight of the sample in the template is either the first threshold or the second threshold, thereby reducing the computational complexity of the template weight.

This disclosure does not limit the specific values of the first threshold and the second threshold.

Optionally, the first threshold is 1.

Optionally, the second threshold is 0.

In one example, the weight of the sample in the template may be determined by the following formula:

wVemplateValue[x][y]=(partFlip?weightIdx:−weightIdx)>0?1:0

where wVemplateValue[x][y] is the weight of the sample (x, y) in the template, and in the “1:0” in the above formula, “1” represents the first threshold and “0” represents the second threshold.

In the above manner 1, the weight of each sample in the template is determined based on the weight derivation mode, and the weight matrix composed of the weights of samples in the template serves as the template weight.

Manner 2: the weights of the current block and the template are determined according to the weight derivation mode. That is to say, in this manner 2, the combined area composed of the current block and the template is considered as a whole, and the weights of the samples in the combined area are derived according to the weight derivation mode.

For example, at the decoding end, the weights of the samples in the combined area composed of the current block and the template are determined based on the angle index, the distance index, the size of the template, the size of the current block. The template weight is determined based on the size of the template and the weights of the samples in the combined area.

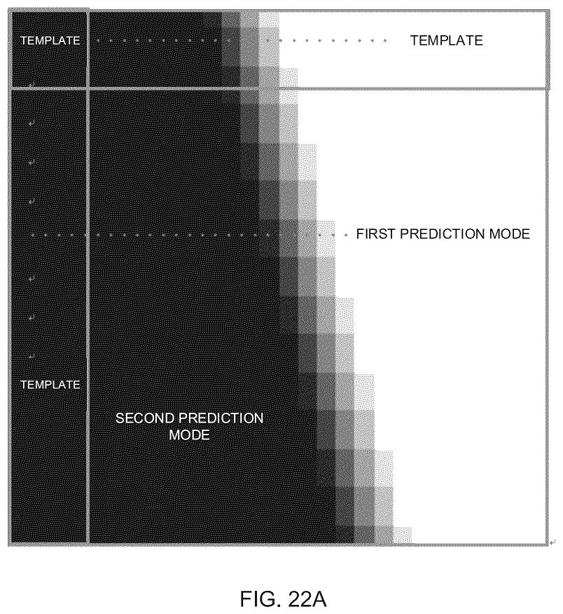

In manner 2, the current block and the template are treated as a whole, and the weights of the samples in the combined area composed of the current block and the template are determined based on the angle index, the distance index, as well as the size of the template and the size of the current block. Then, based on the size of the template, the weights corresponding to the template in the combined area are determined as the template weight. For example, as illustrated in FIG. 22A and FIG. 22B, the weights corresponding to the L-shaped template area in the combined area are determined as the template weights.

In one example, the process of deriving the template weight in manner 2 is as follows.

The inputs to this process are: the width of the current block (nCbW), the height of the current block (nCbH), the width of the left template (nTmW), the height of the top template (nTmH), the “partition” angle index variable of GPM (angleIdx), the distance index variable of GPM (distanceIdx), and the component index variable (cIdx). Since this example only considers the luma component, cIdx is 0, indicating the luma component.

The output of this process is the template weight matrix wTemplateValue.

The variables nW, nH, shift1, offset1, displacementX, displacementY, partFlip, and shiftHor are derived as follows:

nW = (cIdx == 0) ? nCbW : nCbW * SubWidthC
nH = (cIdx == 0) ? nCbH : nCbH * SubHeightC
shift1 = Max(5, 17 − BitDepth), where BitDepth is the coding bit depth,
offset1 = 1 << (shift1 − 1)
displacementX = angleIdx
displacementY = (angleIdx + 8) % 32
partFlip = (angleIdx >= 13 && angleIdx <= 27) ? 0 : 1
shiftHor = (angleIdx % 16 == 8 || (angleIdx % 16 != 0 && nH >=
nW)) ? 0 : 1

The variables offsetX and offsetY are derived as follows:

```
- If shiftHor =0:
  offsetX = (−nW) >> 1
  offsetY = ((−nH) >> 1) + (angleIdx < 16 ? (distanceIdx * nH) >>
  3 : −((distanceIdx *
    nH) >> 3))
- Otherwise (i.e., if shiftHor = 1):
  offsetX = ((−nW) >> 1) + (angleIdx < 16 ? (distanceIdx * nW) >>
  3 : −((distanceIdx *
    nW) >> 3))
  offsetY = (−nH) >> 1
```

The template weight matrix wTemplateValue[x][y](where x=−nTmW . . . nCbW−1, y=−nTmH . . . nCbH−1, excluding the case where both x and y are greater than or equal to 0) is derived as follows, with the top-left corner of the current block as the coordinate origin (0, 0):
The variables xL and yL are derived as follows:

```
  xL = (cIdx == 0) ? x : x * SubWidthC;
  yL = (cIdx == 0) ? y : y * SubHeightC;
where disLut is determined according to Table 3.
weightIdx = ((((xL + offsetX) << 1) + 1) * disLut[displacementX] +
((((yL + offsetY) <<
1) + 1) * disLut[displacementY]));
weightIdxL = partFlip ? 32 + weightIdx : 32 − weightIdx;
wTemplateValue[x][y] = Clip3(0, 8, (weightIdxL + 4) >> 3).
```

In some embodiments, for simplicity of calculation, the template weight can also be set to only 2 possible values, such as 0 and 1.

In one example, the weight of the sample in the template can be determined by the following formula:

wTemplateValue[x][y]=(partFlip?weightIdx:−weightIdx)>0?1:0.

The template weight corresponding to a second combination and K template prediction values are determined using the above method. The K template prediction values are weighted using the template weight to obtain the template prediction value under that second combination.

Since the template of the current block is a reconstructed area, the reconstructed value of the template can be obtained at the decoding end. Thus, for each of the T second combinations, the cost corresponding to the second combination can be determined based on the prediction value of the template and the reconstructed value of the template under the second combination. The method for determining the cost corresponding to the second combination includes, but is not limited to, SAD, SATD, SSE, etc. Subsequently, based on the costs corresponding to the T second combinations respectively, the candidate combination list is constructed.

In the embodiments of this disclosure, the manner for determining the prediction value of the template corresponding to the second combination includes at least the following methods.

In a first method, the prediction value of the template corresponding to the second combination is a single value. That is, at the decoding end, the K prediction modes included in the second combination are used separately to predict the template, obtaining K prediction values. The template weight is determined according to the weight derivation mode included in the second combination. The K prediction values are weighted using the template weight to obtain the weighted prediction value, which is determined as the prediction value of the template corresponding to the second combination.

In a second method, in some embodiments, a hierarchical screening idea can also be used. For example, if a weight derivation mode can achieve a relatively small cost, then weight derivation modes similar to this weight derivation mode can be tried. Conversely, if a weight derivation mode cannot achieve a relatively small cost, then similar weight derivation modes will not be tried. For example, if an intra prediction mode can achieve a relatively small cost, then similar intra prediction modes can be tried. Conversely, if an intra prediction mode cannot achieve a relatively small cost, then similar intra prediction modes will not be tried. These screening methods can also be limited to the use case of combining with other two elements. For example, under a certain weight derivation mode, if a certain intra prediction mode serving as the first prediction mode cannot achieve a relatively small cost, then under this weight derivation mode, intra prediction modes similar to this intra prediction mode will not be tried as the first prediction mode.

In a third method, a fast cost calculation method is used to determine the cost corresponding to each second combination. As mentioned above, the prediction values of the template corresponding to the second combination includes the prediction values of the template respectively corresponding to the K prediction modes included in the second combination. In this case, the costs respectively corresponding to the K prediction modes in the second combination can be determined based on the prediction values of the template and the reconstructed values of the template respectively corresponding to the K prediction modes in the second combination. The cost corresponding to the second combination is determined based on the costs respectively corresponding to the K prediction modes in the second combination. For example, the sum of the costs respectively corresponding to the K prediction modes in the second combination is determined as the cost corresponding to the second combination.

In the embodiments of this disclosure, assuming K=2, the weights on the template can be simplified to only two possibilities, 0 and 1. Therefore, for each sample position, the value comes only from the prediction block under the first prediction mode or the prediction block under the second prediction mode. Thus, for a prediction mode, the cost on the template when the prediction mode serves as the first prediction mode for a certain weight derivation mode can be calculated. That is, only the cost of the samples with weight 1 when this prediction mode serves as the first prediction mode for the weight derivation mode is calculated. For example, this cost can be denoted as cost[pred_mode_idx][gpm_idx][0], where pred_mode_idx represents the index of the prediction mode, gpm_idx represents the index of the weight derivation mode, and 0 indicates serving as the first prediction mode.

Further, the cost on the template when the prediction mode serves as the second prediction mode for the certain weight derivation mode can also be calculated. That is, only the cost of the samples with weight 1 when this prediction mode serves as the second prediction mode for this weight derivation mode is calculated. For example, this cost can be denoted as cost[pred_mode_idx][gpm_idx][1], where pred_mode_idx represents the index of the prediction mode, gpm_idx represents the index of the weight derivation mode, and 1 indicates serving as the second prediction mode.

Then, when calculating the cost of a combination, the corresponding two costs mentioned above can be directly added together. For example, to calculate the cost of prediction modes pred_mode_idx0 and pred_mode_idx1 under weight derivation mode gpm_idx, where pred_mode_idx0 is the first prediction mode and pred_mode_idx1 is the second prediction mode, denoting the cost as costTemp, then costTemp=cost[pred_mode_idx0][gpm_idx][0]+cost[pred_mode_idx1][gpm_idx][1]. For another example, to calculate the cost of prediction modes pred_mode_idx0 and pred_mode_idx1 under weight derivation mode gpm_idx, where pred_mode_idx1 is the first prediction mode and pred_mode_idx0 is the second prediction mode, denoting the cost as costTemp, then costTemp=cost[pred_mode_idx1][gpm_idx][0]+cost[pred_mode_idx0][gpm_idx][1].

One advantage of this approach is that it simplifies the process of first combining into one prediction block through weighting and then calculating the cost, to directly calculating costs of two parts and then adding the costs together to obtain the cost of the combination. Since a prediction mode may be combined with multiple other prediction modes, and for the same weight derivation mode, the costs of the parts when the prediction mode serves as the first prediction mode and the second prediction mode respectively are fixed, these costs (i.e., cost[pred_mode_idx][gpm_idx][0] and cost[pred_mode_idx][gpm_idx][1] in the above example) can be retained and reused to reduce the amount of computation.

Based on the above method, the costs respectively corresponding to the T second combinations can be determined. Subsequently, based on the costs respectively corresponding to the T second combinations, the candidate combination list can be constructed.

In the embodiments of this disclosure, the manner for determining the candidate combination list based on the costs respectively corresponding to the T second combinations in S103-B22 includes, but is not limited to, the following examples.

Example 1: the T second combinations are sorted based on the costs corresponding to the T second combinations, and the sorted T second combinations are determined as the candidate combination list.

In Example 1, the generated candidate combination list includes T first candidate combinations.

Optionally, the T first candidate combinations in the candidate combination list are sorted in ascending order of cost, that is, the costs corresponding to the T first candidate combinations in the candidate combination list increase sequentially according to the sorting order.

The sorting of the T second combinations based on the corresponding costs can be sorting the T second combinations in ascending order of cost.

Example 2: C second combinations are selected from the T second combinations based on the corresponding costs, and a list composed of the C second combinations is determined as the candidate combination list.

Optionally, the C second combinations are the top C second combinations with the smallest costs among the T second combinations. For example, the C second combinations with the smallest costs are selected from the T second combinations based on the corresponding costs to form the candidate combination list. In this case, the candidate combination list includes C candidate combinations.

Optionally, the C candidate combinations in the candidate combination list are sorted in ascending order of cost, that is, the costs corresponding to the C candidate combinations in the candidate combination list increase sequentially according to the sorting order.

At the decoding end, based on the above steps, the first combination corresponding to the first index is selected from the candidate combination list, and the weight derivation mode included in the first combination is determined as the first weight derivation mode, and the K prediction modes included in the first combination are determined as the K first prediction modes.

Based on the above steps, the first weight derivation mode and the K first prediction modes are determined at the decoding end. Then the following step S104 is performed.

S104, the current block is predicted according to the first weight derivation mode and the K first prediction modes to obtain the prediction value of the current block.

In the embodiments of this disclosure, when decoding the current block, the N candidate weight derivation modes and the candidate prediction mode list are determined at the decoding end. The candidate prediction mode list includes at least one candidate prediction mode, where at least one candidate prediction mode is determined based on the partitioning of the template of the current block. That is to say, in the embodiments of this disclosure, when determining the candidate prediction mode, the prediction mode is derived through the partitioned template, which realizes the accurate derivation of the prediction mode and thereby improves the accuracy of determining the candidate prediction mode list. Subsequently, based on the N candidate weight derivation modes and the accurately determined candidate prediction mode, the first weight derivation mode and the K first prediction modes are determined, which realizes the accurate determination of the first weight derivation mode and the K first prediction modes. When predicting the current block based on the accurately determined first weight derivation mode and the K first prediction modes, the prediction accuracy can be improved, thereby enhancing the decoding performance.

The embodiments of this disclosure do not limit the specific process of predicting the current block based on the first weight derivation mode and the K first prediction modes in the above S104 to obtain the prediction value of the current block.

Case 1, when determining weights of prediction values, the weight gradient parameter (also called the blending parameter) is not considered. The weights of the prediction values of the current block are determined based on the first weight derivation mode. The current block is predicted based on the K first prediction modes to obtain K prediction values of the current block. The K prediction values of the current block are weighted using the weights of the prediction values of the current block to obtain the prediction value of the current block. For the process of deriving the weights of prediction values of the current block based on the first weight derivation mode, reference can be made to the process of deriving the weights of prediction values of the current block in the above embodiments, which will not be repeated herein.

Case 2, when determining the weights of prediction value, the weight gradient parameter is considered. The above S104 includes the following steps.

S104-A1, the weight gradient parameter is determined.

S104-A2, the current block is predicted based on the weight gradient parameter, the first weight derivation mode, and the K first prediction modes, to obtain the prediction value of the current block.

In the above Case 1, the gradient of the weights is fixed. However, in some embodiments, the variable weight gradient can adjust the gradient of weight changes, thereby allowing the GPM to obtain blending regions of different widths under the same partition line angle and partition line offset.

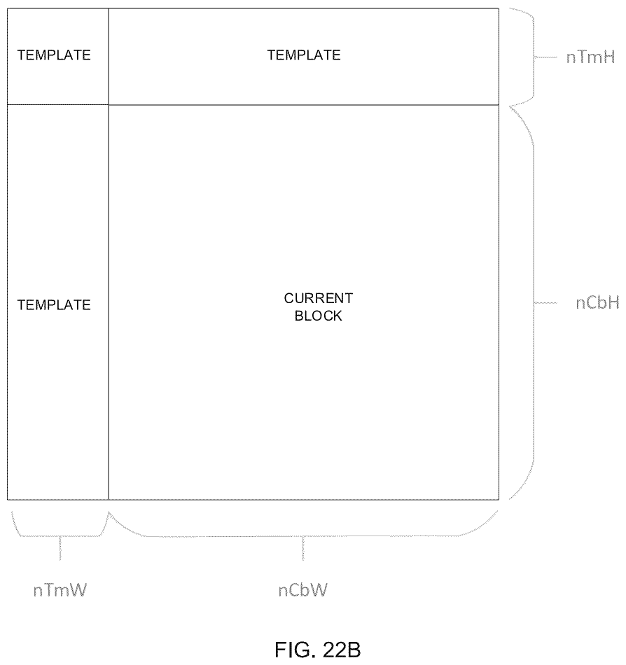

For example, as illustrated in FIG. 23A and FIG. 23B, FIG. 23A is a schematic diagram of the GPM blending area in VVC, and FIG. 23B is an example of the variable weight gradient of GPM.

The value of blendingCoeff can be ¼, ½, 1, 2, 4, etc.

For example, the value of blendingCoeff can be derived from the weight gradient index gpm_blending_idx.

In some embodiments, the weight gradient index is also referred to as a blending gradient parameter or blending parameter.

The embodiments of this disclosure do not limit the specific implementation process of the above S104-A2. For example, the first weight derivation mode and the K first prediction modes are used to predict the current block to obtain a prediction value, and then a prediction value of the current block is determined based on the weight gradient parameter and the prediction value.

In some embodiments, the above S104-A2 includes the following steps.

S104-A21, weights of prediction values are determined based on the weight gradient parameter and the first weight derivation mode.

S104-A22, the current block is predicted according to the K first prediction modes to obtain K prediction values.

S104-A23, the K prediction values are weighted based on the weights of the prediction values to obtain the prediction value of the current block.

There is no specific order of execution between S104-A22 and S104-A21, that is, S104-A22 can be executed before S104-A21, or after S104-A21, or in parallel with S104-A21.

In Case 2, the decoding end determines the weight gradient parameter, and determines the weights of the prediction values based on the weight gradient parameter and the first weight derivation mode. Subsequently, the current block is predicted based on the K first prediction modes to obtain K prediction values of the current block. Then, the K prediction values of the current block are weighted using the weights of the prediction values to obtain the prediction value of the current block.

In the embodiments of this disclosure, the manner for determining the weight gradient parameter includes, but is not limited to, the following manners.

Manner 1, the bitstream is decoded to obtain a second index, where the second index indicates the weight gradient parameter. Based on the second index, the weight gradient parameter is determined. Specifically, after the weight gradient parameter is determined at the encoding end, the second index corresponding to the weight gradient parameter is signalled into the bitstream. Then the bitstream is decoded at the decoding end to obtain the second index, and the weight gradient parameter is determined based on the second index.

In some embodiments, the second index is also referred to as the weight gradient index.

In an example, the syntax corresponding to manner 1 is illustrated in Table 8.

TABLE 8

| | |
|---|---|
| if (the condition for deriving that GPM is | |
| used for the current block) { | |
| gpm_cand_idx[ x0 ][ y0 ] | ae(v) |
| gpm_blending_idx[ x0 ][ y0 ] | ae(v) |
| } | |

In Table 8, gpm_cand_idx represents the first index, and gpm_blending_idx represents the second index.

In some embodiments, different weight gradient parameters have a relatively small impact on the prediction results of the template. If the simplified method is used, that is, the weights on the template are only 0 and 1, the weight gradient parameter will not affect the prediction of the template, that is, it cannot affect the candidate combination list. In this case, the blending gradient index can be placed outside the combination.

The embodiments of this disclosure do not limit the specific manner for determining the weight gradient parameter based on the second index.

In some embodiments, at the decoding end, a candidate blending parameter list is determined, which includes multiple candidate blending parameters. A candidate blending parameter corresponding to the second index in the candidate blending parameter list is determined as the weight gradient parameter.

The embodiments of this disclosure do not limit the manner for determining the candidate blending parameter list.

In an example, the candidate blending parameters in the above candidate blending parameter list are preset.

In another example, at the decoding end, based on the characteristics of the current block, at least one blending parameter is selected from preset multiple blending parameters to form the candidate blending parameter list. For example, based on image information of the current block, blending parameters that match the image information of the current block are selected from the preset multiple blending parameters to form the candidate blending parameter list.

For example, assuming that the image information includes sharpness of image edges, if the sharpness of the image edges of the current block is less than a preset value, at least one first-type weight gradient parameter, such as ¼, ½, etc., is selected from the preset multiple weight gradient parameters to form the candidate weight gradient parameter list. If the sharpness of the image edges of the current block is greater than or equal to the preset value, at least one second-type weight gradient parameter, such as 2, 4, etc., is selected from the preset multiple weight gradient parameters to form the candidate weight gradient parameter list.

For example, the candidate weight gradient parameter list in the embodiments of this disclosure is illustrated in Table 9.

TABLE 9

| index | candidate weight gradient parameter |
|---|---|
| 0 | candidate weight gradient parameter 0 |
| 1 | candidate weight gradient parameter 1 |
| . . . | . . . |
| i | candidate weight gradient parameter i |
| . . . | . . . |

As illustrated in Table 9, the candidate weight gradient parameter list includes multiple candidate weight gradient parameters, with each candidate weight gradient parameter corresponding to one index.

For example, in the above Table 9, the index of the candidate weight gradient parameter is represented by an order of the candidate weight gradient parameter in the candidate weight gradient parameter list. Optionally, the index of the candidate weight gradient parameter in the candidate weight gradient parameter list may be represented according to another method, which is not limited in the embodiments of this disclosure.

Based on the above Table 9, according to the second index, the decoding end determines the weight gradient parameter corresponding to the second index in Table 9 as the weight gradient parameter.

In addition to determining the weight gradient parameter according to the second index that is decoded from the bitstream in the above manner 1, the decoding end can also determine the weight gradient parameter in the following manner 2.

In some embodiments, the weight gradient index will not be signalled into the bitstream. Instead, a weight gradient index gpm_blending_idx or blendingCoeff can be derived directly based on the block size, etc. At the decoding end, the weight gradient parameter can also be determined in the following manner 2.

Manner 2, the weight gradient parameter is determined through the following steps S104-A11 and S104-A12.

S104-A11, multiple alternative weight gradient parameters are determined.

S104-A12, the weight gradient parameter is selected from the multiple alternative weight gradient parameters.

In manner 2, the weight gradient parameter is determined independently by the decoding end, thereby avoiding signalling of the second index into the bitstream at the encoding end, thus saving code words. Specifically, at the decoding end, multiple alternative weight gradient parameters are determined first, and then one of these alternative weight gradient parameters is selected as the weight gradient parameter.

The embodiments of this disclosure do not limit the specific manner for the decoding end to determine the multiple alternative weight gradient parameters.

In one possible implementation, the multiple alternative weight gradient parameters are preset. That is to say, the decoding end and the encoding end agree to determine several preset weight gradient parameters as the multiple alternative weight gradient parameters.

In another possible implementation, the multiple alternative weight gradient parameters can be indicated by the encoding end. For example, the encoding end indicates that multiple weight gradient parameters from a set of preset weight gradient parameters are used as the alternative weight gradient parameters.

In another possible implementation, the multiple alternative weight gradient parameters can be determined based on the size of the current block.

In another possible implementation, the image information of the current block is determined first. Then, based on the image information, multiple alternative weight gradient parameters are selected from a set of preset alternative weight gradient parameters.

After the multiple alternative weight gradient parameters are determined at the decoding end, one of the multiple alternative weight gradient parameters is selected as the weight gradient parameter.

The embodiments of this disclosure do not limit the specific manner for selecting the weight gradient parameter from the multiple alternative weight gradient parameters.

In some embodiments, any one of the multiple alternative weight gradient parameters can be selected as the weight gradient parameter.

In some embodiments, the cost corresponding to each of the multiple alternative weight gradient parameters is determined. Then, based on the costs, the weight gradient parameter is determined from the multiple alternative weight gradient parameters. For example, the weight gradient parameter with the smallest cost can be determined as the gradient parameter corresponding to the current block.

Manner 3, the weight gradient parameter is determined based on the size of the current block.

As mentioned above, there is a certain correlation between the weight gradient parameter and the block size. Therefore, in the embodiments of this disclosure, the weight gradient parameter can also be determined based on the size of the current block.

In one possible implementation, a fixed weight gradient parameter is determined as the weight gradient parameter based on the size of the current block.

For example, if the size of the current block is less than a first predetermined threshold, then the weight gradient parameter is determined as a first value.

For another example, if the size of the current block is greater than or equal to the first predetermined threshold, then the weight gradient parameter is determined as a second value, where the second value is less than the first value.

The embodiments of this disclosure do not limit the specific values of the above-mentioned first value, second value, and first predetermined threshold.

For example, the first value is 1, and the second value is ½.

For example, if the size of the current block is represented by the number of samples (or pixel points) in the current block, then the first predetermined threshold can be 256, etc.

In another possible implementation, a value range of the weight gradient parameter is determined based on the size of the current block, and then the weight gradient parameter is determined as a value within this range.

For example, if the size of the current block is less than a first predetermined threshold, then the weight gradient parameter is determined to be within a certain range of weight gradient parameter. For instance, the weight gradient parameter can be the minimum, maximum, or any intermediate value within this range of weight gradient parameter. Alternatively, the weight gradient parameter can be the one with the smallest cost within this range of weight gradient parameter. The manner for determining the cost of the weight gradient parameter can refer to the descriptions in other embodiments of this disclosure, which will not be repeated here.

For another example, if the size of the current block is greater than or equal to the first predetermined threshold, then the weight gradient parameter is determined to be within a second range of weight gradient parameter. For instance, the weight gradient parameter can be the minimum, maximum, or any intermediate value within the second range of weight gradient parameter. Alternatively, the weight gradient parameter can be the one with the smallest cost within the second range of weight gradient parameter. The minimum value of the second range is less than the minimum value of the first range, and the two ranges can either intersect or be disjoint, which is not limited in the embodiments of this disclosure.

After determining the weight gradient parameter according to the above steps in case 2, the step S104-A21 is executed to determine the weight of the prediction value based on the weight gradient parameter and the first weight derivation mode.

In the embodiments of this disclosure, the manner for determining the weight of the prediction value based on the weight gradient parameter and the first weight derivation mode includes, but is not limited to, the following examples.

Example 1, when the first weight derivation mode is used to derive the weight of the prediction value, multiple intermediate variables need to be determined. The weight gradient parameter can be used to adjust one or several of these intermediate variables, and then the adjusted variables are used to derive the weight of the prediction value.

Example 2, the weight index weightIdx corresponding to the current block is determined based on the first weight derivation mode and the current block. The weight index weightIdx is processed using the weight gradient parameter to obtain the processed weightIdx. The weight of the prediction value wVemplateValue is determined based on the processed weightIdx.

In one example, the weight of the prediction value wVemplateValue can be determined using the weight gradient parameter as follows:

... ...
weightIdx = ( ( ( xL + offsetX ) << 1 ) + 1 ) * disLut[ displacementX ] +
( ( ( yL + offsetY ) << 1 ) + 1 ) * disLut[ displacementY ]
weightIdx = weightIdx * blendingCoeff
weightIdxL = partFlip ? 32 + weightIdx : 32 − weightIdx
wValue = Clip3( 0, 8, ( weightIdxL + 4 ) >> 3 )

Here, blendingCoeff is the weight gradient parameter.

Subsequently, the current block is predicted using the K first prediction modes to obtain K prediction values. The K prediction values are weighted using the weights of the prediction values to obtain the prediction value of the current block.

The above example can be understood as two independent processes for the template weight and the weight of the prediction value, which do not interfere with each other. Through the above method, the weight of the prediction value can be determined separately.

In some embodiments, considering the combined area that is composed of the template area and the current block, if the template weight is determined by determining the weights of the combined area, since the combined area contains the current block, the weights corresponding to the current block in the combined area is determined as the weights of the prediction values. It should be noted that when determining the weights of the combined area, the influence of the weight gradient parameter on the weight is also considered. For details, reference is made to the above examples, which will not be repeated herein.

In some embodiments, the above prediction operation is performed on a sample basis, and accordingly, the weights of the prediction values are weights corresponding to a sample. In this case, when predicting the current block, a certain sample (i.e. sample A) in the current block is predicted by applying each of the K first prediction modes, so as to obtain K prediction values of sample A under the K first prediction modes, and weights of prediction values of sample A are determined according to the first weight derivation mode and a weight blending parameter. Then, the K prediction values are weighted with the weights of the prediction values of sample A, to obtain a prediction value of sample A. The foregoing steps are performed on each sample in the current block, and thus a prediction value of each sample in the current block can be obtained, where the prediction values of respective samples in the current block constitutes the prediction value of the current block. Taking K=2 as an example, sample A in the current block is predicted by applying a 1^{st} prediction mode, so as to obtain a first prediction value of sample A; and sample A is predicted by applying a 2^{nd} prediction mode, so as to obtain a second prediction value of sample A. The first prediction value and the second prediction value are weighted according to the weights of the prediction values corresponding to sample A, so as to obtain the prediction value of sample A.

In an example, taking K=2 as an example, if a 1^{st} prediction mode and a 2^{nd} prediction mode are both intra prediction modes, prediction is performed by applying a first intra prediction mode to obtain a first prediction value; and prediction is performed by applying a second intra prediction mode to obtain a second prediction value. The first prediction value and the second prediction value are weighted according to the weights of the prediction values to obtain the prediction value of the current block. For example, sample A is predicted by applying the first intra prediction mode, to obtain a first prediction value of sample A; and sample A is predicted by applying the second intra prediction mode, to obtain a second prediction value of sample A. The first prediction value and the second prediction value are weighted with weights of prediction values corresponding to sample A, to obtain the prediction value of sample A.

In some embodiments, when K is greater than 2, weights of prediction values corresponding to two prediction modes among the K first prediction modes can be determined based on the first weight derivation mode, while weights of prediction values corresponding to other prediction modes among the K first prediction modes can be preset values. For example, when K=3, first weights of prediction values corresponding to the 1^{st} and 2^{nd} prediction modes respectively are derived based on the weight derivation mode, while a weight of prediction value corresponding to the 3^{rd} prediction mode is a preset value. In some embodiments, if the total weight of prediction values corresponding to the K first prediction modes is fixed, such as 8, the weights of the prediction values respectively corresponding to the K first prediction modes can be determined based on preset weight ratios. Suppose the weight of the prediction value corresponding to the 3^{rd} prediction mode accounts for ¼ of the total weight of the prediction values. In this case, the weight of the prediction value corresponding to the 3^{rd} prediction mode can be determined as 2, with the remaining ¾ of the total weight allocated to the 1^{st} and 2^{nd} prediction modes. For example, if the weight of the prediction value corresponding to the 1^{st} prediction mode is derived as 3 based on the first weight derivation mode, then the weight of the prediction value corresponding to the 1^{st} prediction mode can be determined as (¾)×3, and the weight of the prediction value corresponding to the 2^{nd} prediction mode can be determined as (¾)×5.

Based on the above method, the prediction value of the current block is determined. Further, the bitstream is decoded to obtain quantized coefficients of the current block. The quantized coefficients are inverse quantized and inverse transformed to obtain a residual value of the current block. The prediction value of the current block is then added to the residual value to obtain a reconstructed value of the current block.

In the video decoding method provided in the embodiments of this disclosure, the decoding end determines N candidate weight derivation modes and a candidate prediction mode list when decoding the current block. The candidate prediction mode list includes at least one candidate prediction mode, where at least one candidate prediction mode is determined based on partitioning of the template of the current block. That is to say, in the embodiments of this disclosure, when determining the candidate prediction mode, the prediction mode is derived through the partitioned template, which realizes the accurate derivation of the prediction mode and thereby improves the accuracy of determining the candidate prediction mode list. Subsequently, based on the N candidate weight derivation modes and the accurately-determined candidate prediction mode, the first weight derivation mode and the K first prediction modes are determined, which improves the accuracy of determining the first weight derivation mode and the K first prediction modes. When predicting the current block based on the accurately determined first weight derivation mode and the K first prediction modes, the prediction accuracy can be improved, thereby enhancing the decoding performance.

The video decoding method of the disclosure is elaborated above by taking a decoding end as an example, and the following elaboration is given by taking an encoding end as an example.

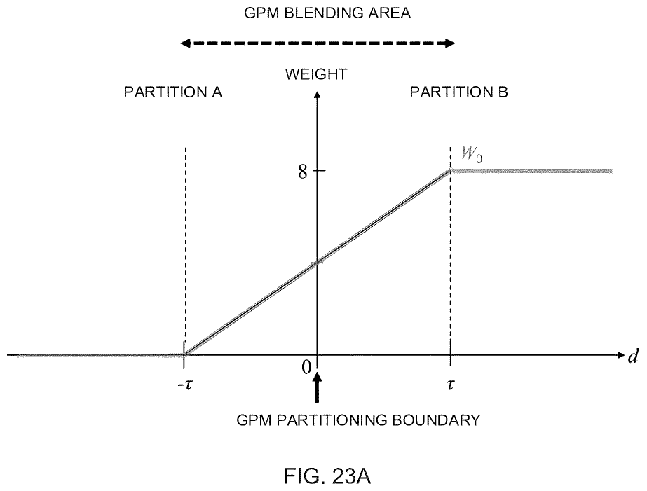

FIG. 24 is a schematic flowchart of a video encoding method provided in an embodiment of the disclosure. The embodiment of the disclosure is applied to the video encoders illustrated in FIG. 1 and FIG. 2. As illustrated in FIG. 24, the method according to embodiments of the disclosure includes the following.

S201, N candidate weight derivation modes are determined.

N is a positive integer. Optionally, N is a preset value or a default value. Optionally, N may also be determined at the decoding end in other manners, which is not limited in embodiments of the disclosure.

It can be seen from the above that, in embodiments of the disclosure, a prediction block is generated based on one weight derivation mode and K prediction modes, and the prediction block is applied to a current block. In other words, weights are determined according to the weight derivation mode, the current block is predicted according to the K prediction modes to obtain K prediction values, and the K prediction values are weighted according to the weights, to obtain a prediction value of the current block.

That is, at the encoding end, when encoding the current block, the N candidate weight derivation modes and multiple candidate prediction modes need to be determined. Further, one weight derivation mode is selected from the N candidate weight derivation modes, and K prediction modes are selected from the multiple candidate prediction modes. Then the current block is predicted by applying the selected one weight derivation mode and K prediction modes, to obtain the prediction value of the current block.

In embodiments of the disclosure, there is no limitation on the manner for the encoding end to determine the N candidate weight derivation modes.

In a possible implementation, there are 56 weight derivation modes for AWP and 64 weight derivation modes for GPM. The N candidate weight derivation modes include at least one weight derivation mode in the 56 weight derivation modes for AWP, or include at least one weight derivation mode in the 64 weight derivation modes for GPM.

In a possible implementation, some of the weight derivation modes for AWP or GPM can be selected and taken as the N candidate weight derivation modes. That is, the N candidate weight derivation modes in embodiments of the disclosure are a subset of all the weight derivation modes for AWP or GPM. For example, for weight derivation modes, the same “partition” angle may correspond to multiple offsets. For example, weight derivation modes 10, 11, 12, and 13 illustrated in FIG. 4 or FIG. 5 have the same “partition” angle, but have different offsets. Therefore, in embodiments of the disclosure, modes corresponding to some offsets can be removed, and modes corresponding to some “partition” angles can also be removed. As such, it is possible to reduce the total number of possible combinations, and on the other hand, to make various possible combinations differ more significantly. Different selection methods may be set for blocks of different sizes. For example, fewer weight derivation modes are set for a small block, while more weight derivation modes are set for a large block. Different selection methods may also be set for blocks of different shapes, where the block shape can refer to the ratio of width to height.

In this implementation, the manner for selecting the N candidate weight derivation modes at the encoding end is the same as that at the decoding end. In an example, the manner for selecting the N candidate weight derivation modes is default at both the encoding end and the decoding end. In another example, at the encoding end, the manner for selecting the N candidate weight derivation modes may be indicated to the decoding end, so that at the decoding end, the N candidate weight derivation modes that are the same as those at the encoding end can be selected in the same manner.

In some embodiments, a weight derivation mode corresponding to a preset partition angle and/or a preset offset is removed from M preset weight derivation modes, to obtain the N weight derivation modes. In the weight derivation modes, the same partition angle may correspond to multiple offsets. As illustrated in FIG. 4, weight derivation modes 10, 11, 12, and 13 have the same partition angle, but have different offsets. Therefore, weight derivation modes corresponding to some preset offsets can be removed, and/or weight derivation modes corresponding to some preset partition angles can be removed.

In some embodiments, selection conditions corresponding to different blocks can be different. In this way, when determining N weight derivation modes corresponding to the current block, a selection condition corresponding to the current block is firstly determined, and then N weight derivation modes are selected from the M preset weight derivation modes according to the selection condition corresponding to the current block.

In some embodiments, the selection condition corresponding to the current block includes a selection condition corresponding to the size of the current block and/or a selection condition corresponding to the shape of the current block. During prediction, for a small block, prediction results under similar weight derivation modes differ slightly, while for a large block, prediction results under similar weight derivation modes will have more significant difference. Therefore, in embodiments of the disclosure, different values of N are set for blocks of different sizes, i.e. a large value of N is set for a large block, while a small value of N is set for a small block.

In a possible implementation, the N candidate weight derivation modes are indicated by the encoding end to the decoding end.

In some embodiments, the selection condition is implemented by an array. The array includes N elements, and the N elements are in one-to-one correspondence with the N weight derivation modes. An element corresponding to each weight derivation mode indicates whether the weight derivation mode is applicable.

The array can be a one-dimensional array or a two-dimensional array.

For example, taking GPM as an example, the total number of possible weight derivation modes is 64. At the encoding end, a look-up table including 64 elements is set, where a value of each element indicates whether to apply a weight derivation mode corresponding to the element.

In an example, taking a one-dimensional array as an example, a specific example is as follows, in which an array of g_sgpm_splitDir is set:

g_sgpm_splitDir[64] = {
1,1,1,0,1,0,1,0,
1,0,1,0,1,0,1,0,
1,0,1,1,1,0,1,0,
1,0,1,0,1,0,1,0,
0,0,0,0,1,1,0,1,
0,0,1,0,0,1,0,0,
1,0,1,1,0,1,0,0,
1,0,0,1,0,0,1,0
};

If the value of g_sgpm_splitDir[x] is 1, it indicates that a weight derivation mode with an index of x is applicable; otherwise, it indicates that the weight derivation mode with an index of x is not applicable. In this example, at the encoding end, 26 candidate weight derivation modes are determined based on the array.

In another example, the N candidate weight derivation modes may be indicated by one array, where the array includes only an index of a weight derivation mode that is applicable. For example, 26 candidate weight derivation modes are indicated by an array g_sgpm_splitDir[26]={0,1,6,8,10,12,14,16,18,19,20,22,24,26,28,30,36,37,42,45,48,50,51,53,56,59} with a length of 26. At the encoding end, based on indexes of weight derivation modes in the array, weight derivation modes corresponding to the indexes are determined as the candidate weight derivation modes, thereby obtaining 26 candidate weight derivation modes.

In some embodiments, if the selection condition corresponding to the current block includes the selection condition corresponding to the size of the current block and the selection condition corresponding to the shape of the current block, and for the same weight derivation mode, if the selection condition corresponding to the size of the current block and the selection condition corresponding to the shape of the current block both indicate that the weight derivation mode is applicable, the weight derivation mode is determined as one of the N weight derivation modes. If at least one of the selection condition corresponding to the size of the current block or the selection condition corresponding to the shape of the current block indicates that the weight derivation mode is not applicable, it is determined that the weight derivation mode does not belong to the N weight derivation modes.

In some embodiments, selection conditions corresponding to different block sizes and selection conditions corresponding to different block shapes can be implemented separately by multiple arrays.

In some embodiments, selection conditions corresponding to different block sizes and selection conditions corresponding to different block shapes can be implemented by two-dimensional arrays, that is, one two-dimensional array includes both the selection condition corresponding to the block size and the selection condition corresponding to the block shape.

Exemplarily, for a block with a size of A and a shape of B, a selection condition corresponding to the block is illustrated below, and the selection condition is represented by a two-dimensional array:

g_sgpm_splitDir[64] = {
(1,1),(1,1),(1,1),(1,0),(1,0),(0,0),(1,0),(1,1),
(1,1),(0,0),(1,1),(1,0),(1,0),(0,0),(1,0),(1,1),
(0,1),(0,0),(1,1),(0,0),(1,0),(0,0),(1,0),(0,0),
(1,1),(0,0),(0,1),(1,0),(1,0),(1,0),(1,0),(0,0),
(0,0),(0,0),(1,1),(0,0),(1,1),(1,1),(1,0),(0,1),
(0,0),(0,0),(1,1),(0,0),(1,0),(0,0),(1,0),(0,0),
(1,0),(0,0),(1,1),(1,0),(1,0),(1,0),(0,0),(0,0),
(1,1),(0,0),(1,1),(0,0),(0,0),(1,0),(1,1),(0,0)
};

If both values of g_sgpm_splitDir[x] are 1, it indicates that a weight derivation mode with an index of x is applicable; and if one of the values of g_sgpm_splitDir[x] is 0, it indicates that the weight derivation mode with an index of x is not applicable. For example, g_sgpm_splitDir[4]=(1,0) indicates that weight derivation mode 4 is applicable to a block with a size of A, but is not applicable to a block with a shape of B. Therefore, if the size of a block is A and the shape of the block is B, the weight derivation mode is not applicable.

It should be noted that, in the foregoing elaborations, the 64 weight derivation modes for GPM are taken as an example, but the weight derivation mode in embodiments of the disclosure includes, but is not limited to, the 64 weight derivation modes for GPM and the 56 weight derivation modes for AMP.

In some embodiments, at the encoding end, before determining the N candidate weight derivation modes, whether K different prediction modes are applied to the current block for weighted prediction needs to be determined. If it is determined at the encoding end that K different prediction modes are applied to the current block for weighted prediction, the foregoing S201 is performed to determine the N candidate weight derivation modes. If it is determined at the encoding end that K different prediction modes are not applied to the current block for weighted prediction, S201 is skipped.

In a possible implementation, at the encoding end, whether K different prediction modes are applied to the current block for weighted prediction can be determined by determining a prediction-mode parameter for the current block.

Optionally, in embodiments of the disclosure, the prediction-mode parameter can indicate whether a GPM mode or an AWP mode can be applied to the current block, that is, indicate whether K different prediction modes can be applied for prediction of the current block.

It can be understood that, in embodiments of the disclosure, the prediction-mode parameter can be understood as a flag indicating whether the GPM mode or the AWP mode is applied. Specifically, an encoder can use a variable as the prediction-mode parameter, so that the prediction-mode parameter can be set by setting the value of the variable. Exemplarily, in the disclosure, if the GPM mode or the AWP mode is applied to the current block, the encoder can set the value of the prediction-mode parameter to indicate that the GPM mode or the AWP mode is applied to the current block, and specifically, the encoder can set the value of the variable to 1. Exemplarily, in the disclosure, if the GPM mode or the AWP mode is not applied to the current block, the encoder can set the value of the prediction-mode parameter to indicate that the GPM mode or the AWP mode is not applied to the current block, and specifically, the encoder can set the value of the variable to 0. Further, in embodiments of the disclosure, after setting the prediction-mode parameter, the encoder can signal the prediction-mode parameter into the bitstream and transmit the bitstream to a decoder, so that the decoder can obtain the prediction-mode parameter after parsing the bitstream.

In some embodiments, in embodiments of the disclosure, a condition regarding whether the GPM mode or the AWP mode is applied to the current block can also be set, i.e. if the current block is determined to satisfy a preset condition, it is determined that K prediction modes are applied to the current block for weighted prediction, and then the N candidate weight derivation modes corresponding to the current block are determined.

Exemplarily, when applying the GPM mode or the AWP mode, restriction can be imposed on the size of the current block.

It can be understood that, in the video encoding method provided in embodiments of the disclosure, K prediction values need to be generated by applying K different prediction modes, and then are weighted according to weights to obtain the prediction value of the current block. In order to reduce complexity and take into consideration the trade-off between compression performance and complexity, in embodiments of the disclosure, there can be a restriction that the GPM mode or the AWP mode is not applied to a block of a certain size. Therefore, in the disclosure, the encoder can firstly determine a size parameter of the current block, and then determine, according to the size parameter, whether the GPM mode or the AWP mode is applied to the current block.

In embodiments of the disclosure, the size parameter of the current block can include the height and the width of the current block, and in this case, the encoder can determine, according to the height and the width of the current block, whether the GPM mode or the AWP mode is applied to the current block.

Exemplarily, in the disclosure, if the width is greater than threshold 1 and the height is greater than threshold 2, it is determined that the GPM mode or the AWP mode can be applied to the current block. As can be seen, one possible restriction is that the GPM mode or the AWP mode can be applied only if the width of the block is greater than (or greater than or equal to) threshold 1 and the height of the block is greater than (or greater than or equal to) threshold 2. The values of threshold 1 and threshold 2 can be 4, 8, 16, 32, 128, 256, etc., and threshold 1 can be equal to threshold 2.

Exemplarily, in the disclosure, if the width is less than threshold 3 and the height is greater than threshold 4, it is determined that the GPM mode or the AWP mode can be applied to the current block. As can be seen, one possible restriction is that the GPM mode or the AWP mode can be applied only if the width of the block is less than (or less than or equal to) threshold 3 and the height of the block is greater than (or greater than or equal to) threshold 4. The values of threshold 3 and threshold 4 can be 4, 8, 16, 32, 128, 256, etc., and threshold 3 can be equal to threshold 4.

Further, in embodiments of the disclosure, the size of the block to which the GPM mode or the AWP mode can be applied can also be restricted by restricting a sample parameter.

Exemplarily, in the disclosure, the encoder can firstly determine a sample parameter of the current block, and then determine, according to the sample parameter and threshold 5, whether the GPM mode or the AWP mode can be applied to the current block. As can be seen, one possible restriction is that the GPM mode or the AWP mode can be applied only if the number of samples in the block is greater than (or greater than or equal to) threshold 5, where the value of threshold 5 can be 4, 8, 16, 32, 128, 256, 1024, etc.

That is, in the disclosure, the GPM mode or the AWP mode can be applied to the current block only if the size parameter of the current block satisfies the size requirement.

Exemplarily, in the disclosure, a picture-level flag can be used to determine whether the disclosure is applied to a current picture to-be-encoded. For example, it can be configured that the disclosure is applied to an intra frame (such as I frame) but is not applied to an inter frame (such as B frame or P frame). Alternatively, it can be configured that the disclosure is applied to an inter frame but is not applied to an intra frame. Alternatively, it can be configured that the disclosure is applied to some inter frames but is not applied to other inter frames. Since intra prediction can also be applied to an inter frame, the disclosure may also be applied to an inter frame.

In some embodiments, a flag below a picture level can be used to determine whether the disclosure is applied to the current block.

S202, a candidate prediction mode list is determined.

The candidate prediction mode list includes at least one candidate prediction mode, and the at least one candidate prediction mode includes a prediction mode determined based on partitioning a template of the current block.

In some embodiments, when using a template in TIMD, the whole template including a left template and a top template is used together to derive an intra prediction mode for TIMD. If a template at a certain side does not exist, for example, in a case that the current block is located at the left boundary or the top boundary of a picture, only a template that exists can be used in TIMD. However, if templates at both sides exist, these templates will be used together. When using neighbouring reconstructed samples in DIMD, left reconstructed samples and top reconstructed samples will be used together to derive an intra prediction mode for DIMD. If there is no reconstructed sample at a certain side, for example, in a case that the current block is on the left boundary or the top boundary of the picture, only reconstructed samples that exist can be used in DIMD. However, if both left reconstructed samples and top reconstructed samples exist, these reconstructed samples will be used together. This does not matter for a non-GPM block. However, for a GPM block, a correlation between a 1^{st} prediction mode and the left and top templates or the left and top reconstructed samples is different from a correlation between a 2^{nd} prediction mode and the left and top templates or the left and top reconstructed samples. If a prediction mode is derived from the whole template, the prediction mode derived will have low accuracy, and as a result, a candidate prediction mode list thus constructed will be inaccurate. If the current block is predicted based on the candidate prediction mode list that is inaccurate, it is hard to realize accurate prediction of the current block.

In order to solve the technical problem, in embodiments of the disclosure, partitioning is performed on the template of the current block, where partitioning of the template can be understood as partitioning the template into multiple sub-templates, or partitioning a reconstructed sample area in which the template is located into multiple reconstructed sample sub-areas. In this way, by deriving the prediction mode from the template obtained by partitioning or the reconstructed sample area obtained by partitioning, it is possible to improve accuracy of prediction mode derivation, thereby improving accuracy of construction of the candidate prediction mode list. By performing prediction based on a candidate prediction mode list that is constructed accurately, it is possible to improve prediction accuracy, thereby improving encoding performance.

In embodiments of the disclosure, there is no limitation on the manner for determining the candidate prediction mode list.

In some embodiments, determination of the candidate prediction mode list does not depend on the N candidate weight derivation modes. That is, the N candidate weight derivation modes correspond to one candidate prediction mode list, which can reduce complexity of determining the candidate prediction mode list, thereby improving encoding efficiency. It should be noted that, in embodiments, since the candidate prediction mode list does not depend on the N candidate weight derivation modes, there is no restriction on the order between the foregoing S202 and S201, that is, S202 may be performed after S201, or may be performed before S201, or may be performed concurrently with S201, which is not limited in embodiments of the disclosure.

In some embodiments, S202 includes the following step S202-A.

S202-A, for each first candidate weight derivation mode in the N candidate weight derivation modes, a candidate prediction mode list corresponding to the first candidate weight derivation mode is determined.

In an example, the first candidate weight derivation mode is any one of the N candidate weight derivation modes. That is, in this example, at least one candidate prediction mode list needs to be determined for each of the N candidate weight derivation modes. It can be seen from the above that one weight derivation mode corresponds to K prediction modes, and the candidate prediction mode list is used for determining prediction modes. Therefore, in a possible implementation of this example, a candidate prediction mode list is determined for at least one prediction mode in K prediction modes corresponding to each of the N candidate weight derivation modes.

In another example, if the first candidate weight derivation mode belongs to one category of candidate weight derivation modes in the N candidate weight derivation modes, in embodiments of the disclosure, the N candidate weight derivation modes need to be classified, and at least one candidate prediction mode list is constructed for each category of candidate weight derivation modes.

Specifically, at the encoding end, angle indexes corresponding to the N candidate weight derivation modes are determined, for example, an angle index corresponding to each of the N candidate weight derivation modes is determined. For the method for determining the angle index, reference can be made to the elaborations in the foregoing embodiments, which is not described again herein. Then, at the encoding end, the N candidate weight derivation modes are classified into M categories of candidate weight derivation modes based on the angle indexes corresponding to the candidate weight derivation modes. Candidate weight derivation modes in the same category of candidate weight derivation modes correspond to the same angle index. That is, at the encoding end, based on the angle indexes corresponding to the candidate weight derivation modes, candidate weight derivation modes with the same angle index are classified into one category, thereby obtaining M categories of candidate weight derivation modes, where each category of candidate weight derivation modes at least includes one candidate weight derivation mode. Further, a j^{th} category of candidate weight derivation modes in the M categories of candidate weight derivation modes is determined as the first weight derivation mode(s), where j is a positive integer and j≤M. In this example, at least one candidate prediction mode list is determined for each category of candidate weight derivation modes in the N candidate weight derivation modes.

In embodiments of the disclosure, the manner of determining the candidate prediction mode list is the same for each first candidate weight derivation mode in the N candidate weight derivation modes. For ease of illustration, in embodiments of the disclosure, determination of a candidate prediction mode list corresponding to one first candidate weight derivation mode is taken as an example for illustration.

The manner for determining the candidate prediction mode list corresponding to the first candidate weight derivation mode in S202-A is introduced below.

In some embodiments, the first candidate weight derivation mode corresponds to one candidate prediction mode list.

In some embodiments, S202-A includes the following step S202-A1.

S202-A1, a candidate prediction mode list for at least one prediction mode in K prediction modes corresponding to the first candidate weight derivation mode is determined.

In embodiments, a candidate prediction mode list is determined for at least one prediction mode in the K prediction modes corresponding to the first candidate weight derivation mode. Assuming that K=2, optionally, one candidate prediction mode list may be determined for a 1^{st} prediction mode, but skip determining a candidate prediction mode list for a 2^{nd} candidate prediction mode; optionally, one candidate prediction mode list may be determined for the 2^{nd} prediction mode, but skip determining a candidate prediction mode list for the 1^{st} candidate prediction mode; optionally, one candidate prediction mode list may be determined for the 1^{st} prediction mode, and one candidate prediction mode list is determined for the 2^{nd} candidate prediction mode; optionally, one common candidate prediction mode list is determined for the 1^{st} prediction mode and the 2^{nd} prediction mode.

In embodiments of the disclosure, the candidate prediction mode list is determined for at least one prediction mode corresponding to the first candidate weight derivation mode, and as such, at least one prediction mode corresponding to the first candidate weight derivation mode is determined accurately from the candidate prediction mode list constructed.

In some embodiments, if the at least one prediction mode corresponds to a candidate prediction mode list, the foregoing S202-A1 includes the following steps S202-A1-11 and S202-A1-12.

S202-A1-11, a candidate prediction mode list for an I^{th} prediction mode in the at least one prediction mode is determined, where i is a positive integer.

S202-A1-12, the candidate prediction mode list for the at least one prediction mode is determined based on the candidate prediction mode list for the I^{th} prediction mode.

In the embodiments, the at least one prediction mode corresponding to the first candidate weight derivation mode corresponds to one candidate prediction mode list, that is, the at least one prediction mode corresponds to the same candidate prediction mode list, i.e. corresponds to one candidate prediction mode list. In this way, it is possible to reduce complexity of determining the candidate prediction mode list, thereby improving encoding efficiency. In this case, at the encoding end, one candidate prediction mode list is determined for the at least one prediction mode.

Specifically, the candidate prediction mode list for the I^{th} prediction mode in the at least one prediction mode is determined. Optionally, the I^{th} prediction mode is any one prediction mode in the at least one prediction mode. Then, the candidate prediction mode list for the at least one prediction mode is determined based on the candidate prediction mode list for the I^{th} prediction mode.

The manner for determining the candidate prediction mode list for the at least one prediction mode based on the candidate prediction mode list for the I^{th} prediction mode in S202-A1-12 includes, but is not limited to, the following manners.

Manner 1: the candidate prediction mode list for the I^{th} prediction mode is determined directly as the candidate prediction mode list for the at least one prediction mode.

Manner 2: whether the candidate prediction mode list for the I^{th} prediction mode includes a preset prediction mode is determined. If the candidate prediction mode list for the I^{th} prediction mode includes the preset prediction mode, the candidate prediction mode list for the I^{th} prediction mode is determined as the candidate prediction mode list for the at least one prediction mode. If the candidate prediction mode list for the I^{th} prediction mode does not include the preset prediction mode, the preset prediction mode is added to the candidate prediction mode list for the I^{th} prediction mode, to obtain the candidate prediction mode list for the at least one prediction mode.

In embodiments of the disclosure, there is no limitation on the preset prediction mode in the foregoing manner 2, and the preset prediction mode is determined according to actual needs.

The foregoing embodiments have introduced the process of determining the candidate prediction mode list for the at least one prediction mode for the case where the at least one prediction mode corresponds to one candidate prediction mode list.

In some embodiments, if each prediction mode in the at least one prediction mode corresponds to one candidate prediction mode list, the foregoing S202-A1 includes the following step S202-A1-21.

S202-A1-21, for an I^{th} prediction mode in the at least one prediction mode, a candidate prediction mode list for the I^{th} prediction mode is determined, where i is a positive integer.

In the embodiments, each prediction mode in the at least one prediction mode corresponds to one candidate prediction mode list. Therefore, at the encoding end, one candidate prediction mode list is determined for each prediction mode in the at least one prediction mode corresponding to the first candidate weight derivation mode. For example, the at least one prediction mode includes a 1^{st} prediction mode and a 2^{nd} prediction mode corresponding to the first candidate weight derivation mode, and accordingly, at the decoding end, one candidate prediction mode list is determined for the 1^{st} prediction mode and one candidate prediction mode list is determined for the 2^{nd} prediction mode.

In the embodiments, the process of determining one candidate prediction mode list corresponding to each prediction mode in the at least one prediction mode is the same. For ease of illustration, in embodiments of the disclosure, determination of the candidate prediction mode list for the I^{th} prediction mode in the at least one prediction mode is taken as an example for illustration.

The process of determining the candidate prediction mode list for the I^{th} prediction mode in S202-A1-11 and S202-A1-21 is described below.

In embodiments of the disclosure, there is no limitation on the type of a candidate prediction mode(s) in the candidate prediction mode list for the I^{th} prediction mode.

In some embodiments, the candidate prediction mode list for the I^{th} prediction mode includes at least one of: a first candidate prediction mode determined based on the template of the current block or a second candidate prediction mode determined based on gradients of reconstructed samples in the template.

Case 1: if the candidate prediction mode list for the I^{th} prediction mode includes the first candidate prediction mode, embodiments of the disclosure include the following step 31 to step 34.

Step 31, the template of the current block is partitioned into P sub-templates, where P is a positive integer and P>1.

It can be seen from the above that, the template of the current block includes the left template of the current block and the top template of the current block. Currently, the whole template of the current block is used to derive the first candidate prediction mode. For example, in TIMD, the whole template of the current block is used to derive a prediction mode, and as a result, the first candidate prediction mode thus derived is not accurate enough.

According to embodiments of the disclosure, the template of the current block is partitioned into P sub-templates, then the first candidate prediction mode is derived from the P sub-templates and/or the template of the current block, and the first candidate prediction mode is added to the candidate prediction mode list for the I^{th} prediction mode, which can improve accuracy of the candidate prediction mode list for the I^{th} prediction mode.

In embodiments of the disclosure, the manner for partitioning the template of the current block includes, but is not limited to, the following manners.

Manner 1: at the encoding end, the template of the current block is partitioned based on the first candidate weight derivation mode. Specifically, an angle index corresponding to the first candidate weight derivation mode is determined, and the template of the current block is partitioned into P sub-templates based on the angle index.

For example, as illustrated in FIG. 18, taking a weight derivation mode for GPM with an index of 2 as an example, a white area of a weight matrix for the current block means that a weight corresponding to a prediction value under a 1^{st} prediction mode is 100%, while a black area means that a weight corresponding to a prediction value under a 2^{nd} prediction mode is 100%. As illustrated in FIG. 18, the 1^{st} prediction mode is correlated with the top template of the current block, and the 2^{nd} prediction mode is correlated with the left template of the current block and part of the top template of the current block. However, currently, the whole template is used to derive a prediction mode, which results in inaccuracy of derivation of a prediction mode, thus increasing prediction error.

In order to solve the technical problem, in the disclosure, finer partitioning of the template can be realized based on a weight derivation mode. For example, as illustrated in FIG. 18, in the disclosure, the angle index corresponding to the first candidate weight derivation mode is determined, and a partition line of a weight matrix corresponding to the first candidate weight derivation mode can be determined according to the angle index. Then the partition line extends to the template region of the current block, so as to partition the template to obtain two sub-templates. For example, the two sub-templates are denoted as a first sub-template and a second sub-template, where the first sub-template corresponds to the 1^{st} prediction mode, and the second sub-template corresponds to the 2^{nd} prediction mode, i.e. the first sub-template is used for deriving a first candidate prediction mode corresponding to the 1^{st} prediction mode, and the second sub-template is used for deriving a first candidate prediction mode corresponding to the 2^{nd} prediction mode.

Manner 2: at the encoding end, the template of the current block is partitioned into P sub-templates based on the size of the current block. For example, if the size of the current block is less than a certain threshold, the template of the current block is partitioned into fewer sub-templates. If the size of the current block is greater than or equal to the threshold, the template of the current block is partitioned into more sub-templates.

Manner 3: the left template and/or the top template of the current block is partitioned to obtain the P sub-templates. For example, the left template of the current block is partitioned evenly into halves, quarters, or the like; and/or the top template of the current block is partitioned evenly into halves, quarters, or the like.

It should be noted that, at the encoding end, instead of partitioning the template of the current block into P sub-templates in the foregoing manners 1 to 3, the template can also be partitioned in other manners, which is not limited in embodiments of the disclosure.

At the encoding end, after the template of the current block is partitioned into P sub-templates, step 32 is performed.

Step 32, Q prediction templates are selected from the P sub-templates and/or the template of the current block, where Q is a positive integer and Q≤P+1.

In embodiments of the disclosure, in order to improve accuracy of the first candidate prediction mode, the template of the current block is partitioned into P sub-templates through the foregoing step 11, then the Q prediction templates are selected from the P sub-templates and/or the template of the current block, and the first candidate prediction mode is derived from the Q prediction templates, so as to realize accurate derivation of the first candidate prediction mode. Finally, the first candidate prediction mode derived is added to the candidate prediction mode list corresponding to the I^{th} prediction mode.

In embodiments of the disclosure, the prediction template may be understood as a template used to derive a prediction mode, and the prediction template may be the sub-template or the template of the current block described above.

In embodiments of the disclosure, there is no limitation on the manner for selecting the Q prediction templates from the P sub-templates and/or the template of the current block.

In some embodiments, the Q prediction templates are selected from the P sub-templates and/or the template of the current block based on a default condition. For example, the Q prediction templates are selected from the P sub-templates.

In some embodiments, the Q prediction templates are selected from the P sub-templates and/or template of the current block through the following steps 32-1 to 32-3.

Step 32-1, an angle index corresponding to the first candidate weight derivation mode is determined.

Step 32-2, an available neighbouring block(s) corresponding to the I^{th} prediction mode is determined based on the angle index.

Step 32-3, the Q prediction templates are selected from the P sub-templates and/or the template of the current block based on the available neighbouring block corresponding to the I^{th} prediction mode.

In the embodiments, it is assumed that five neighbouring blocks are available for the current block, where locations of the five neighbouring blocks are illustrated in FIG. 19. The coordinate of the top-left corner of the current block is denoted as (x0, y0), the width of the current block is denoted as width, and the height of the current block is denoted as height. The five neighbouring blocks are: neighbouring block AL determined according to coordinate (x0−1, y0−1), neighbouring block A determined according to coordinate (x0+width−1, y0−1), neighbouring block AR determined according to coordinate (x0+width, y0−1), neighbouring block L determined according to coordinate (x0−1, y0+height−1), and neighbouring block BL determined according to coordinate (x0−1, y0+height). A can be understood as a top neighbouring block of the current block, L can be understood as a left neighbouring block of the current block, AR can be understood as a top-right neighbouring block of the current block, AL can be understood as a top-left neighbouring block of the current block, BL can be understood as a bottom-left neighbouring block of the current block.

In an example, a correspondence between angle indexes, first parts (the 1^{st} prediction mode), second parts (the 2^{nd} prediction mode), and neighbouring blocks is illustrated in Table 5. In the embodiments, at the encoding end, the angle index corresponding to the first candidate weight derivation mode is determined, a range of the available neighbouring block corresponding to the I^{th} prediction mode is determined based on the angle index, and then the Q prediction templates are selected from the P sub-templates and/or the template of the current block based on the available neighbouring block corresponding to the I^{th} prediction mode, and as such, the Q prediction templates selected are correlated with the I^{th} prediction mode. In this way, a first candidate prediction mode corresponding to the I^{th} prediction mode can be accurately determined based on the Q prediction templates correlated with the I^{th} prediction mode.

Exemplarily, if the I^{th} prediction mode is a 1^{st} prediction mode corresponding to the first candidate weight derivation mode, the available neighbouring block corresponding to the I^{th} prediction mode is determined from neighbouring blocks corresponding to the first part. For example, if the angle index corresponding to the first candidate weight derivation mode is 2, it can be determined according to Table 5 that the available neighbouring block corresponding to the I^{th} prediction mode is A.

Exemplarily, if the I^{th} prediction mode is a 2^{nd} prediction mode corresponding to the first candidate weight derivation mode, the available neighbouring block corresponding to the I^{th} prediction mode is determined from neighbouring blocks corresponding to the second part. For example, if the angle index corresponding to the first candidate weight derivation mode is 2, it can be determined according to Table 5 that the available neighbouring block corresponding to the I^{th} prediction mode is L+A.

Then, the Q prediction templates are selected from the P sub-templates and/or the template of the current block based on the available neighbouring block corresponding to the I^{th} prediction mode.

Example 1, if the available neighbouring block corresponding to the I^{th} prediction mode includes the top neighbouring block of the current block, a sub-template(s) at the top of the current block in the P sub-templates is determined as a prediction template(s) in the Q prediction templates.

In a possible implementation, in this example, each sub-template at the top of the current block in the P sub-templates can be determined as one of the Q prediction templates.

In a possible implementation, in this example, sub-templates at the top of the current block in the P sub-templates can be merged into one or more prediction templates in the Q prediction templates. For example, the sub-templates at the top of the current block in the P sub-templates are: sub-template a, sub-template b, and sub-template c. Sub-template a, sub-template b, and sub-template c are merged into one prediction template. Alternatively, any two of sub-template a, sub-template b, and sub-template c are merged into one prediction template, and the remaining one sub-template is separately taken as one prediction template.

Example 2, if the available neighbouring block corresponding to the I^{th} prediction mode includes the left neighbouring block of the current block, a sub-template(s) at the left of the current block in the P sub-templates is determined as a prediction template(s) in the Q prediction templates.

In a possible implementation, in this example, each sub-template at the left of the current block in the P sub-templates can be determined as one of the Q prediction templates.

In a possible implementation, in this example, sub-templates at the left of the current block in the P sub-templates can be merged into one or more prediction templates in the Q prediction templates. For example, the sub-templates at the left of the current block in the P sub-templates are: sub-template a, sub-template b, and sub-template c. Sub-template a, sub-template b, and sub-template c are merged into one prediction template. Alternatively, any two of sub-template a, sub-template b, and sub-template c are merged into one prediction template, and the remaining one sub-template is separately taken as one prediction template.

Example 3, if the available neighbouring block corresponding to the I^{th} prediction mode includes the left neighbouring block and the top neighbouring block of the current block, at least one of a sub-template(s) at the left of the current block in the P sub-templates, a sub-template(s) at the top of the current block in the P sub-templates, or the template of the current block is determined as a prediction template(s) in the Q prediction templates.

For example, if the available neighbouring block corresponding to the I^{th} prediction mode includes the left neighbouring block and the top neighbouring block of the current block, the sub-template at the left of the current block in the P sub-templates is determined as a prediction template in the Q prediction templates.

For another example, if the available neighbouring block corresponding to the I^{th} prediction mode includes the left neighbouring block and the top neighbouring block of the current block, the sub-template at the top of the current block in the P sub-templates is determined as a prediction template in the Q prediction templates.

For another example, if the available neighbouring block corresponding to the I^{th} prediction mode includes the left neighbouring block and the top neighbouring block of the current block, the template of the current block is determined as a prediction template in the Q prediction templates.

For another example, if the available neighbouring block corresponding to the I^{th} prediction mode includes the left neighbouring block and the top neighbouring block of the current block, the sub-template at the left of the current block in the P sub-templates, the sub-template at the top of the current block in the P sub-templates, and the template of the current block are determined as prediction templates in the Q prediction templates.

For another example, if the available neighbouring block corresponding to the I^{th} prediction mode includes the left neighbouring block and the top neighbouring block of the current block, at least one sub-template at the left of the current block in the P sub-templates and the template of the current block are determined as prediction templates in the Q prediction templates.

For another example, if the available neighbouring block corresponding to the I^{th} prediction mode includes the left neighbouring block and the top neighbouring block of the current block, at least one sub-template at the top of the current block in the P sub-templates and the template of the current block are determined as prediction templates in the Q prediction templates.

Since natural textures vary significantly, when reflected at a sample level, there are many positions with different degrees of gradual transition. For example, although a certain part does not neighbour the left or the top, since the texture is gradual, it may be difficult to distinguish the strength of correlation within a small range, especially for a small block. For a large block, it is easier to distinguish the strength of correlation if the distance is long.

To this end, step 32 includes the following. The Q prediction templates are selected from the P sub-templates and/or the template of the current block based on the size of the current block.

The size of the current block includes, but is not limited to, the width or the height of the block, the number of samples in the block, or the like.

In an example, if the size of the current block is less than or equal to a second threshold, the P sub-templates and the template of the current block are determined as prediction templates in the Q prediction templates. That is, if the size of the current block is less than or equal to the second threshold, instead of distinguishing prediction modes derived from the sub-templates and the whole template, these prediction modes are used directly as the first candidate prediction modes and added to the candidate prediction mode list corresponding to the I^{th} prediction mode.

In another example, if the size of the current block is less than or equal to a second threshold, the template of the current block is determined as a prediction template in the Q prediction templates. In this example, if the size of the current block is less than or equal to the second threshold, it is difficult to distinguish the strength of correlation. Therefore, a prediction mode derived from the template of the current block is determined directly as the first candidate prediction mode, and is added to the candidate prediction mode list corresponding to the I^{th} prediction mode.

In some embodiments, if the size of the current block is greater than a first threshold, the foregoing steps 32-1 to 32-3 are performed, that is, if the size of the current block is greater than the first threshold, step 32-1 is performed to determine the angle index corresponding to the first candidate weight derivation mode.

In embodiments of the disclosure, there is no limitation on the values of the first threshold and the second threshold.

Exemplarily, the first threshold is equal to the second threshold.

Optionally, if the size of the current block includes the width or the height of the current block, the first threshold and the second threshold may be 8, 16, 32, or the like.

Optionally, if the size of the current block includes the number of samples in the current block, the first threshold and the second threshold may be 64, 128, 256, 512, or the like.

In an example, the first threshold and the second threshold are default values.

In an example, the first threshold and the second threshold may also be derived from a high-level flag. For example, a flag of an SPS is set to indicate the first threshold and the second threshold.

At the encoding end, after selecting the Q prediction templates from the P sub-templates and/or the template of the current block through the foregoing steps, step 33 is performed.

Step 33, prediction modes derived from the Q prediction templates are determined.

At the encoding end, after selecting the Q prediction templates from the P sub-templates and/or the template of the current block through the foregoing steps, the Q prediction templates are used to derive prediction modes.

In an example, for each of the Q prediction templates, one prediction mode is derived from the prediction template, thereby deriving Q prediction modes.

In some embodiments, the manner for determining the prediction modes derived from the Q prediction templates may be as follows. For any one prediction template of the Q prediction templates, R alternative prediction modes are determined, where the R alternative prediction modes may be all prediction modes that are available, or may be several preset prediction modes, or may be several prediction modes corresponding to the prediction template, which is not limited in embodiments of the disclosure. Then, first costs when predicting the prediction template by applying the R alternative prediction modes respectively are determined. Since the prediction template is already reconstructed, for each of the R alternative prediction modes, the prediction template is predicted by applying the alternative prediction mode, to obtain a prediction value of the prediction template in the alternative prediction mode. For each alternative prediction mode, a first cost corresponding to the alternative prediction mode is obtained based on the prediction value and a reconstructed value in the alternative prediction mode. Optionally, the first cost may be an approximate cost such as a sum of absolute difference (SAD) or a sum of absolute transformed difference (SATD). Finally, a prediction mode derived from the prediction template is obtained based on the first costs corresponding to the R alternative prediction modes. For example, an alternative prediction mode corresponding to the minimum first cost among the R alternative prediction modes is determined as the prediction mode derived from the prediction template.

At the encoding end, after determining the prediction modes derived from the Q prediction templates through the foregoing steps, the following step 34 is performed.

Step 34, at least one prediction mode in the prediction modes derived from the Q prediction templates is determined as the first candidate prediction mode.

As can be seen from the foregoing illustration, the prediction modes derived from the Q prediction templates correspond to first costs. In some embodiments, at least one prediction mode can be selected from the prediction modes derived from the Q prediction templates based on the first costs and determined as the first candidate prediction mode.

For example, one or more prediction modes with the minimum first cost(s) among the prediction modes derived from the Q prediction templates are determined as the first candidate prediction mode(s).

In some embodiments, the prediction modes derived from the Q prediction templates are not filtered. Instead, the prediction modes derived from the Q prediction templates are determined directly as the first candidate prediction modes.

After the first candidate prediction mode is determined through the foregoing steps, the first candidate prediction mode thus determined is added to the candidate prediction mode list corresponding to the I^{th} prediction mode.

As can be seen, in embodiments of the disclosure, when determining the first candidate prediction mode, the template of the current block is partitioned into P sub-templates, and the first candidate prediction mode is derived from the P sub-templates and/or the template of the current block, which can improve accuracy of deriving the first candidate prediction mode, thereby improving quality of the candidate prediction mode list corresponding to the I^{th} prediction mode.

The above has introduced the process of determining the first candidate prediction mode if the candidate prediction mode list for the I^{th} prediction mode includes the first candidate prediction mode in the foregoing case 1.

The following will introduce the process of determining the second candidate prediction mode if the candidate prediction mode list for the I^{th} prediction mode includes the second candidate prediction mode in case 2.

Case 2: if the candidate prediction mode list for the I^{th} prediction mode includes the second candidate prediction mode, embodiments of the disclosure include the following steps 41 to 44.

Step 41: a reconstructed sample area in which template of the current block is located is partitioned into S reconstructed sample sub-areas, where S is a positive integer.

In embodiments of the disclosure, the reconstructed sample area in which the template of the current block is located includes a left neighbouring reconstructed sample area of the current block and a top neighbouring reconstructed sample area of the current block. Currently, the whole reconstructed sample area in which the template of the current block is located is used to derive the second candidate prediction mode. For example, in DIMD, the second candidate prediction mode derived from the whole reconstructed sample area in which the template of the current block is located is not accurate enough.

For ease of illustration, the reconstructed sample area in which the template of the current block is located is referred to as a reconstructed sample area.

According to embodiments of the disclosure, the reconstructed sample area in which the template of the current block is located is partitioned into S reconstructed sample sub-areas, then the second candidate prediction mode is derived from the S reconstructed sample sub-areas and/or the reconstructed sample area, and the second candidate prediction mode is added to the candidate prediction mode list for the I^{th} prediction mode, which can improve accuracy of the candidate prediction mode list for the I^{th} prediction mode.

In embodiments of the disclosure, the manner for partitioning the reconstructed sample area in which the template of the current block is located includes, but is not limited to, the following manners.

Manner 1: at the encoding end, the template of the current block is partitioned based on the first candidate weight derivation mode. Specifically, an angle index corresponding to the first candidate weight derivation mode is determined, and the reconstructed sample area in which the template of the current block is located is partitioned into S reconstructed sample sub-areas based on the angle index.

For example, as illustrated in FIG. 20, taking a weight derivation mode for GPM with an index of 2 as an example, a white area of a weight matrix for the current block means that a weight corresponding to a prediction value of a 1^{st} prediction mode is 100%, while a black area means that a weight corresponding to a prediction value of a 2^{nd} prediction mode is 100%. As illustrated in FIG. 20, the 1^{st} prediction mode is correlated with the top reconstructed sample area of the current block, and the 2^{nd} prediction mode is correlated with the left reconstructed sample area and part of the top reconstructed sample area of the current block. However, currently, the whole reconstructed sample area is used to derive a prediction mode, which results in inaccuracy of derivation of a prediction mode, thus increasing prediction error.

In order to solve the technical problem, in the disclosure, finer partitioning of the reconstructed sample area in which the template is located can be realized based on a weight derivation mode. For example, as illustrated in FIG. 19, in the disclosure, the angle index corresponding to the first candidate weight derivation mode is determined, and a partition line of a weight matrix corresponding to the first candidate weight derivation mode can be determined according to the angle index. Then, the partition line extends to the reconstructed sample area in which the template of the current block is located, so as to partition the reconstructed sample area to obtain two reconstructed sample sub-areas. For example, the two reconstructed sample sub-areas are denoted as a first reconstructed sample sub-area and a second reconstructed sample sub-area, where the first reconstructed sample sub-area corresponds to the 1^{st} prediction mode, and the second reconstructed sample sub-area corresponds to the 2^{nd} prediction mode, i.e. the first reconstructed sample sub-area is used for deriving a second candidate prediction mode corresponding to the 1^{st} prediction mode, and the second reconstructed sample sub-area is used for deriving a second candidate prediction mode corresponding to the 2^{nd} prediction mode.

Manner 2: at the encoding end, the reconstructed sample area in which the template of the current block is located is partitioned into S reconstructed sample sub-areas based on the size of the current block. For example, if the size of the current block is less than a certain threshold, the reconstructed sample area in which the template of the current block is located is partitioned into fewer reconstructed sample sub-areas. If the size of the current block is greater than or equal to the threshold, the reconstructed sample area in which the template of the current block is located is partitioned into more reconstructed sample sub-areas.

The size of the current block includes the width or the height of the current block or the number of samples in the current block.

Manner 3: the left neighbouring reconstructed sample area and/or the top neighbouring reconstructed sample area of the current block is partitioned to obtain the S reconstructed sample sub-areas. For example, the left neighbouring sample area of the current block is partitioned evenly into halves, quarters, or the like; and/or the top neighbouring reconstructed sample area of the current block is partitioned evenly into halves, quarters, or the like.

It should be noted that, at the encoding end, instead of partitioning the reconstructed sample area in which the template of the current block is located into S reconstructed sample sub-areas in the foregoing manner 1 to manner 3, partitioning can also be performed in other manners, which is not limited in embodiments of the disclosure.

At the encoding end, after the reconstructed sample area in which the template of the current block is located is partitioned into S reconstructed sample sub-areas, the following step 42 is performed.

Step 42, G reconstructed sample prediction areas are selected from the S reconstructed sample sub-areas and/or the reconstructed sample area in which the template of the current block is located, where G is a positive integer and G≤S+1.

In embodiments of the disclosure, in order to improve accuracy of the second candidate prediction mode, the reconstructed sample area in which the template of the current block is located is partitioned into S reconstructed sample sub-areas through the foregoing step 21, then the G reconstructed sample prediction areas are selected from the S reconstructed sample sub-areas and/or the reconstructed sample area in which the template of the current block is located, and the second candidate prediction mode is derived from the G reconstructed sample prediction areas, so as to realize accurate derivation of the second candidate prediction mode. Finally, the second candidate prediction mode derived is added to the candidate prediction mode list corresponding to the I^{th} prediction mode.

In embodiments of the disclosure, the reconstructed sample prediction area may be understood as a reconstructed sample area used to derive a prediction mode, and the reconstructed sample prediction area may be the reconstructed sample sub-area or the reconstructed sample area in which the template of the current block is located.

In embodiments of the disclosure, there is no limitation on the manner for selecting the G reconstructed sample prediction areas from the S reconstructed sample sub-areas and/or the reconstructed sample area in which the template of the current block is located.

In some embodiments, based on a default condition, the G reconstructed sample prediction areas are selected from the S reconstructed sample sub-areas and/or the reconstructed sample area in which the template of the current block is located. For example, the G reconstructed sample prediction areas are selected from the S reconstructed sample sub-areas.

In some embodiments, the G reconstructed sample prediction areas are selected from the S reconstructed sample sub-areas and/or the reconstructed sample area in which the template of the current block is located through steps 42-1 to 42-3 below.

Step 42-1, an angle index corresponding to the first candidate weight derivation mode is determined.

Step 42-2, an available neighbouring block(s) corresponding to the I^{th} prediction mode is determined based on the angle index.

Step 42-3, based on the available neighbouring block corresponding to the I^{th} prediction mode, the G reconstructed sample prediction areas are selected from the S reconstructed sample sub-areas and/or the reconstructed sample area in which the template of the current block is located.

In the embodiments, it is assumed that five neighbouring blocks are available for current block, where locations of the five neighbouring blocks are illustrated in FIG. 19.

In an example, a correspondence between angle indexes, first parts (the 1^{st} prediction mode), second parts (the 2^{nd} prediction mode), and neighbouring blocks is illustrated in Table 5.

In the embodiments, at the encoding end, the angle index corresponding to the first candidate weight derivation mode is determined, the available neighbouring block corresponding to the I^{th} prediction mode is determined based on the angle index, and then based on the available neighbouring block corresponding to the I^{th} prediction mode, the G reconstructed sample prediction areas are selected from the S reconstructed sample sub-areas and/or the reconstructed sample area in which the template of the current block is located, so that the G reconstructed sample prediction areas selected are correlated with the I^{th} prediction mode. In this way, a second candidate prediction mode corresponding to the I^{th} prediction mode can be accurately determined based on the G reconstructed sample prediction areas correlated with the I^{th} prediction mode.

Exemplarily, if the I^{th} prediction mode is a 1^{st} prediction mode corresponding to the first candidate weight derivation mode, the available neighbouring block corresponding to the I^{th} prediction mode is determined from neighbouring blocks corresponding to the first part. For example, if the angle index corresponding to the first candidate weight derivation mode is 2, it can be determined according to Table 5 that the available neighbouring block corresponding to the I^{th} prediction mode is A.

Exemplarily, if the I^{th} prediction mode is a 2^{nd} prediction mode corresponding to the first candidate weight derivation mode, the available neighbouring block corresponding to the I^{th} prediction mode is determined from neighbouring blocks corresponding to the second part. For example, if the angle index corresponding to the first candidate weight derivation mode is 2, it can be determined according to Table 5 that the available neighbouring block corresponding to the I^{th} prediction mode is L+A.

Then, based on the available neighbouring block corresponding to the I^{th} prediction mode, the G reconstructed sample prediction areas are selected from the S reconstructed sample sub-areas and/or the reconstructed sample area in which the template of the current block is located.

Example 1, if the available neighbouring block corresponding to the I^{th} prediction mode includes the top neighbouring block of the current block, a reconstructed sample sub-area(s) at the top of the current block in the S reconstructed sample sub-areas is determined as a reconstructed sample prediction area(s) in the G reconstructed sample prediction areas.

In a possible implementation, in this example, each reconstructed sample sub-area at the top of the current block in the S reconstructed sample sub-areas can be determined as one of the G reconstructed sample prediction areas.

In a possible implementation, in this example, reconstructed sample sub-areas at the top of the current block in the S reconstructed sample sub-areas can be merged into one or more reconstructed sample prediction areas in the G reconstructed sample prediction areas. For example, the reconstructed sample sub-areas at the top of the current block in the S reconstructed sample sub-areas are: reconstructed sample sub-area a, reconstructed sample sub-area b, and reconstructed sample sub-area c. Reconstructed sample sub-area a, reconstructed sample sub-area b, and reconstructed sample sub-area c may be merged into one reconstructed sample prediction area. Alternatively, any two of reconstructed sample sub-area a, reconstructed sample sub-area b, and reconstructed sample sub-area c are merged into one reconstructed sample prediction area, and the remaining one reconstructed sample sub-area is separately taken as one reconstructed sample prediction area.

Example 2, if the available neighbouring block corresponding to the I^{th} prediction mode includes the left neighbouring block of the current block, a reconstructed sample sub-area(s) at the left of the current block in the S reconstructed sample sub-areas is determined as a reconstructed sample prediction area(s) in the G reconstructed sample prediction areas.

In a possible implementation, in this example, each reconstructed sample sub-area at the left of the current block in the S reconstructed sample sub-areas can be determined as one of the G reconstructed sample prediction areas.

In a possible implementation, in this example, reconstructed sample sub-areas at the left of the current block in the S reconstructed sample sub-areas can be merged into one or more reconstructed sample prediction areas in the G reconstructed sample prediction areas. For example, the reconstructed sample sub-areas at the left of the current block in the S reconstructed sample sub-areas are: reconstructed sample sub-area a, reconstructed sample sub-area b, and reconstructed sample sub-area c. Reconstructed sample sub-area a, reconstructed sample sub-area b, and reconstructed sample sub-area c may be merged into one reconstructed sample prediction area. Alternatively, any two of reconstructed sample sub-area a, reconstructed sample sub-area b, and reconstructed sample sub-area c are merged into one reconstructed sample prediction area, and the remaining one reconstructed sample sub-area is separately taken as one reconstructed sample prediction area.

Example 3, if the available neighbouring block corresponding to the I^{th} prediction mode includes the left neighbouring block and the top neighbouring block of the current block, at least one of a reconstructed sample sub-area(s) at the left of the current block in the S reconstructed sample sub-areas, a reconstructed sample sub-area(s) at the top of the current block in the S reconstructed sample sub-areas, or the reconstructed sample area in which the template of the current block is located is determined as a reconstructed sample prediction area(s) in the G reconstructed sample prediction areas.

For example, if the available neighbouring block corresponding to the I^{th} prediction mode includes the left neighbouring block and the top neighbouring block of the current block, the reconstructed sample sub-area at the left of the current block in the S reconstructed sample sub-areas is determined as a reconstructed sample prediction area in the G reconstructed sample prediction areas.

For another example, if the available neighbouring block corresponding to the I^{th} prediction mode includes the left neighbouring block and the top neighbouring block of the current block, the reconstructed sample sub-area at the top of the current block in the S reconstructed sample sub-areas is determined as a reconstructed sample prediction area in the G reconstructed sample prediction areas.

For another example, if the available neighbouring block corresponding to the I^{th} prediction mode includes the left neighbouring block and the top neighbouring block of the current block, the reconstructed sample area in which the template of the current block is located is determined as a reconstructed sample prediction area in the G reconstructed sample prediction areas.

For another example, if the available neighbouring block corresponding to the I^{th} prediction mode includes the left neighbouring block and the top neighbouring block of the current block, the reconstructed sample sub-area at the left of the current block in the S reconstructed sample sub-areas, the reconstructed sample sub-area at the top of the current block in the S reconstructed sample sub-areas, and the reconstructed sample area in which the template of the current block is located are determined as reconstructed sample prediction areas in the G reconstructed sample prediction areas.

For another example, if the available neighbouring block corresponding to the I^{th} prediction mode includes the left neighbouring block and the top neighbouring block of the current block, at least one reconstructed sample sub-area at the left of the current block in the S reconstructed sample sub-areas and the reconstructed sample area in which the template of the current block is located are determined as reconstructed sample prediction areas in the G reconstructed sample prediction areas.

For another example, if the available neighbouring block corresponding to the I^{th} prediction mode includes the left neighbouring block and the top neighbouring block of the current block, at least one reconstructed sample sub-area at the top of the current block in the S reconstructed sample sub-areas and the reconstructed sample area in which the template of the current block is located are determined as reconstructed sample prediction areas in the G reconstructed sample prediction areas.

Since natural textures vary significantly, when reflected at a sample level, there are many positions with different degrees of gradual transition. For example, although a certain part does not neighbour the left or the top, since the texture is gradual, it may be difficult to distinguish the strength of correlation within a small range, especially for a small block. For a large block, it is easier to distinguish the strength of correlation if the distance is long.

To this end, step 42 includes the following. The G reconstructed sample prediction areas are selected from the S reconstructed sample sub-areas and/or the reconstructed sample area based on the size of the current block.

The size of the current block includes, but is not limited to, the width or the height of the block, the number of samples in the block, or the like.

In an example, if the size of the current block is less than or equal to a fourth threshold, the S reconstructed sample sub-areas and the reconstructed sample area in which the template of the current block is located are determined as reconstructed sample prediction areas in the G reconstructed sample prediction areas. That is, if the size of the current block is less than or equal to the fourth threshold, instead of distinguishing prediction modes derived from the reconstructed sample sub-areas and the reconstructed sample area in which the whole template is located, these prediction modes are used directly as the second candidate prediction modes and added to the candidate prediction mode list corresponding to the I^{th} prediction mode.

In another example, if the size of the current block is less than or equal to a fourth threshold, the template of the current block is determined as a reconstructed sample prediction area in the G reconstructed sample prediction areas. In this example, if the size of the current block is less than or equal to the fourth threshold, it is difficult to distinguish the strength of the correlation. Therefore, a prediction mode derived from the reconstructed sample area in which the template of the current block is located is determined directly as the second candidate prediction mode and added to the candidate prediction mode list corresponding to the I^{th} prediction mode.

In some embodiments, if the size of the current block is greater than a third threshold, steps 42-1 to 42-3 are performed, that is, if the size of the current block is greater than the third threshold, step 42-1 is performed to determine the angle index corresponding to the first candidate weight derivation mode.

The values of the third threshold and the fourth threshold are not limited in embodiments of the disclosure.

Exemplarily, the third threshold is equal to the fourth threshold.

At the encoding end, after the G reconstructed sample prediction areas are selected from the S reconstructed sample sub-areas and/or the reconstructed sample area in which the template of the current block is located based on the foregoing steps, the following step 43 is performed.

Step 43, prediction modes derived from the G reconstructed sample prediction areas are determined.

At the encoding end, after the G reconstructed sample prediction areas are selected from the S reconstructed sample sub-areas and/or the reconstructed sample area in which the template of the current block is located through the foregoing steps, the G reconstructed sample prediction areas are used to derive prediction modes.

In an example, for each of the G reconstructed sample prediction areas, one prediction mode is derived from the reconstructed sample prediction area, thereby deriving G prediction modes.

In some embodiments, the manner for determining the prediction modes derived from the G reconstructed sample prediction areas may be as follows. For any one reconstructed sample prediction area in the G reconstructed sample prediction areas, gradients of center samples of the reconstructed sample prediction area are determined. A prediction mode derived from the reconstructed sample prediction area is determined based on the gradients of the center samples of the reconstructed sample prediction area.

At the encoding end, after determining the prediction modes derived from the G reconstructed sample prediction areas through the foregoing steps, step 44 is performed.

Step 44, at least one prediction mode in the prediction modes derived from the G reconstructed sample prediction areas is determined as the second candidate prediction mode.

In some embodiments, as can be seen from the foregoing illustration, the prediction modes derived from the G reconstructed sample prediction areas correspond to first costs, and at least one prediction mode can be selected from the prediction modes derived from the G reconstructed sample prediction areas based on the first costs and determined as the second candidate prediction mode.

For example, one or more prediction modes with the minimum first cost among the prediction modes derived from the G reconstructed sample prediction areas are determined as the second candidate prediction mode.

In some embodiments, instead of selecting from the prediction modes derived from the G reconstructed sample prediction areas, the prediction modes derived from the G reconstructed sample prediction areas are determined directly as the second candidate prediction mode.

After the second candidate prediction mode is determined through the foregoing steps, the second candidate prediction mode determined is added to the candidate prediction mode list corresponding to the I^{th} prediction mode.

As can be seen, in embodiments of the disclosure, when determining the second candidate prediction mode, the template of the current block is partitioned into S reconstructed sample sub-areas, and the second candidate prediction mode is derived from the S reconstructed sample sub-areas and/or the template of the current block, which can improve accuracy of deriving the second candidate prediction mode, thereby improving quality of the candidate prediction mode list corresponding to the I^{th} prediction mode.

The above has introduced the process of determining the second candidate prediction mode if the candidate prediction mode list for the I^{th} prediction mode includes the second candidate prediction mode in the foregoing case 2.

In some embodiments, the candidate prediction mode list for the I^{th} prediction mode further includes at least one of: a third candidate prediction mode corresponding to the first candidate weight derivation mode, a prediction mode for a neighbouring block of the current block, or a preset prediction mode.

In embodiments of the disclosure, the third candidate prediction mode corresponding to the first candidate weight derivation mode may be understood as a third candidate prediction mode determined based on the first candidate weight derivation mode. In embodiments of the disclosure, there is no limitation on the type of the third candidate prediction mode corresponding to the first candidate weight derivation mode.

In an example, the third candidate prediction mode corresponding to the first candidate weight derivation mode includes a prediction mode with a prediction angle parallel to a partition line (or a weight boundary line) of the first candidate weight derivation mode. Exemplarily, as illustrated in FIG. 21A, assuming that the partition line of the first candidate weight derivation mode is marked by a diagonal line in the figure, at least one prediction mode with a prediction angle parallel to the partition line is determined as the third candidate prediction mode corresponding to the first candidate weight derivation mode.

In another example, the third candidate prediction mode corresponding to the first candidate weight derivation mode includes a prediction mode with a prediction angle perpendicular to a partition line (or a weight boundary line) of the first candidate weight derivation mode. Exemplarily, as illustrated in FIG. 21B, assuming that the partition line of the first candidate weight derivation mode is marked by a diagonal line in the figure, at least one prediction mode with a prediction angle is perpendicular to the partition line is determined as the third candidate prediction mode corresponding to the first candidate weight derivation mode.

In some embodiments, in order to accelerate determination of the third candidate prediction mode, a look-up table is constructed for angle indexes angleIdx and corresponding intra prediction modes. In this way, at the encoding end, the angle index of the first candidate weight derivation mode can be calculated, and an intra prediction mode with a prediction angle parallel to the partition line of the first candidate weight derivation mode can be obtained from the look-up table according to the angle index of the first candidate weight derivation mode. Optionally, an intra prediction mode with a prediction angle perpendicular to the partition line of the first candidate weight derivation mode can be calculated according to the intra prediction mode with the prediction angle parallel to the partition line of the first candidate weight derivation mode.

In some embodiments, when applying an intra prediction mode for the neighbouring block, intra prediction modes for at most five neighbouring blocks are applicable, where locations of the five neighbouring blocks are illustrated in FIG. 19. The coordinate of the top-left corner of the current block is denoted as (x0, y0), the width of the current block is denoted as width, and the height of the current block is denoted as height. The five neighbouring blocks are: neighbouring block AL determined according to coordinate (x0−1, y0−1), neighbouring block A determined according to coordinate (x0+width−1, y0−1), neighbouring block AR determined according to coordinate (x0+width, y0−1), neighbouring block L determined according to coordinate (x0−1, y0+height−1), and neighbouring block BL determined according to coordinate (x0−1, y0+height). According to whether the I^{th} prediction mode corresponds to the first part or the second part and the angle index angleIdx corresponding to the first candidate weight derivation mode, a range of the available neighbouring blocks is determined from the foregoing Table 5, where A may be understood as the top neighbouring block of the current block, and L may be understood as the left neighbouring block of the current block. If it is determined from Table 5 that the available neighbouring block corresponding to the I^{th} prediction mode is neighbouring block A, an intra prediction mode for neighbouring block A and an intra prediction mode for neighbouring block AR are added to the candidate prediction mode list corresponding to the I^{th} prediction mode. If it is determined from Table 5 that the available neighbouring block corresponding to the I^{th} prediction mode is neighbouring block L, an intra prediction mode for neighbouring block L and an intra prediction mode for neighbouring block BL are added to the candidate prediction mode list corresponding to the I^{th} prediction mode. If it is determined from Table 5 that the available neighbouring block corresponding to the I^{th} prediction mode is neighbouring blocks L+A, an intra prediction mode for neighbouring block A, an intra prediction mode for neighbouring block AR, an intra prediction mode for neighbouring block L, and an intra prediction mode for neighbouring block BL are added to the candidate prediction mode list corresponding to the I^{th} prediction mode. It can be seen from the above that, the prediction mode for neighbouring block AL is always applicable. Optionally, the order in which the neighbouring blocks are checked is L->A->BL->AR->AL.

In embodiments of the disclosure, there is no limitation on the type of the preset prediction mode. For example, the preset prediction mode may be at least one of: DC, a horizontal mode, a vertical mode, an angular mode, or a PLANAR mode.

In some embodiments, in order to reduce complexity of prediction, restriction is imposed on the length of the candidate prediction mode list. For example, the number of candidate prediction modes in the candidate prediction mode list for the I^{th} prediction mode is a preset number. The value of the preset number is not limited in embodiments of the disclosure, for example, the preset number is 3.

In some embodiments, according to a preset order, the preset number (such as 3) of prediction modes are selected from the first candidate prediction mode determined based on the template of the current block, the second candidate prediction mode determined based on the gradients of the reconstructed samples in the template of the current block, the prediction mode with the prediction angle parallel to the partition line of the first candidate weight derivation mode, the prediction mode with the prediction angle perpendicular to the partition line of the first candidate weight derivation mode, the prediction mode for the neighbouring block of the current block, and the PLANAR mode, to construct the candidate prediction mode list for the I^{th} prediction mode. In embodiments of the disclosure, no restriction is imposed on the preset order.

In an example, when constructing the candidate prediction mode list for the I^{th} prediction mode, the following types of prediction modes are sequentially added to the candidate prediction mode list until the length of the list reaches the preset number (such as 3):
1. The prediction mode with the prediction angle parallel to the partition line of the first candidate weight derivation mode;
2. The first candidate prediction mode determined based on the template of the current block. In some embodiments, the first candidate prediction mode is also referred to as a prediction mode derived based on TIMD;
3. The second candidate prediction mode determined based on the gradients of the reconstructed samples in the template of the current block. In some embodiments, the second candidate prediction mode is also referred to as a prediction mode derived based on DIMD;
4. The prediction mode for the neighbouring block of the current block;
5. The prediction mode with the prediction angle perpendicular to the partition line of the first candidate weight derivation mode;
6. The PLANAR mode.

The process of determining the candidate prediction mode list has been introduced in the foregoing embodiments.

At the encoding end, after determining the candidate prediction mode list through the foregoing steps, the following step S203 is performed.

S203, the first weight derivation mode and K first prediction modes are determined based on the N candidate weight derivation modes and the candidate prediction mode list.

At the encoding end, the N candidate weight derivation modes are determined through the foregoing step S201, and the candidate prediction mode list is determined through the foregoing step S202. Then one candidate weight derivation mode is selected from the N candidate weight derivation modes as the first weight derivation mode, and at least one first prediction mode in the K first prediction modes is determined from at least one candidate prediction mode in the candidate prediction mode list. Finally, the current block is predicted by applying the determined first weight derivation mode and K first prediction modes, to obtain a prediction value of the current block.

In embodiments of the disclosure, at the encoding end, there is no limitation on the manner for determining the first weight derivation mode and the K first prediction modes based on the N candidate weight derivation modes and the candidate prediction mode list.

In some embodiments, the candidate prediction mode list is a candidate prediction mode list corresponding to the K first prediction modes, that is, the K first prediction modes are all selected from the candidate prediction mode list. In this case, at the encoding end, the N candidate weight derivation modes are combined with candidate prediction modes in the candidate prediction mode list. For example, each candidate weight derivation mode in the N candidate weight derivation modes is combined with any K candidate prediction modes in the candidate prediction mode list to obtain multiple combinations, where each combination includes one candidate weight derivation mode and K candidate prediction modes. Then, for each combination, the template of the current block is predicted by applying a candidate weight derivation mode and K candidate prediction modes in the combination, and a cost of the combination is determined. Then one combination is determined from the multiple combinations based on the costs. For example, a combination with the minimum cost is selected from the multiple combinations, a candidate weight derivation mode in the combination with the minimum cost is determined as the first weight derivation mode, and K prediction modes in the combination with the minimum cost are determined as the K first prediction modes.

In some embodiments, the candidate prediction mode list is a candidate prediction mode list for a certain first prediction mode in the K first prediction modes, for example, K=2, and the candidate prediction mode list is a candidate prediction mode list for the 1^{st} prediction mode. In this case, at the encoding end, a set of optional prediction modes corresponding to the 2^{nd} prediction mode is determined. Then for each candidate weight derivation mode in the N candidate weight derivation modes, one candidate prediction mode is selected from the candidate prediction mode list for the 1^{st} prediction mode and taken as a possible choice for the 1^{st} prediction mode, and one prediction mode is selected from the set of optional prediction modes corresponding to the 2^{nd} prediction mode and taken as a possible choice for the 2^{nd} prediction mode, so as to obtain a combination of the candidate weight derivation mode, the possible choice for the 1^{st} prediction mode, and the possible choice for the 2^{nd} prediction mode. As such, multiple combinations can be obtained, where each combination includes one candidate weight derivation mode and two candidate prediction modes. Further, for each combination, the template of the current block is predicted by applying a candidate weight derivation mode and two candidate prediction modes in the combination, and a cost of the combination is determined. Then one combination is determined from the multiple combinations based on the costs. For example, a combination with the minimum cost is selected from the multiple combinations, a candidate weight derivation mode in the combination with the minimum cost is determined as the first weight derivation mode, and K prediction modes in the combination with the minimum cost is determined as the K first prediction modes.

In some embodiments, the candidate prediction mode list includes a candidate prediction mode list corresponding to each first prediction mode in the K first prediction modes, that is, at the encoding end, K candidate prediction mode lists are determined through the foregoing step S202, for example, assuming that K=2, that is, at the encoding end, a candidate prediction mode list for the 1^{st} prediction mode and a candidate prediction mode list for the 2^{nd} prediction mode are determined. In this case, at the encoding end, one candidate weight derivation mode is selected from the N candidate weight derivation modes, one candidate prediction mode is selected from the candidate prediction mode list for the 1^{st} prediction mode, and one candidate prediction mode is selected from the candidate prediction mode list for the 2^{nd} prediction mode. In this way, the selected one candidate weight derivation mode and two candidate prediction modes constitute one combination. According to the foregoing method, multiple combinations can be obtained, where each combination includes one candidate weight derivation mode and two candidate prediction modes. Then, for each combination, the template of the current block is predicted by applying a candidate weight derivation mode and two candidate prediction modes in the combination, and a cost of the combination is determined. Then, one combination is determined from the multiple combinations based on the costs. For example, a combination with the minimum cost is selected from the multiple combinations, a candidate weight derivation mode in the combination with the minimum cost is determined as the first weight derivation mode, and K prediction modes in the combination with the minimum cost are determined as the K first prediction modes.

Based on the above illustration, one weight derivation mode and K prediction modes can be applied together to the current block as a combination. In order to save codewords and reduce encoding cost, in some embodiments, a weight derivation mode and K prediction modes corresponding to the current block are used as a combination, namely a first combination, and the first combination is indicated by a first index. Compared with indicating separately the weight derivation mode and the K prediction modes, in embodiments of the disclosure, fewer codewords are required, thereby reducing encoding cost.

To this end, the above S203 includes the following steps S203-A to S203-B.

S203-A, a candidate combination list is determined based on the N candidate weight derivation modes and the candidate prediction mode list, where the candidate combination list includes at least one candidate combination, and the candidate combination includes one weight derivation mode and K prediction modes.

S203-B, based on the first index, a first combination is determined from the candidate combination list.

Exemplarily, the candidate combination list is illustrated in Table 7. As illustrated Table 7, the candidate combination list includes multiple candidate combinations, and any two candidate combinations in the multiple candidate combinations are not completely the same, i.e., any two candidate combinations differ in at least one of the weight derivation mode or the K prediction modes. For example, candidate combination 1 and candidate combination 2 have different weight derivation modes. Alternatively, candidate combination 1 and candidate combination 2 have the same weight derivation mode, but differ in at least one of the K prediction modes. Alternatively, candidate combination 1 and candidate combination 2 have different weight derivation modes, and also differ in at least one of the K prediction modes.

Exemplarily, in the foregoing Table 7, the order of a candidate combination in the candidate combination list is taken as an index of the candidate combination. Optionally, the index of the candidate combination in the candidate combination list can also be indicated in another manner, which is not limited in embodiments of the disclosure.

The following describes the specific process of determining the candidate combination list based on the N candidate weight derivation modes and the candidate prediction mode list in S203-A.

Embodiments of the present disclosure do not limit the specific manner of determining the candidate combination list based on the N candidate weight derivation modes and the candidate prediction mode list in S203-A.

In some embodiments, the N candidate weight derivation modes are arbitrarily combined with multiple candidate prediction modes included in the candidate prediction mode list, with each combination including one weight derivation mode and two prediction modes. In this way, multiple combinations can be obtained. Using information related to the current block, the probabilities of occurrence of different combinations are analysed, and the candidate combination list is constructed based on the probabilities of occurrence of respective combinations. Optionally, the information related to the current block includes mode information of neighbouring block(s) of the current block, reconstructed samples of the current block, etc.

In some embodiments, S203-A includes the following steps S203-A1 and S203-A2.

S203-A1, T second combinations are obtained based on the N candidate weight derivation modes and the candidate prediction mode list.

S203-A2, the candidate combination list is obtained based on the T second combinations.

In the above, any one of the T second combinations includes one weight derivation mode and K prediction modes, and the weight derivation mode and the K prediction modes included in any two of the T second combinations are not completely the same. Tis a positive integer greater than 1.

In this embodiment, the T second combinations are determined at the encoding end based on the N candidate weight derivation modes and the candidate prediction mode list. The present disclosure does not limit the specific number of the T second combinations, which may be such as 8, 16, 32, etc. Each of the T second combinations includes one weight derivation mode and K prediction modes, and the weight derivation mode and the K prediction modes included in any two of the T second combinations are not completely the same.

The embodiments of this disclosure do not limit the specific manner of obtaining the T second combinations based on the N candidate weight derivation modes and the candidate prediction mode list in the above S203-A1.

In some embodiments, if the candidate prediction mode list is the candidate prediction mode list corresponding to the K first prediction modes, that is, the K first prediction modes are all selected from this candidate prediction mode list, the N candidate weight derivation modes are combined with the candidate prediction modes included in the candidate prediction mode list at the encoding end. For example, each of the N candidate weight derivation modes is combined with any K candidate prediction modes in the candidate prediction mode list to obtain the T second combinations, with each second combination includes one candidate weight derivation mode and K candidate prediction modes.

In some embodiments, the candidate prediction mode list is the candidate prediction mode list for one of the K first prediction modes, for example, K=2 and the candidate prediction mode list mentioned above is the candidate prediction mode list for the first prediction mode. Then at the encoding end, a set of optional prediction modes corresponding to the second prediction mode is determined. Subsequently, for each of the N candidate weight derivation modes, at the encoding end, one candidate prediction mode is selected from the candidate prediction mode list for the first prediction mode as one possibility for the first prediction mode, and one prediction mode is selected from the set of optional prediction modes corresponding to the second prediction mode as one possibility for the second prediction mode. This results in a second combination composed of the candidate weight derivation mode, one possibility for the first prediction mode, and one possibility for the second prediction mode. In this way, T second combinations can be obtained, each of which includes one candidate weight derivation mode and two candidate prediction modes.

In some embodiments, the candidate prediction mode list includes the candidate prediction mode list corresponding to each of the K first prediction modes, that is to say, based on the step of S202, K candidate prediction mode lists are determined at the encoding end. For example, assuming K=2, at the encoding end, a candidate prediction mode list for the first prediction mode and a candidate prediction mode list for the second prediction mode are determined. In this case, one candidate weight derivation mode is selected from the N candidate weight derivation modes, one candidate prediction mode is selected from the candidate prediction mode list for the first prediction mode, and one candidate prediction mode is selected from the candidate prediction mode list for the second prediction mode at the encoding end. The selected one candidate weight derivation mode and the two candidate prediction modes form a second combination. By referring to the above method, T second combinations can be obtained, each of which includes one candidate weight derivation mode and two candidate prediction modes.

The manner for obtaining the candidate combination list based on the T second combinations in the above S203-A2 includes but is not limited to the following manners:

Manner 1: the T second combinations are sorted according to a preset rule to obtain the candidate combination list.

Manner 2: The above S203-A2 includes the following steps:

S203-A21: For any one of the T second combinations, a cost corresponding to the second combination when predicting the template of the current block using the weight derivation mode and the K prediction modes in the second combination, is determined.

S203-A22: the candidate combination list is determined based on the costs corresponding to the T second combinations.

In manner 2, for each of the T second combinations, the template of the current block is predicted using the weight derivation mode and the K prediction modes included in the second combination, to obtain a prediction value of the template corresponding to the second combination.

Specifically, for each of the T second combinations, the K prediction modes in the second combination are used to predict the template of the current block, resulting in K prediction values.

Then, based on the weight derivation mode in the second combination, a template weight corresponding to the second combination is determined.

The template weight corresponding to a second combination and K template prediction values are determined using the above method. The K template prediction values are weighted using the template weight to obtain the template prediction value under that second combination.

Since the template of the current block is a reconstructed area, the reconstructed value of the template can be obtained at the encoding end. Thus, for each of the T second combinations, the cost corresponding to the second combination can be determined based on the prediction value of the template and the reconstructed value of the template under the second combination. The method for determining the cost corresponding to the second combination includes, but is not limited to, SAD, SATD, SSE, etc. Subsequently, based on the costs corresponding to the T second combinations respectively, the candidate combination list is constructed.

In the embodiments of this disclosure, the manner for determining the prediction value of the template corresponding to the second combination includes at least the following methods.

In a first method, the prediction value of the template corresponding to the second combination is a single value. That is, at the encoding end, the K prediction modes included in the second combination are used separately to predict the template, obtaining K prediction values. The template weight is determined according to the weight derivation mode included in the second combination. The K prediction values are weighted using the template weight to obtain the weighted prediction value, which is determined as the prediction value of the template corresponding to the second combination.

In a second method, in some embodiments, a hierarchical screening idea can also be used. For example, if a weight derivation mode can achieve a relatively small cost, then weight derivation modes similar to this weight derivation mode can be tried. Conversely, if a weight derivation mode cannot achieve a relatively small cost, then similar weight derivation modes will not be tried. For example, if an intra prediction mode can achieve a relatively small cost, then similar intra prediction modes can be tried. Conversely, if an intra prediction mode cannot achieve a relatively small cost, then similar intra prediction modes will not be tried. These screening methods can also be limited to the use case of combining with other two elements. For example, under a certain weight derivation mode, if a certain intra prediction mode serving as the first prediction mode cannot achieve a relatively small cost, then under this weight derivation mode, intra prediction modes similar to this intra prediction mode will not be tried as the first prediction mode.

In a third method, a fast cost calculation method is used to determine the cost corresponding to each second combination. As mentioned above, the prediction values of the template corresponding to the second combination includes the prediction values of the template respectively corresponding to the K prediction modes included in the second combination. In this case, the costs respectively corresponding to the K prediction modes in the second combination can be determined based on the prediction values of the template and the reconstructed values of the template respectively corresponding to the K prediction modes in the second combination. The cost corresponding to the second combination is determined based on the costs respectively corresponding to the K prediction modes in the second combination. For example, the sum of the costs respectively corresponding to the K prediction modes in the second combination is determined as the cost corresponding to the second combination.

In the embodiments of this disclosure, assuming K=2, the weights on the template can be simplified to only two possibilities, 0 and 1. Therefore, for each sample position, the value comes only from the prediction block under the first prediction mode or the prediction block under the second prediction mode. Thus, for a prediction mode, the cost on the template when the prediction mode serves as the first prediction mode for a certain weight derivation mode can be calculated. That is, only the cost of the samples with weight 1 when this prediction mode serves as the first prediction mode for the weight derivation mode is calculated. For example, this cost can be denoted as cost[pred_mode_idx][gpm_idx][0], where pred_mode_idx represents the index of the prediction mode, gpm_idx represents the index of the weight derivation mode, and 0 indicates serving as the first prediction mode.

Further, the cost on the template when the prediction mode serves as the second prediction mode for the certain weight derivation mode can also be calculated. That is, only the cost of the samples with weight 1 when this prediction mode serves as the second prediction mode for this weight derivation mode is calculated. For example, this cost can be denoted as cost[pred_mode_idx][gpm_idx][1], where pred_mode_idx represents the index of the prediction mode, gpm_idx represents the index of the weight derivation mode, and 1 indicates serving as the second prediction mode.

Then, when calculating the cost of a combination, the corresponding two costs mentioned above can be directly added together. For example, to calculate the cost of prediction modes pred_mode_idx0 and pred_mode_idx1 under weight derivation mode gpm_idx, where pred_mode_idx0 is the first prediction mode and pred_mode_idx1 is the second prediction mode, denoting the cost as costTemp, then costTemp=cost[pred_mode_idx0][gpm_idx][0]+cost[pred_mode_idx1][gpm_idx][1]. For another example, to calculate the cost of prediction modes pred_mode_idx0 and pred_mode_idx1 under weight derivation mode gpm_idx, where pred_mode_idx1 is the first prediction mode and pred_mode_idx0 is the second prediction mode, denoting the cost as costTemp, then costTemp=cost[pred_mode_idx1][gpm_idx][0]+cost[pred_mode_idx0][gpm_idx][1].

One advantage of this approach is that it simplifies the process of first combining into one prediction block through weighting and then calculating the cost, to directly calculating costs of two parts and then adding the costs together to obtain the cost of the combination. Since a prediction mode may be combined with multiple other prediction modes, and for the same weight derivation mode, the costs of the parts when the prediction mode serves as the first prediction mode and the second prediction mode respectively are fixed, these costs (i.e., cost[pred_mode_idx][gpm_idx][0] and cost[pred_mode_idx][gpm_idx][1] in the above example) can be retained and reused to reduce the amount of computation.

Based on the above method, the costs respectively corresponding to the T second combinations can be determined. Subsequently, based on the costs respectively corresponding to the T second combinations, the candidate combination list can be constructed.

In the embodiments of this disclosure, the manner for determining the candidate combination list based on the costs respectively corresponding to the T second combinations in S203-A22 includes, but is not limited to, the following examples.

Example 1: the T second combinations are sorted based on the costs corresponding to the T second combinations, and the sorted T second combinations are determined as the candidate combination list.

In Example 1, the generated candidate combination list includes T first candidate combinations.

Optionally, the T first candidate combinations in the candidate combination list are sorted in ascending order of cost, that is, the costs corresponding to the T first candidate combinations in the candidate combination list increase sequentially according to the sorting order.

The sorting of the T second combinations based on the corresponding costs can be sorting the T second combinations in ascending order of cost.

Example 2: C second combinations are selected from the T second combinations based on the corresponding costs, and a list composed of the C second combinations is determined as the candidate combination list.

Optionally, the C second combinations are the top C second combinations with the smallest costs among the T second combinations. For example, the C second combinations with the smallest costs are selected from the T second combinations based on the corresponding costs to form the candidate combination list. In this case, the candidate combination list includes C candidate combinations.

Optionally, the C candidate combinations in the candidate combination list are sorted in ascending order of cost, that is, the costs corresponding to the C candidate combinations in the candidate combination list increase sequentially according to the sorting order.

At the encoding end, based on the above steps, the candidate combination list is determined.

Then the first combination is determined from the candidate combination list at the encoding end.

In embodiments of the disclosure, the manner for determining the first combination from the candidate combination list is not limited.

For example, the first combination is any one candidate combination in the candidate combination list.

For another example, the first combination is a candidate combination with the minimum cost in the candidate combination list.

In some embodiments, an index of the first combination in the candidate combination list is a first index. Then the first index is signalled into the bitstream at the encoding end, so that the decoding end can determine the first combination based on the first index.

At the encoding end, the first combination corresponding to the first index is selected from the candidate combination list, and the weight derivation mode included in the first combination is determined as the first weight derivation mode, and the K prediction modes included in the first combination are determined as the K first prediction modes.

Based on the above steps, the first weight derivation mode and the K first prediction modes are determined at the encoding end. Then the following step S204 is performed.

S204, the current block is predicted according to the first weight derivation mode and the K first prediction modes to obtain the prediction value of the current block.

In the embodiments of this disclosure, when encoding the current block, the N candidate weight derivation modes and the candidate prediction mode list are determined at the encoding end. The candidate prediction mode list includes at least one candidate prediction mode, where at least one candidate prediction mode is determined based on the partitioning of the template of the current block. That is to say, in the embodiments of this disclosure, when determining the candidate prediction mode, the prediction mode is derived through the partitioned template, which realizes the accurate derivation of the prediction mode and thereby improves the accuracy of determining the candidate prediction mode list. Subsequently, based on the N candidate weight derivation modes and the accurately determined candidate prediction mode, the first weight derivation mode and the K first prediction modes are determined, which realizes the accurate determination of the first weight derivation mode and the K first prediction modes. When predicting the current block based on the accurately determined first weight derivation mode and the K first prediction modes, the prediction accuracy can be improved, thereby enhancing the encoding performance.

The embodiments of this disclosure do not limit the specific process of predicting the current block based on the first weight derivation mode and the K first prediction modes in the above S204 to obtain the prediction value of the current block.

Case 1, when determining weights of prediction values, the weight gradient parameter (also called the blending parameter) is not considered. The weights of the prediction values of the current block are determined based on the first weight derivation mode. The current block is predicted based on the K first prediction modes to obtain K prediction values of the current block. The K prediction values of the current block are weighted using the weights of the prediction values of the current block to obtain the prediction value of the current block. For the process of deriving the weights of prediction values of the current block based on the first weight derivation mode, reference can be made to the process of deriving the weights of prediction values of the current block in the above embodiments, which will not be repeated herein.

Case 2, when determining the weights of prediction value, the weight gradient parameter is considered. The above S204 includes the following steps.

S204-A1, the weight gradient parameter is determined.

S204-A2, the current block is predicted based on the weight gradient parameter, the first weight derivation mode, and the K first prediction modes, to obtain the prediction value of the current block.

In the above Case 1, the gradient of the weights is fixed. However, in some embodiments, the variable weight gradient can adjust the gradient of weight changes, thereby allowing the GPM to obtain blending regions of different widths under the same partition line angle and partition line offset.

For example, as illustrated in FIG. 23A and FIG. 23B, FIG. 23A is a schematic diagram of the GPM blending area in VVC, and FIG. 23B is an example of the variable weight gradient of GPM.

The value of blendingCoeff can be ¼, ½, 1, 2, 4, etc.

For example, the value of blendingCoeff can be derived from the weight gradient index gpm_blending_idx.

In some embodiments, the weight gradient index is also referred to as a blending gradient parameter or blending parameter.

The embodiments of this disclosure do not limit the specific implementation process of the above S204-A2. For example, the first weight derivation mode and the K first prediction modes are used to predict the current block to obtain a prediction value, and then a prediction value of the current block is determined based on the weight gradient parameter and the prediction value.

In some embodiments, the above S204-A2 includes the following steps.

S204-A21, weights of prediction values are determined based on the weight gradient parameter and the first weight derivation mode.

S204-A22, the current block is predicted according to the K first prediction modes to obtain K prediction values.

S204-A23, the K prediction values are weighted based on the weights of the prediction values to obtain the prediction value of the current block.

There is no specific order of execution between S204-A22 and S204-A21, that is, S204-A22 can be executed before S204-A21, or after S204-A21, or in parallel with S204-A21.

In Case 2, the encoding end determines the weight gradient parameter, and determines the weights of the prediction values based on the weight gradient parameter and the first weight derivation mode. Subsequently, the current block is predicted based on the K first prediction modes to obtain K prediction values of the current block. Then, the K prediction values of the current block are weighted using the weights of the prediction values to obtain the prediction value of the current block.

In some embodiments, after the weight gradient parameter is determined at the encoding end, the second index corresponding to the weight gradient parameter is signalled into the bitstream, so that the decoding end can obtain the second index by decoding the bitstream, and the weight gradient parameter is determined based on the second index.

In some embodiments, the second index is also referred to as the weight gradient index.

In some embodiments, different weight gradient parameters have a relatively small impact on the prediction results of the template. If the simplified method is used, that is, the weights on the template are only 0 and 1, the weight gradient parameter will not affect the prediction of the template, that is, it cannot affect the candidate combination list. In this case, the blending gradient index can be placed outside the combination.

The embodiments of this disclosure do not limit the specific manner for determining the weight gradient parameter based on the second index.

In some embodiments, at the encoding end, a candidate blending parameter list is determined, which includes multiple candidate blending parameters. A candidate blending parameter corresponding to the second index in the candidate blending parameter list is determined as the weight gradient parameter.

The embodiments of this disclosure do not limit the manner for determining the candidate blending parameter list.

In an example, the candidate blending parameters in the above candidate blending parameter list are preset.

In another example, at the encoding end, based on the characteristics of the current block, at least one blending parameter is selected from preset multiple blending parameters to form the candidate blending parameter list. For example, based on image information of the current block, blending parameters that match the image information of the current block are selected from the preset multiple blending parameters to form the candidate blending parameter list.

For example, assuming that the image information includes sharpness of image edges, if the sharpness of the image edges of the current block is less than a preset value, at least one first-type weight gradient parameter, such as ¼, ½, etc., is selected from the preset multiple weight gradient parameters to form the candidate weight gradient parameter list. If the sharpness of the image edges of the current block is greater than or equal to the preset value, at least one second-type weight gradient parameter, such as 2, 4, etc., is selected from the preset multiple weight gradient parameters to form the candidate weight gradient parameter list.

In some embodiments, the weight gradient parameter is determined through the following steps S204-A11 and S204-A12.

S204-A11, multiple alternative weight gradient parameters are determined.

S204-A12, the weight gradient parameter is selected from the multiple alternative weight gradient parameters.

In this embodiment, at the encoding end, multiple alternative weight gradient parameters are determined first, and then one of these alternative weight gradient parameters is selected as the weight gradient parameter.

The embodiments of this disclosure do not limit the specific manner for the encoding end to determine the multiple alternative weight gradient parameters.

In one possible implementation, the multiple alternative weight gradient parameters are preset. That is to say, the decoding end and the encoding end agree to determine several preset weight gradient parameters as the multiple alternative weight gradient parameters.

In another possible implementation, the multiple alternative weight gradient parameters can be indicated by the encoding end. For example, the encoding end indicates that multiple weight gradient parameters from a set of preset weight gradient parameters are used as the alternative weight gradient parameters.

In another possible implementation, the multiple alternative weight gradient parameters can be determined based on the size of the current block.

In another possible implementation, the image information of the current block is determined first. Then, based on the image information, multiple alternative weight gradient parameters are selected from a set of preset alternative weight gradient parameters.

After the multiple alternative weight gradient parameters are determined at the encoding end, one of the multiple alternative weight gradient parameters is selected as the weight gradient parameter.

The embodiments of this disclosure do not limit the specific manner for selecting the weight gradient parameter from the multiple alternative weight gradient parameters.

In some embodiments, any one of the multiple alternative weight gradient parameters can be selected as the weight gradient parameter.

In some embodiments, the cost corresponding to each of the multiple alternative weight gradient parameters is determined. Then, based on the costs, the weight gradient parameter is determined from the multiple alternative weight gradient parameters. For example, the weight gradient parameter with the smallest cost can be determined as the gradient parameter corresponding to the current block.

In some embodiments, the weight gradient parameter is determined based on the size of the current block.

As mentioned above, there is a certain correlation between the weight gradient parameter and the block size. Therefore, in the embodiments of this disclosure, the weight gradient parameter can also be determined based on the size of the current block.

In one possible implementation, a fixed weight gradient parameter is determined as the weight gradient parameter based on the size of the current block.

For example, if the size of the current block is less than a first predetermined threshold, then the weight gradient parameter is determined as a first value.

For another example, if the size of the current block is greater than or equal to the first predetermined threshold, then the weight gradient parameter is determined as a second value, where the second value is less than the first value.

The embodiments of this disclosure do not limit the specific values of the above-mentioned first value, second value, and first predetermined threshold.

For example, the first value is 1, and the second value is ½.

For example, if the size of the current block is represented by the number of samples (or pixel points) in the current block, then the first predetermined threshold can be 256, etc.

In another possible implementation, a value range of the weight gradient parameter is determined based on the size of the current block, and then the weight gradient parameter is determined as a value within this range.

For example, if the size of the current block is less than a first predetermined threshold, then the weight gradient parameter is determined to be within a certain range of weight gradient parameter. For instance, the weight gradient parameter can be the minimum, maximum, or any intermediate value within this range of weight gradient parameter. Alternatively, the weight gradient parameter can be the one with the smallest cost within this range of weight gradient parameter. The manner for determining the cost of the weight gradient parameter can refer to the descriptions in other embodiments of this disclosure, which will not be repeated here.

For another example, if the size of the current block is greater than or equal to the first predetermined threshold, then the weight gradient parameter is determined to be within a second range of weight gradient parameter. For instance, the weight gradient parameter can be the minimum, maximum, or any intermediate value within the second range of weight gradient parameter. Alternatively, the weight gradient parameter can be the one with the smallest cost within the second range of weight gradient parameter. The minimum value of the second range is less than the minimum value of the first range, and the two ranges can either intersect or be disjoint, which is not limited in the embodiments of this disclosure.

After determining the weight gradient parameter according to the above steps in case 2, the step S204-A21 is executed to determine the weight of the prediction value based on the weight gradient parameter and the first weight derivation mode.

Subsequently, the current block is predicted using the K first prediction modes to obtain K prediction values. The K prediction values are weighted using the weights of the prediction values to obtain the prediction value of the current block.

The above example can be understood as two independent processes for the template weight and the weight of the prediction value, which do not interfere with each other. Through the above method, the weight of the prediction value can be determined separately.

In some embodiments, considering the combined area that is composed of the template area and the current block, if the template weight is determined by determining the weights of the combined area, since the combined area contains the current block, the weights corresponding to the current block in the combined area is determined as the weights of the prediction values. It should be noted that when determining the weights of the combined area, the influence of the weight gradient parameter on the weight is also considered. For details, reference is made to the above examples, which will not be repeated herein.

In some embodiments, the above prediction operation is performed on a sample basis, and accordingly, the weights of the prediction values are weights corresponding to a sample. In this case, when predicting the current block, a certain sample (i.e. sample A) in the current block is predicted by applying each of the K first prediction modes, so as to obtain K prediction values of sample A under the K first prediction modes, and weights of prediction values of sample A are determined according to the first weight derivation mode and a weight blending parameter. Then, the K prediction values are weighted with the weights of the prediction values of sample A, to obtain a prediction value of sample A. The foregoing steps are performed on each sample in the current block, and thus a prediction value of each sample in the current block can be obtained, where the prediction values of respective samples in the current block constitutes the prediction value of the current block. Taking K=2 as an example, sample A in the current block is predicted by applying a 1^{st} prediction mode, so as to obtain a first prediction value of sample A; and sample A is predicted by applying a 2^{nd} prediction mode, so as to obtain a second prediction value of sample A. The first prediction value and the second prediction value are weighted according to the weights of the prediction values corresponding to sample A, so as to obtain the prediction value of sample A.

In an example, taking K=2 as an example, if a 1^{st} prediction mode and a 2^{nd} prediction mode are both intra prediction modes, prediction is performed by applying a first intra prediction mode to obtain a first prediction value; and prediction is performed by applying a second intra prediction mode to obtain a second prediction value. The first prediction value and the second prediction value are weighted according to the weights of the prediction values to obtain the prediction value of the current block. For example, sample A is predicted by applying the first intra prediction mode, to obtain a first prediction value of sample A; and sample A is predicted by applying the second intra prediction mode, to obtain a second prediction value of sample A. The first prediction value and the second prediction value are weighted with weights of prediction values corresponding to sample A, to obtain the prediction value of sample A.

In some embodiments, when K is greater than 2, weights of prediction values corresponding to two prediction modes among the K first prediction modes can be determined based on the first weight derivation mode, while weights of prediction values corresponding to other prediction modes among the K first prediction modes can be preset values. For example, when K=3, first weights of prediction values corresponding to the 1^{st} and 2^{nd} prediction modes respectively are derived based on the weight derivation mode, while a weight of prediction value corresponding to the 3^{rd} prediction mode is a preset value. In some embodiments, if the total weight of prediction values corresponding to the K first prediction modes is fixed, such as 8, the weights of the prediction values respectively corresponding to the K first prediction modes can be determined based on preset weight ratios. Suppose the weight of the prediction value corresponding to the 3^{rd} prediction mode accounts for ¼ of the total weight of the prediction values. In this case, the weight of the prediction value corresponding to the 3^{rd} prediction mode can be determined as 2, with the remaining ¾ of the total weight allocated to the 1^{st} and 2^{nd} prediction modes. For example, if the weight of the prediction value corresponding to the 1^{st} prediction mode is derived as 3 based on the first weight derivation mode, then the weight of the prediction value corresponding to the 1^{st} prediction mode can be determined as (¾)×3, and the weight of the prediction value corresponding to the 2^{nd} prediction mode can be determined as (¾)×5.

Based on the above method, the prediction value of the current block is determined. A residual value of the current block is obtained according to the current block and the prediction value. The residual value of the current block is transformed to obtain transform coefficients. The transform coefficients are quantized to obtain quantized coefficients. The quantized coefficients are encoded to obtain the bitstream.

In the video encoding method provided in the embodiments of this disclosure, the encoding end determines N candidate weight derivation modes and a candidate prediction mode list when encoding the current block. The candidate prediction mode list includes at least one candidate prediction mode, where at least one candidate prediction mode is determined based on partitioning of the template of the current block. That is to say, in the embodiments of this disclosure, when determining the candidate prediction mode, the prediction mode is derived through the partitioned template, which realizes the accurate derivation of the prediction mode and thereby improves the accuracy of determining the candidate prediction mode list. Subsequently, based on the N candidate weight derivation modes and the accurately-determined candidate prediction mode, the first weight derivation mode and the K first prediction modes are determined, which improves the accuracy of determining the first weight derivation mode and the K first prediction modes. When predicting the current block based on the accurately determined first weight derivation mode and the K first prediction modes, the prediction accuracy can be improved, thereby enhancing the encoding performance.

It should be understood that FIG. 15 to FIG. 19 are merely examples of the disclosure, and should not be construed as a limitation to the disclosure.

Preferable implementations of the disclosure have been described in detail above with reference to the accompanying drawings. However, the disclosure is not limited to the details described in the foregoing implementations. Within the scope of the technical concept of the disclosure, various simple modifications can be made to the technical solutions of the disclosure, and these simple modifications all fall within the protection scope of the disclosure. For example, various technical features described in the foregoing implementations may be combined in any suitable manner without contradiction, and in order to avoid unnecessary redundancy, various possible combinations are not further described in the disclosure. For another example, various implementations of the disclosure may also be combined in any manner, and as long as the combinations do not depart from the idea of the disclosure, they should also be considered as contents disclosed in the disclosure.

It should also be understood that, in various method embodiments of the disclosure, the magnitude of a sequence number of each of the foregoing processes does not mean an execution order, and an execution order of each process should be determined according to a function and an internal logic of the process, which shall not constitute any limitation on the implementation of embodiments of the disclosure. In addition, the term “and/or” herein only describes an association between associated objects, which means that there can be three relationships. Specifically, A and/or B can mean A alone, both A and B exist, and B alone. Besides, the character “/” herein generally indicates that the associated objects are in an “or” relationship.

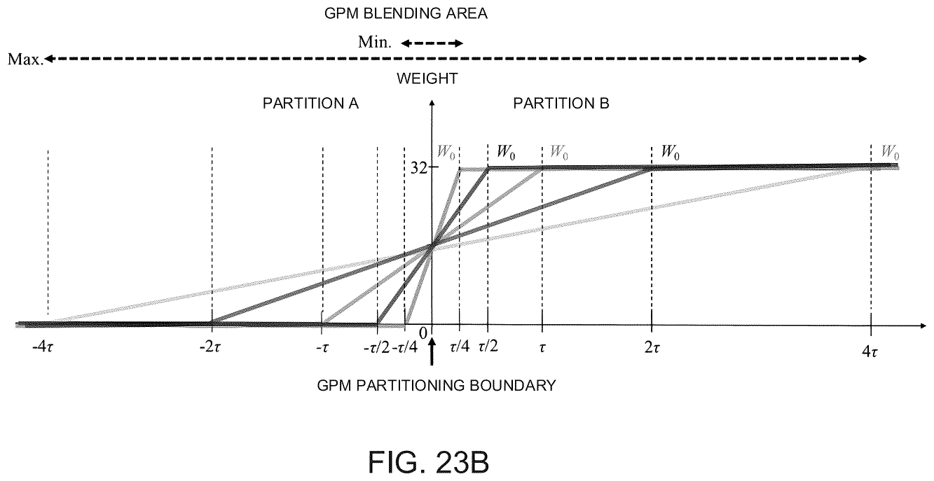

The method embodiments of the present disclosure are described in detail above with reference to FIG. 17 to FIG. 24. In the following, the apparatus embodiments of the present disclosure will be described in detail with reference to FIG. 25 to FIG. 28.

FIG. 25 is a schematic block diagram of a video decoding apparatus according to an embodiment of the disclosure. The video decoding apparatus 10 is applied to the foregoing video decoder.

As illustrated in FIG. 25, the video decoding apparatus 10 includes a weight-derivation-mode determining unit 11, a prediction-list determining unit 12, a processing unit 13, and a predicting unit 14.

The weight-derivation-mode determining unit 11 is configured to determine N candidate weight derivation modes, where N is a positive integer.

The prediction-list determining unit 12 is configured to determine a candidate prediction mode list, where the candidate prediction mode list includes at least one candidate prediction mode, and the at least one candidate prediction mode includes a prediction mode determined based on partitioning a template of a current block.

The processing unit 13 is configured to determine, based on the N candidate weight derivation modes and the candidate prediction mode list, a first weight derivation mode and K first prediction modes, where K is a positive integer and K>1.

The predicting unit 14 is configured to predict the current block based on the first weight derivation mode and the K first prediction modes, to obtain a prediction value of the current block.

In some embodiments, the prediction-list determining unit 12 is configured to determine, for each first candidate weight derivation mode in the N candidate weight derivation modes, a candidate prediction mode list corresponding to the first candidate weight derivation mode.

In some embodiments, the first candidate weight derivation mode is any one of the N candidate weight derivation modes.

In some embodiments, if the first candidate weight derivation mode belongs to one category of candidate weight derivation modes in the N candidate weight derivation modes, the prediction-list determining unit 12 is further configured to: determine angle indexes corresponding to the N candidate weight derivation modes; classify the N candidate weight derivation modes into M categories of candidate weight derivation modes based on the angle indexes, where candidate weight derivation modes in the same category of candidate weight derivation modes correspond to the same angle index; and determine a j^{th} category of candidate weight derivation modes in the M categories of candidate weight derivation modes as the first weight derivation mode, where j is a positive integer and j≤M.

In some embodiments, the prediction-list determining unit 12 is specifically configured to determine a candidate prediction mode list for at least one prediction mode in K prediction modes corresponding to the first candidate weight derivation mode.

In some embodiments, if the at least one prediction mode corresponds to one candidate prediction mode list, the prediction-list determining unit 12 is configured to determine a candidate prediction mode list for an I^{th} prediction mode in the at least one prediction mode, where i is a positive integer, and determine the candidate prediction mode list for the at least one prediction mode based on the candidate prediction mode list for the I^{th} prediction mode.

In some embodiments, the prediction-list determining unit 12 is specifically configured to determine the candidate prediction mode list for the I^{th} prediction mode as the candidate prediction mode list for the at least one prediction mode.

In some embodiments, the prediction-list determining unit 12 is specifically configured to determine, when the candidate prediction mode list for the I^{th} prediction mode includes a preset prediction mode, the candidate prediction mode list for the I^{th} prediction mode as the candidate prediction mode list for the at least one prediction mode.

In some embodiments, the prediction-list determining unit 12 is specifically configured to: when the candidate prediction mode list for the I^{th} prediction mode does not include a preset prediction mode, add the preset prediction mode to the candidate prediction mode list for the I^{th} prediction mode, to obtain the candidate prediction mode list for the at least one prediction mode.

In some embodiments, if each prediction mode in the at least one prediction mode corresponds to one candidate prediction mode list, the prediction-list determining unit 12 is specifically configured to determine for an I^{th} prediction mode in the at least one prediction mode, a candidate prediction mode list for the I^{th} prediction mode, where i is a positive integer.

In some embodiments, the candidate prediction mode list for the I^{th} prediction mode includes at least one of: a first candidate prediction mode determined based on the template of the current block or a second candidate prediction mode determined based on gradients of reconstructed samples in the template.

In some embodiments, if the candidate prediction mode list for the I^{th} prediction mode includes the first candidate prediction mode, the prediction-list determining unit 12 is further configured to: partition the template of the current block into P sub-templates, where P is a positive integer and P>1; select Q prediction templates from the P sub-templates and/or the template of the current block, where Q is a positive integer and Q≤P+1; determine prediction modes derived from the Q prediction templates; and determine at least one prediction mode in the prediction modes derived from the Q prediction templates as the first candidate prediction mode.

In some embodiments, the prediction-list determining unit 12 is specifically configured to determine an angle index corresponding to the first candidate weight derivation mode; and partition the template of the current block into P sub-templates based on the angle index.

In some embodiments, the prediction-list determining unit 12 is specifically configured to partition the template of the current block into P sub-templates based on the size of the current block.

In some embodiments, the prediction-list determining unit 12 is specifically configured to partition a left template and/or a top template of the current block to obtain the P sub-templates.

In some embodiments, the prediction-list determining unit 12 is specifically configured to: determine an angle index corresponding to the first candidate weight derivation mode; determine an available neighbouring block corresponding to the I^{th} prediction mode based on the angle index; and select the Q prediction templates from the P sub-templates and/or the template of the current block based on the available neighbouring block corresponding to the I^{th} prediction mode.

In some embodiments, the prediction-list determining unit 12 is specifically configured to: when the available neighbouring block corresponding to the I^{th} prediction mode includes a top neighbouring block of the current block, determine a sub-template at the top of the current block in the P sub-templates as a prediction template in the Q prediction templates.

In some embodiments, the prediction-list determining unit 12 is specifically configured to: when the available neighbouring block corresponding to the I^{th} prediction mode includes a left neighbouring block of the current block, determine a sub-template at the left of the current block in the P sub-templates as a prediction template in the Q prediction templates.

In some embodiments, the prediction-list determining unit 12 is specifically configured to: when the available neighbouring block corresponding to the I^{th} prediction mode includes a left neighbouring block and a top neighbouring block of the current block, determine at least one of the following as a prediction template in the Q prediction templates: a sub-template at the left of the current block in the P sub-templates, a sub-template at the top of the current block in the P sub-templates, or the template of the current block.

In some embodiments, the prediction-list determining unit 12 is specifically configured to: when a size of the current block is greater than a first threshold, determine the angle index corresponding to the first candidate weight derivation mode.

In some embodiments, the prediction-list determining unit 12 is specifically configured to select the Q prediction templates from the P sub-templates and/or the templates of the current block based on the size of the current block.

In some embodiments, the prediction-list determining unit 12 is specifically configured to: when the size of the current block is less than or equal to a second threshold, determine the P sub-templates and the template of the current block as prediction templates in the Q prediction templates.

In some embodiments, the prediction-list determining unit 12 is specifically configured to: when the size of the current block is less than or equal to a second threshold, determine the template of the current block as a prediction template in the Q prediction templates.

In some embodiments, the prediction-list determining unit 12 is specifically configured to: for any one prediction template in the Q prediction templates, determine R alternative prediction modes; determine first costs when predicting the prediction template by applying the R alternative prediction modes; and obtain, based on the first costs corresponding to the R alternative prediction modes, a prediction mode derived from the prediction template.

In some embodiments, the prediction-list determining unit 12 is specifically configured to determine the prediction modes derived from the Q prediction templates as the first candidate prediction mode.

In some embodiments, if the candidate prediction mode list for the I^{th} prediction mode includes the second candidate prediction mode, the prediction-list determining unit 12 is further configured to: partition a reconstructed sample area in which the template of the current block is located into S reconstructed sample sub-areas, where S is a positive integer; select G reconstructed sample prediction areas from the S reconstructed sample sub-areas and/or the reconstructed sample area, where G is a positive integer and G≤S+1; determine prediction modes derived from the G reconstructed sample prediction areas; and determine at least one prediction mode in the prediction modes derived from the G reconstructed sample prediction areas as the second candidate prediction mode.

In some embodiments, the prediction-list determining unit 12 is specifically configured to determine an angle index corresponding to the first candidate weight derivation mode; and partition the reconstructed sample area into S reconstructed sample sub-areas based on the angle index.

In some embodiments, the prediction-list determining unit 12 is specifically configured to partition the reconstructed sample area into S reconstructed sample sub-areas based on the size of the current block.

In some embodiments, the prediction-list determining unit 12 is specifically configured to partition a left neighbouring reconstructed sample area and/or a top neighbouring reconstructed sample area of the current block to obtain the S reconstructed sample sub-areas.

In some embodiments, the prediction-list determining unit 12 is specifically configured to: determine an angle index corresponding to the first candidate weight derivation mode; determine an available neighbouring block corresponding to the I^{th} prediction mode based on the angle index; and select the G reconstructed sample prediction areas from the S reconstructed sample sub-areas and/or the reconstructed sample area based on the available neighbouring block corresponding to the I^{th} prediction mode.

In some embodiments, the prediction-list determining unit 12 is specifically configured to: when the available neighbouring block corresponding to the I^{th} prediction mode includes a top neighbouring block of the current block, determine a reconstructed sample sub-area at the top of the current block in the S reconstructed sample sub-areas as a reconstructed sample prediction area in the G reconstructed sample prediction areas.

In some embodiments, the prediction-list determining unit 12 is specifically configured to: when the available neighbouring block corresponding to the I^{th} prediction mode includes a left neighbouring block of the current block, determine a reconstructed sample sub-area at the left of the current block in the S reconstructed sample sub-areas as a reconstructed sample prediction area in the G reconstructed sample prediction areas.

In some embodiments, the prediction-list determining unit 12 is specifically configured to: when the available neighbouring block corresponding to the I^{th} prediction mode includes a left neighbouring block and a top neighbouring block of the current block, determine as a reconstructed sample prediction area in the G reconstructed sample prediction areas, at least one of: a reconstructed sample sub-area at the left of the current block in the S reconstructed sample sub-areas, a reconstructed sample sub-area at the top of the current block in the S reconstructed sample sub-areas, or the reconstructed sample area.

In some embodiments, the prediction-list determining unit 12 is specifically configured to determine an angle index corresponding to the first candidate weight derivation mode if the size of the current block is greater than a third threshold.

In some embodiments, the prediction-list determining unit 12 is specifically configured to select the G reconstructed sample prediction areas from the S reconstructed sample sub-areas and/or the reconstructed sample area based on the size of the current block.

In some embodiments, the prediction-list determining unit 12 is specifically configured to: when the size of the current block is less than or equal to a fourth threshold, determine the S reconstructed sample sub-areas and the reconstructed sample area as reconstructed sample prediction areas in the G reconstructed sample prediction areas.

In some embodiments, the prediction-list determining unit 12 is specifically configured to: when the size of the current block is smaller than or equal to a fourth threshold, determine the reconstructed sample area as a reconstructed sample prediction area among the G reconstructed sample prediction areas.

In some embodiments, the prediction-list determining unit 12 is specifically configured to: for any one reconstructed sample prediction area in the G reconstructed sample prediction areas, determine gradients of center samples of the reconstructed sample prediction area; and determine a prediction mode derived from the reconstructed sample prediction area based on the gradients of the center samples of the reconstructed sample prediction area.

In some embodiments, the prediction-list determining unit 12 is specifically configured to determine the prediction modes derived from the G reconstructed sample prediction areas as the second candidate prediction mode.

In some embodiments, the candidate prediction mode list for the I^{th} prediction mode further includes at least one of: a third candidate prediction mode corresponding to the first candidate weight derivation mode, a prediction mode for a neighbouring block of the current block, or a preset prediction mode.

In some embodiments, the number of candidate prediction modes in the candidate prediction mode list for the I^{th} prediction mode is a preset number.

In some embodiments, the prediction-list determining unit 12 is specifically configured to select, according to a preset order, the preset number of prediction modes from the first candidate prediction mode, the second candidate prediction mode, the third candidate prediction mode corresponding to the first candidate weight derivation mode, the prediction mode for the neighbouring block of the current block, or the preset prediction mode, to construct the candidate prediction mode list for the I^{th} prediction mode.

In some embodiments, the third candidate prediction mode includes at least one of a prediction mode with a prediction angle parallel to a partition line of the first candidate weight derivation mode or a prediction mode with a prediction angle perpendicular to the partition line of the first candidate weight derivation mode. The preset prediction mode includes a PLANAR mode. The preset order includes: the prediction mode with the prediction angle parallel to the partition line of the first candidate weight derivation mode, the first candidate prediction mode, the second candidate prediction mode, the prediction mode for the neighbouring block of the current block, the prediction mode with the prediction angle perpendicular to the partition line of the first candidate weight derivation mode, and the PLANAR mode.

In some embodiments, the processing unit 13 is specifically configured to decode a bitstream to obtain a first index, where the first index indicates a first combination, and the first combination includes the first weight derivation mode and the K first prediction modes; determine a candidate combination list based on the N candidate weight derivation modes and the candidate prediction mode list, where the candidate combination list includes at least one candidate combination, and the candidate combination includes one weight derivation mode and K prediction modes; and determine the first combination from the candidate combination list based on the first index.

In some embodiments, the processing unit 13 is specifically configured to obtain T second combinations based on the N candidate weight derivation modes and the candidate prediction mode list, where any one second combination in the T second combinations includes one weight derivation mode and K prediction modes, any two combinations in the T second combinations are not completely the same in terms of weight derivation mode and K prediction modes, and T is a positive integer and T>1; and obtain the candidate combination list based on the T second combinations.

In some embodiments, the processing unit 13 is specifically configured to: for any one second combination in the T second combinations, determine a cost corresponding to the second combination when predicting the template of the current block by applying a weight derivation mode and K prediction modes in the second combination; and determine the candidate combination list according to the costs corresponding to the second combinations in the T second combinations.

It should be understood that the apparatus embodiments and the method embodiments may correspond to each other, and for similar description, reference may be made to the method embodiments. To avoid repetition, no further description is given here. Specifically, the apparatus 10 illustrated in FIG. 25 may execute the decoding method at the decoding end in the embodiments of the disclosure, and the foregoing and other operations and/or functions of each unit in the apparatus 10 are separately intended to implement corresponding processes in each method such as the foregoing decoding method at the decoding end, which are not described herein again for brevity.

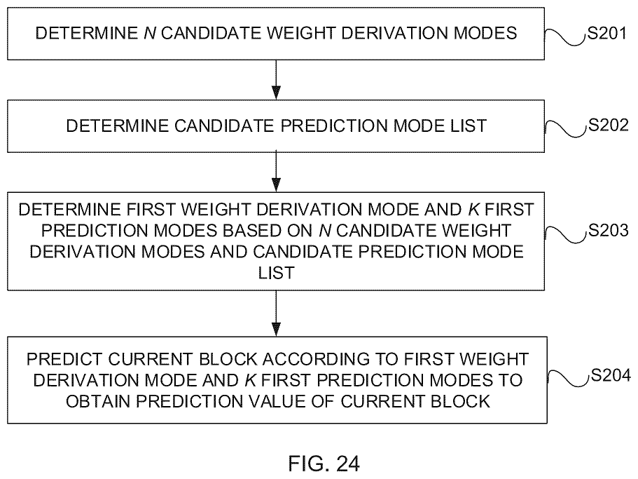

FIG. 26 is a schematic block diagram of a video encoding apparatus according to an embodiment of the disclosure, where the video encoding apparatus is applied to the foregoing encoder.

As illustrated in FIG. 26, the video encoding apparatus 20 may include a weight derivation mode unit 21, a prediction-list determining unit 22, a processing unit 23, and a predicting unit 24.

The weight derivation mode unit 21 is configured to determine N candidate weight derivation modes, where N is a positive integer.

The prediction-list determining unit 22 is configured to determine a candidate prediction mode list, where the candidate prediction mode list includes at least one candidate prediction mode, and the at least one candidate prediction mode includes a prediction mode determined based on partitioning a template of a current block.

The processing unit 23 is configured to determine, based on the N candidate weight derivation modes and the candidate prediction mode list, a first weight derivation mode and K first prediction modes, where K is a positive integer and K>1.

The predicting unit 24 is configured to predict the current block based on the first weight derivation mode and the K first prediction modes, to obtain a prediction value of the current block.

In some embodiments, the prediction-list determining unit 22 is specifically configured to determine, for each first candidate weight derivation mode in the N candidate weight derivation modes, a candidate prediction mode list corresponding to the first candidate weight derivation mode.

In some embodiments, the first candidate weight derivation mode is any one of the N candidate weight derivation modes.

In some embodiments, if the first candidate weight derivation mode belongs to one category of candidate weight derivation modes in the N candidate weight derivation modes, the prediction-list determining unit 22 is further configured to: determine angle indexes corresponding to the N candidate weight derivation modes; classify the N candidate weight derivation modes into M categories of candidate weight derivation modes based on the angle indexes, where candidate weight derivation modes in the same category of candidate weight derivation modes correspond to the same angle index; and determine a j^{th} category of candidate weight derivation modes in the M categories of candidate weight derivation modes as the first weight derivation mode, where j is a positive integer and j≤M.

In some embodiments, the prediction-list determining unit 22 is specifically configured to determine a candidate prediction mode list for at least one prediction mode in K prediction modes corresponding to the first candidate weight derivation mode.

In some embodiments, if the at least one prediction mode corresponds to one candidate prediction mode list, the prediction-list determining unit 12 is configured to determine a candidate prediction mode list for an I^{th} prediction mode in the at least one prediction mode, where i is a positive integer, and determine the candidate prediction mode list for the at least one prediction mode based on the candidate prediction mode list for the I^{th} prediction mode.

In some embodiments, the prediction-list determining unit 22 is specifically configured to determine the candidate prediction mode list for the I^{th} prediction mode as the candidate prediction mode list for the at least one prediction mode.

In some embodiments, the prediction-list determining unit 22 is specifically configured to determine, when the candidate prediction mode list for the I^{th} prediction mode includes a preset prediction mode, the candidate prediction mode list for the I^{th} prediction mode as the candidate prediction mode list for the at least one prediction mode.

In some embodiments, the prediction-list determining unit 22 is specifically configured to: when the candidate prediction mode list for the I^{th} prediction mode does not include a preset prediction mode, add the preset prediction mode to the candidate prediction mode list for the I^{th} prediction mode, to obtain the candidate prediction mode list for the at least one prediction mode.

In some embodiments, if each prediction mode in the at least one prediction mode corresponds to one candidate prediction mode list, the prediction-list determining unit 12 is specifically configured to determine for an I^{th} prediction mode in the at least one prediction mode, a candidate prediction mode list for the I^{th} prediction mode, where i is a positive integer.

In some embodiments, the candidate prediction mode list for the I^{th} prediction mode includes at least one of: a first candidate prediction mode determined based on the template of the current block or a second candidate prediction mode determined based on gradients of reconstructed samples in the template.

In some embodiments, if the candidate prediction mode list for the I^{th} prediction mode includes the first candidate prediction mode, the prediction-list determining unit 12 is further configured to: partition the template of the current block into P sub-templates, where P is a positive integer and P>1; select Q prediction templates from the P sub-templates and/or the template of the current block, where Q is a positive integer and Q≤P+1; determine prediction modes derived from the Q prediction templates; and determine at least one prediction mode in the prediction modes derived from the Q prediction templates as the first candidate prediction mode.

In some embodiments, the prediction-list determining unit 22 is specifically configured to determine an angle index corresponding to the first candidate weight derivation mode; and partition the template of the current block into P sub-templates based on the angle index.

In some embodiments, the prediction-list determining unit 22 is specifically configured to partition the template of the current block into P sub-templates based on the size of the current block.

In some embodiments, the prediction-list determining unit 22 is specifically configured to partition a left template and/or a top template of the current block to obtain the P sub-templates.

In some embodiments, the prediction-list determining unit 22 is specifically configured to: determine an angle index corresponding to the first candidate weight derivation mode; determine an available neighbouring block corresponding to the I^{th} prediction mode based on the angle index; and select the Q prediction templates from the P sub-templates and/or the template of the current block based on the available neighbouring block corresponding to the I^{th} prediction mode.

In some embodiments, the prediction-list determining unit 22 is specifically configured to: when the available neighbouring block corresponding to the I^{th} prediction mode includes a top neighbouring block of the current block, determine a sub-template at the top of the current block in the P sub-templates as a prediction template in the Q prediction templates.

In some embodiments, the prediction-list determining unit 22 is specifically configured to: when the available neighbouring block corresponding to the I^{th} prediction mode includes a left neighbouring block of the current block, determine a sub-template at the left of the current block in the P sub-templates as a prediction template in the Q prediction templates.

In some embodiments, the prediction-list determining unit 22 is specifically configured to: when the available neighbouring block corresponding to the I^{th} prediction mode includes a left neighbouring block and a top neighbouring block of the current block, determine at least one of the following as a prediction template in the Q prediction templates: a sub-template at the left of the current block in the P sub-templates, a sub-template at the top of the current block in the P sub-templates, or the template of the current block.

In some embodiments, the prediction-list determining unit 22 is specifically configured to: when a size of the current block is greater than a first threshold, determine the angle index corresponding to the first candidate weight derivation mode.

In some embodiments, the prediction-list determining unit 22 is specifically configured to select the Q prediction templates from the P sub-templates and/or the templates of the current block based on the size of the current block.

In some embodiments, the prediction-list determining unit 22 is specifically configured to: when the size of the current block is less than or equal to a second threshold, determine the P sub-templates and the template of the current block as prediction templates in the Q prediction templates.

In some embodiments, the prediction-list determining unit 22 is specifically configured to: when the size of the current block is less than or equal to a second threshold, determine the template of the current block as a prediction template in the Q prediction templates.

In some embodiments, the prediction-list determining unit 22 is specifically configured to: for any one prediction template in the Q prediction templates, determine R alternative prediction modes; determine first costs when predicting the prediction template by applying the R alternative prediction modes; and obtain, based on the first costs corresponding to the R alternative prediction modes, a prediction mode derived from the prediction template.

In some embodiments, the prediction-list determining unit 22 is specifically configured to determine the prediction modes derived from the Q prediction templates as the first candidate prediction mode.

In some embodiments, if the candidate prediction mode list for the I^{th} prediction mode includes the second candidate prediction mode, the prediction-list determining unit 12 is further configured to: partition a reconstructed sample area in which the template of the current block is located into S reconstructed sample sub-areas, where S is a positive integer; select G reconstructed sample prediction areas from the S reconstructed sample sub-areas and/or the reconstructed sample area, where G is a positive integer and G≤S+1; determine prediction modes derived from the G reconstructed sample prediction areas; and determine at least one prediction mode in the prediction modes derived from the G reconstructed sample prediction areas as the second candidate prediction mode.

In some embodiments, the prediction-list determining unit 22 is specifically configured to determine an angle index corresponding to the first candidate weight derivation mode; and partition the reconstructed sample area into S reconstructed sample sub-areas based on the angle index.

In some embodiments, the prediction-list determining unit 22 is specifically configured to partition the reconstructed sample area into S reconstructed sample sub-areas based on the size of the current block.

In some embodiments, the prediction-list determining unit 22 is specifically configured to partition a left neighbouring reconstructed sample area and/or a top neighbouring reconstructed sample area of the current block to obtain the S reconstructed sample sub-areas.

In some embodiments, the prediction-list determining unit 22 is specifically configured to: determine an angle index corresponding to the first candidate weight derivation mode; determine an available neighbouring block corresponding to the I^{th} prediction mode based on the angle index; and select the G reconstructed sample prediction areas from the S reconstructed sample sub-areas and/or the reconstructed sample area based on the available neighbouring block corresponding to the h prediction mode.

In some embodiments, the prediction-list determining unit 22 is specifically configured to: when the available neighbouring block corresponding to the I^{th} prediction mode includes a top neighbouring block of the current block, determine a reconstructed sample sub-area at the top of the current block in the S reconstructed sample sub-areas as a reconstructed sample prediction area in the G reconstructed sample prediction areas.

In some embodiments, the prediction-list determining unit 22 is specifically configured to: when the available neighbouring block corresponding to the I^{th} prediction mode includes a left neighbouring block of the current block, determine a reconstructed sample sub-area at the left of the current block in the S reconstructed sample sub-areas as a reconstructed sample prediction area in the G reconstructed sample prediction areas.

In some embodiments, the prediction-list determining unit 22 is specifically configured to: when the available neighbouring block corresponding to the I^{th} prediction mode includes a left neighbouring block and a top neighbouring block of the current block, determine as a reconstructed sample prediction area in the G reconstructed sample prediction areas, at least one of: a reconstructed sample sub-area at the left of the current block in the S reconstructed sample sub-areas, a reconstructed sample sub-area at the top of the current block in the S reconstructed sample sub-areas, or the reconstructed sample area.

In some embodiments, the prediction-list determining unit 22 is specifically configured to determine an angle index corresponding to the first candidate weight derivation mode if the size of the current block is greater than a third threshold.

In some embodiments, the prediction-list determining unit 22 is specifically configured to select the G reconstructed sample prediction areas from the S reconstructed sample sub-areas and/or the reconstructed sample area based on the size of the current block.

In some embodiments, the prediction-list determining unit 22 is specifically configured to: when the size of the current block is less than or equal to a fourth threshold, determine the S reconstructed sample sub-areas and the reconstructed sample area as reconstructed sample prediction areas in the G reconstructed sample prediction areas.

In some embodiments, the prediction-list determining unit 22 is specifically configured to: when the size of the current block is smaller than or equal to a fourth threshold, determine the reconstructed sample area as a reconstructed sample prediction area among the G reconstructed sample prediction areas.

In some embodiments, the prediction-list determining unit 22 is specifically configured to: for any one reconstructed sample prediction area in the G reconstructed sample prediction areas, determine gradients of center samples of the reconstructed sample prediction area; and determine a prediction mode derived from the reconstructed sample prediction area based on the gradients of the center samples of the reconstructed sample prediction area.

In some embodiments, the prediction-list determining unit 22 is specifically configured to determine the prediction modes derived from the G reconstructed sample prediction areas as the second candidate prediction mode.

In some embodiments, the candidate prediction mode list for the I^{th} prediction mode further includes at least one of: a third candidate prediction mode corresponding to the first candidate weight derivation mode, a prediction mode for a neighbouring block of the current block, or a preset prediction mode.

In some embodiments, the number of candidate prediction modes in the candidate prediction mode list for the I^{th} prediction mode is a preset number.

In some embodiments, the prediction-list determining unit 22 is specifically configured to select, according to a preset order, the preset number of prediction modes from the first candidate prediction mode, the second candidate prediction mode, the third candidate prediction mode corresponding to the first candidate weight derivation mode, the prediction mode for the neighbouring block of the current block, or the preset prediction mode, to construct the candidate prediction mode list for the I^{th} prediction mode.

In some embodiments, the third candidate prediction mode includes at least one of a prediction mode with a prediction angle parallel to a partition line of the first candidate weight derivation mode or a prediction mode with a prediction angle perpendicular to the partition line of the first candidate weight derivation mode. The preset prediction mode includes a PLANAR mode. The preset order includes: the prediction mode with the prediction angle parallel to the partition line of the first candidate weight derivation mode, the first candidate prediction mode, the second candidate prediction mode, the prediction mode for the neighbouring block of the current block, the prediction mode with the prediction angle perpendicular to the partition line of the first candidate weight derivation mode, and the PLANAR mode.

In some embodiments, the prediction-list determining unit 22 is specifically configured to: determine a candidate combination list based on the N candidate weight derivation modes and the candidate prediction mode list, where the candidate combination list includes at least one candidate combination, and the candidate combination includes one weight derivation mode and K prediction modes; and determine the first combination from the candidate combination list.

In some embodiments, the prediction-list determining unit 22 is specifically configured to obtain T second combinations based on the N candidate weight derivation modes and the candidate prediction mode list, where any one second combination in the T second combinations includes one weight derivation mode and K prediction modes, any two combinations in the T second combinations are not completely the same in terms of weight derivation mode and K prediction modes, and T is a positive integer and T>1; and obtain the candidate combination list based on the T second combinations.

In some embodiments, the prediction-list determining unit 22 is specifically configured to: for any one second combination in the T second combinations, determine a cost corresponding to the second combination when predicting the template of the current block by applying a weight derivation mode and K prediction modes in the second combination; and determine the candidate combination list according to the costs corresponding to the second combinations in the T second combinations.

In some embodiments, the predicting unit 24 is further configured to signal a first index into a bitstream, where the first index indicates the first combination, and the first combination includes the first weight derivation mode and the K first prediction modes.

It should be understood that the apparatus embodiments and the method embodiments may correspond to each other, and for similar description, reference may be made to the method embodiments. To avoid repetition, the details are not described herein again. Specifically, the apparatus 20 illustrated in FIG. 26 may correspond to a corresponding entity that executes the encoding method at the encoding end according to the embodiment of the disclosure. The foregoing and other operations and/or functions of each unit in the apparatus 20 are intended to implement corresponding processes in each method such as the encoding method at the encoding end. For brevity, details are not described herein again.

The apparatus and system of embodiments of the disclosure are described above from the perspective of functional units with reference to the accompanying drawings. It should be understood that, the functional units may be implemented in a form of hardware, may also be implemented by instructions in a form of software, and may also be implemented by a combination of hardware and software units. Specifically, each step of the method embodiments in the disclosure may be completed by means of an integrated logic circuit of hardware in a processor and/or instructions in the form of software. Steps combined with the method embodiments in the disclosure may be directly embodied as being completed by a hardware decoding processor, or completed by using a combination of hardware and software units in a decoding processor. Optionally, the software unit may be located in a mature storage medium in the field, such as a random access memory, a flash memory, a read-only memory, a programmable read-only memory, an electrically erasable programmable memory, and a register. The storage medium is located in a memory, and the processor reads information in the memory and completes the steps in the described method embodiments in combination with hardware thereof.

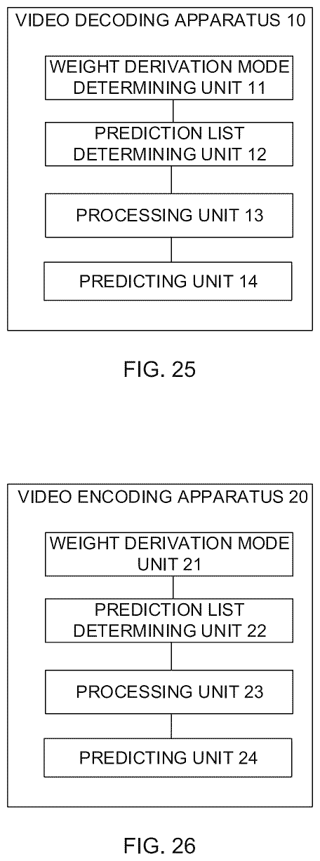

FIG. 27 is a schematic block diagram of an electronic device according to an embodiment of the disclosure.

As illustrated in FIG. 27, the electronic device 30 may be the video encoder or the video decoder described in embodiments of the disclosure. The electronic device 30 may include a memory 33 and a processor 32. The memory 33 is used for storing a computer program 34 and transmitting the computer program 34 to the processor 32. In other words, the processor 32 may call the computer program 34 from the memory 33 to implement the method in embodiments of the disclosure.

For example, the processor 32 may be configured to perform the steps in method 200 described above in accordance with instructions in the computer program 34.

In some embodiments of the disclosure, the processor 32 may include, but is not limited to: a general purpose processor, a digital signal processor (DSP), an application specific integrated circuit (ASIC), a field programmable gate array (FPGA) or another programmable logic device, a discrete gate or transistor logic device, a discrete hardware component, or the like.

In some embodiments of the disclosure, the memory 33 includes, but is not limited to: a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be random access memory (RAM), which serves as an external cache. By way of example and not limitation, many forms of RAM are available, such as static random access memory (SRAM), dynamic random access memory (DRAM), a synchronous dynamic random access memory (SDRAM), and a double data rate synchronous dynamic random access memory (DDR SDRAM), Enhanced Synchronous Dynamic Random Access Memory (ESDRAM), Synchronous Link DRAM (SLDRAM), and Direct Memory Bus Random Access Memory (DDR RAM).

In some embodiments of the present disclosure, the computer program 34 may be divided into one or more units, and the one or more units are stored in the memory 33 and executed by the processor 32 to complete the method provided in the present disclosure. The one or more units may be a series of computer program instruction segments capable of performing a particular function, where the instruction segments describes the execution of the computer program 34 in the electronic device 30.

As illustrated in FIG. 27, the electronic device 30 may further include a transceiver 33, which can be connected to the processor 32 or to the memory 33.

The processor 32 can control the transceiver 33 to communicate with other devices, and specifically, can send information or data to other devices, or receive information or data from other devices. The transceiver 33 may further include an antenna, and the number of antennas may be one or more.

It should be understood that, components in the electronic device 30 are connected through a bus system, where the bus system further includes a power bus, a control bus, and a state signal bus in addition to a data bus.

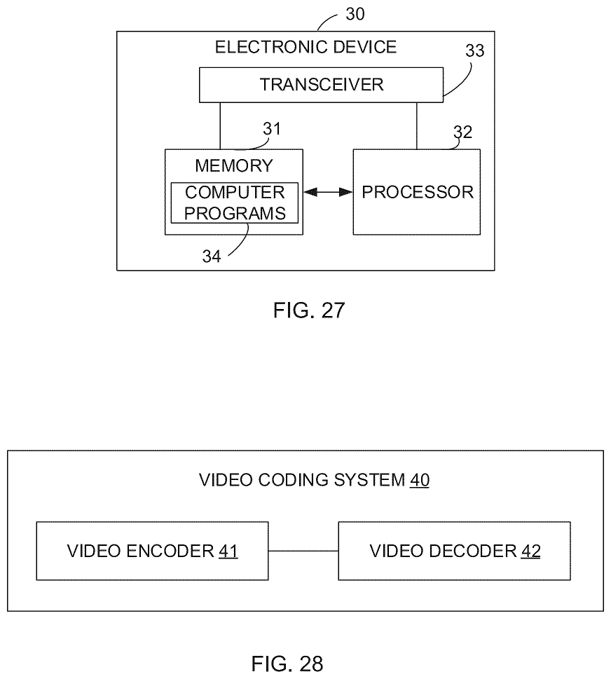

FIG. 28 is a schematic block diagram of a video coding system according to an embodiment of the disclosure.

As illustrated in FIG. 28, the video coding system 40 may include a video encoder 41 and a video decoder 42. The video encoder 41 is configured to execute the video encoding method involved in the embodiment of the disclosure, and the video decoder 42 is configured to execute the video decoding method involved in the embodiment of the disclosure.

The disclosure also provides a computer storage medium, on which a computer program is stored. The computer program, when executed by a computer, enables the computer to execute the method of the described method embodiments. Alternatively, embodiments of the disclosure further provide a computer program product comprising instructions. When the instructions are executed by a computer, the computer executes the method of the described method embodiments.

The disclosure further provides a bitstream. The bitstream is generated according to the encoding method described above.

When implemented by software, all or some the above embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure. For example, various functional units described in various embodiments of the disclosure may be integrated into one processing unit or may be present as a number of physically separated units, and two or more units may be integrated into one.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

I/We claim:

1. A video decoding method, comprising:
determining N candidate weight derivation modes, wherein N is a positive integer;
determining a candidate prediction mode list, wherein the candidate prediction mode list comprises at least one candidate prediction mode, and the at least one candidate prediction mode comprises a prediction mode determined based on partitioning a template of a current block;
determining a first weight derivation mode and K first prediction modes based on the N candidate weight derivation modes and the candidate prediction mode list, wherein K is a positive integer and K>1; and
predicting the current block based on the first weight derivation mode and the K first prediction modes, to obtain a prediction value of the current block;
wherein determining the candidate prediction mode list comprises:
for each first candidate weight derivation mode in the N candidate weight derivation modes, determining a candidate prediction mode list corresponding to the first candidate weight derivation mode.

2. The method of claim 1, wherein the first candidate weight derivation mode belongs to one category of candidate weight derivation modes in the N candidate weight derivation modes, and the method further comprises:
determining angle indexes corresponding to the N candidate weight derivation modes;
classifying the N candidate weight derivation modes into M categories of candidate weight derivation modes based on the angle indexes, wherein candidate weight derivation modes in a same category of candidate weight derivation modes correspond to the same angle index; and
determining a j^{th} category of candidate weight derivation modes in the M categories of candidate weight derivation modes as the first weight derivation mode, wherein j is a positive integer and j≤M.

3. The method of claim 1, wherein determining the candidate prediction mode list corresponding to the first candidate weight derivation mode comprises:
determining a candidate prediction mode list for at least one prediction mode in K prediction modes corresponding to the first candidate weight derivation mode;
wherein the at least one prediction mode corresponds to one candidate prediction mode list, and determining the candidate prediction mode list for the at least one prediction mode in the K prediction modes corresponding to the first candidate weight derivation mode comprises:
determining a candidate prediction mode list for an I^{th} prediction mode in the at least one prediction mode, wherein i is a positive integer; and
determining the candidate prediction mode list for the at least one prediction mode based on the candidate prediction mode list for the I^{th} prediction mode;
wherein the candidate prediction mode list for the I^{th} prediction mode comprises at least one of: a first candidate prediction mode determined based on the template of the current block or a second candidate prediction mode determined based on gradients of reconstructed samples in the template.

4. The method of claim 3, wherein the candidate prediction mode list for the I^{th} prediction mode further comprises at least one of: a third candidate prediction mode corresponding to the first candidate weight derivation mode, a prediction mode for a neighbouring block of the current block, or a preset prediction mode.

5. The method of claim 4, wherein a number of candidate prediction modes in the candidate prediction mode list for the I^{th} prediction mode is a preset number, and determining the candidate prediction mode list for the I^{th} prediction mode comprises:
according to a preset order, selecting the preset number of prediction modes from the first candidate prediction mode, the second candidate prediction mode, the third candidate prediction mode corresponding to the first candidate weight derivation mode, the prediction mode for the neighbouring block of the current block, or the preset prediction mode, to construct the candidate prediction mode list for the I^{th} prediction mode.

6. The method of claim 5, wherein:
the third candidate prediction mode comprises at least one of a prediction mode with a prediction angle parallel to a partition line of the first candidate weight derivation mode or a prediction mode with a prediction angle perpendicular to the partition line of the first candidate weight derivation mode;
the preset prediction mode comprises a PLANAR mode; and
the preset order comprises:
the prediction mode with the prediction angle parallel to the partition line of the first candidate weight derivation mode, the first candidate prediction mode, the second candidate prediction mode, the prediction mode for the neighbouring block of the current block, the prediction mode with the prediction angle perpendicular to the partition line of the first candidate weight derivation mode, and the PLANAR mode.

7. The method of claim 1, wherein determining the first weight derivation mode and the K first prediction modes based on the N candidate weight derivation modes and the candidate prediction mode list comprises:
decoding a bitstream to obtain a first index, wherein the first index indicates a first combination, and the first combination comprises the first weight derivation mode and the K first prediction modes;
determining a candidate combination list based on the N candidate weight derivation modes and the candidate prediction mode list, wherein the candidate combination list comprises at least one candidate combination, and the candidate combination comprises one weight derivation mode and K prediction modes; and
determining the first combination from the candidate combination list based on the first index.

8. The method of claim 7, wherein determining the candidate combination list based on the N candidate weight derivation modes and the candidate prediction mode list comprises:
obtaining T second combinations based on the N candidate weight derivation modes and the candidate prediction mode list, wherein any one second combination in the T second combinations comprises one weight derivation mode and K prediction modes, any two combinations in the T second combinations are not completely the same in terms of weight derivation mode and K prediction modes, and T is a positive integer and T>1; and
obtaining the candidate combination list based on the T second combinations.

9. The method of claim 8, wherein obtaining the candidate combination list based on the T second combinations comprises:
for any one second combination in the T second combinations, determining a cost corresponding to the second combination when predicting the template of the current block by applying a weight derivation mode and K prediction modes in the second combination; and
determining the candidate combination list according to the costs corresponding to the second combinations in the T second combinations.

10. The method of claim 1, wherein a height of a top template of the current block is 1, and/or a width of a left template of the current block is 1.

11. A video encoding method, comprising:
determining N candidate weight derivation modes, wherein N is a positive integer;
determining a candidate prediction mode list, wherein the candidate prediction mode list comprises at least one candidate prediction mode, and the at least one candidate prediction mode comprises a prediction mode determined based on partitioning a template of a current block;
determining a first weight derivation mode and K first prediction modes based on the N candidate weight derivation modes and the candidate prediction mode list, wherein K is a positive integer and K>1; and
predicting the current block based on the first weight derivation mode and the K first prediction modes, to obtain a prediction value of the current block;
wherein determining the candidate prediction mode list comprises:
for each first candidate weight derivation mode in the N candidate weight derivation modes, determining a candidate prediction mode list corresponding to the first candidate weight derivation mode.

12. The method of claim 11, wherein the first candidate weight derivation mode belongs to one category of candidate weight derivation modes in the N candidate weight derivation modes, and the method further comprises:
determining angle indexes corresponding to the N candidate weight derivation modes;
classifying the N candidate weight derivation modes into M categories of candidate weight derivation modes based on the angle indexes, wherein candidate weight derivation modes in a same category of candidate weight derivation modes correspond to the same angle index; and
determining a j^{th} category of candidate weight derivation modes in the M categories of candidate weight derivation modes as the first weight derivation mode, wherein j is a positive integer and j≤M.

13. The method of claim 11, wherein determining the candidate prediction mode list corresponding to the first candidate weight derivation mode comprises:
determining a candidate prediction mode list for at least one prediction mode in K prediction modes corresponding to the first candidate weight derivation mode;
wherein the at least one prediction mode corresponds to one candidate prediction mode list, and determining the candidate prediction mode list for the at least one prediction mode in the K prediction modes corresponding to the first candidate weight derivation mode comprises:
determining a candidate prediction mode list for an I^{th} prediction mode in the at least one prediction mode, wherein i is a positive integer; and
determining the candidate prediction mode list for the at least one prediction mode based on the candidate prediction mode list for the I^{th} prediction mode;
wherein the candidate prediction mode list for the I^{th} prediction mode comprises at least one of: a first candidate prediction mode determined based on the template of the current block or a second candidate prediction mode determined based on gradients of reconstructed samples in the template.

14. The method of claim 13, wherein the candidate prediction mode list for the I^{th} prediction mode further comprises at least one of: a third candidate prediction mode corresponding to the first candidate weight derivation mode, a prediction mode for a neighbouring block of the current block, or a preset prediction mode.

15. The method of claim 14, wherein a number of candidate prediction modes in the candidate prediction mode list for the I^{th} prediction mode is a preset number, and determining the candidate prediction mode list for the I^{th} prediction mode comprises:
according to a preset order, selecting the preset number of prediction modes from the first candidate prediction mode, the second candidate prediction mode, the third candidate prediction mode corresponding to the first candidate weight derivation mode, the prediction mode for the neighbouring block of the current block, or the preset prediction mode, to construct the candidate prediction mode list for the I^{th} prediction mode.

16. The method of claim 15, wherein:
the third candidate prediction mode comprises at least one of a prediction mode with a prediction angle parallel to a partition line of the first candidate weight derivation mode or a prediction mode with a prediction angle perpendicular to the partition line of the first candidate weight derivation mode;
the preset prediction mode comprises a PLANAR mode, and
the preset order comprises:
the prediction mode with the prediction angle parallel to the partition line of the first candidate weight derivation mode, the first candidate prediction mode, the second candidate prediction mode, the prediction mode for the neighbouring block of the current block, the prediction mode with the prediction angle perpendicular to the partition line of the first candidate weight derivation mode, and the PLANAR mode.

17. The method of claim 11, wherein determining the first weight derivation mode and the K first prediction modes based on the N candidate weight derivation modes and the candidate prediction mode list comprises:
determining a candidate combination list based on the N candidate weight derivation modes and the candidate prediction mode list, wherein the candidate combination list comprises at least one candidate combination, and the candidate combination comprises one weight derivation mode and K prediction modes; and
determining the first combination from the candidate combination list, and
wherein the method further comprises:
signalling a first index into a bitstream, wherein the first index indicates the first combination, and the first combination comprises the first weight derivation mode and the K first prediction modes.

18. The method of claim 17, wherein determining the candidate combination list based on the N candidate weight derivation modes and the candidate prediction mode list comprises:
obtaining T second combinations based on the N candidate weight derivation modes and the candidate prediction mode list, wherein any one second combination in the T second combinations comprises one weight derivation mode and K prediction modes, any two combinations in the T second combinations are not completely the same in terms of weight derivation mode and K prediction modes, and T is a positive integer and T>1; and
obtaining the candidate combination list based on the T second combinations.

19. The method of claim 18, wherein obtaining the candidate combination list based on the T second combinations comprises:
for any one second combination in the T second combinations, determining a cost corresponding to the second combination when predicting the template of the current block by applying a weight derivation mode and K prediction modes in the second combination; and
determining the candidate combination list according to the costs corresponding to the second combinations in the T second combinations.

20. The method of claim 11, wherein a height of a top template of the current block is 1, and/or a width of a left template of the current block is 1.
